(19) United States
(12) Patent Application Publication
(10) Pub. No.: US 2016/0116653 A1
(43) Pub. Date: Apr. 28, 2016

(54) INFRARED-LIGHT-BLOCKING COMPOSITION, INFRARED-LIGHT-BLOCKING LAYER, INFRARED CUT-OFF FILTER, AND CAMERA MODULE

(71) Applicant: FUJIFILM Corporation, Tokyo (JP)

(72) Inventors: Satoru MURAYAMA, Haibara-gun (JP); Kazuto SHIMADA, Haibara-gun (JP); Yuki NARA, Haibara-gun (JP)

(73) Assignee: FUJIFILM Corporation, Tokyo (JP)

(21) Appl. No.: 14/982,885

(22) Filed: Dec. 29, 2015

Related U.S. Application Data
(63) Continuation of application No. PCT/JP2014/067511, filed on Jul. 1, 2014.

(30) Foreign Application Priority Data
Jul. 3, 2013 (JP) 2013-140152

(51) Int. Cl. G02B 5/20; G02B 1/04

(52) U.S. Cl. CPC G02B 5/208; G02B 1/04; G02B 5/206

(57) ABSTRACT

Provided are an infrared-light-blocking composition capable of forming an infrared-light-blocking layer having excellent light-transmitting performance in the visible region and having excellent light-blocking performance in the infrared region; an infrared-light-blocking layer; an infrared cut-off filter; and a camera module. An infrared-light-blocking composition of the invention contains inorganic microparticles and a dispersing agent, and the infrared-light-blocking layer formed from the infrared-light-blocking composition has a transmittance at a wavelength of 1,000 nm of 60% or less, a transmittance at a wavelength of 1,100 nm of 50% or less, and a transmittance at a wavelength of 500 nm of 80% or more.

### CROSS-REFERENCE TO RELATED APPLICATIONS

This application is a Continuation of PCT International Application No. PCT/JP2014/067511 filed on Jul. 1, 2014, which claims priority under 35 U.S.C. §119(a) to Japanese Patent Application No. 2013-140152 filed on Jul. 3, 2013. The above application is hereby expressly incorporated by reference, in its entirety, into the present application.

### BACKGROUND OF THE INVENTION

1. Field of the Invention

The present invention relates to an infrared-light-blocking composition, an infrared-light-blocking layer, an infrared cut-off filter, and a camera module.

2. Description of the Related Art

The sensitivities of solid-state imaging elements (CCD, CMOS, and the like) that are used in digital cameras, digital video cameras and the like cover the visible region of the wavelength of light (visible wavelength region) to the infrared region (infrared wavelength region). On the other hand, human spectral sensitivity is applicable only to the visible region of light wavelength. Therefore, for example, in digital cameras, the sensitivity of a solid-state imaging element is corrected so as to be closer to human spectral sensitivity by providing an infrared cut-off filter that transmits light in the visible region and absorbs or reflects light in the infrared region, between an imaging lens and the solid-state imaging element (JP5013022B).

### SUMMARY OF THE INVENTION

On the other hand, in recent years, a further enhancement of performance is desired as compared to that of camera modules using solid-state imaging elements, and in addition, a further enhancement of performance is desired as compared to that of the infrared-light-blocking layer that is used in an infrared cut-off filter. Specifically, there is a demand for an infrared-light-blocking layer having higher transmittance in the visible region and superior light blocking properties in the infrared region.

The inventors of the present invention conducted an investigation on the infrared cut-off filter described in JP5013022B, and the characteristics of the cut-off filter did not satisfy the quality level required in recent years, while further improvements were needed.

Under such circumstances, an object of this invention is to provide an infrared-light-blocking composition which can form an infrared-light-blocking layer having excellent light-transmitting performance in the visible region and excellent light-blocking performance in the infrared region.

Furthermore, another object of the invention is to provide an infrared cut-off filter having excellent light-transmitting performance in the visible region and excellent light-blocking performance in the infrared region.

The inventors of the present invention conducted thorough investigations, and as a result, they found that the problems described above can be solved by the following configurations.

(1) An infrared-light-blocking composition including inorganic microparticles and a dispersing agent, in which an infrared-light-blocking layer formed from the infrared-light-blocking composition has a transmittance at a wavelength of 1,000 nm of 60% or less, a transmittance at a wavelength of 1,100 nm of 50% or less, and a transmittance at a wavelength of 500 nm of 80% or more.

(2) An absorption type infrared-light-blocking composition including inorganic microparticles and a dispersing agent, in which an infrared-light-blocking layer formed from the infrared-light-blocking composition has an optical density (OD) at a wavelength of 1,000 nm of 0.2 or more, an optical density (OD) at a wavelength of 1,100 nm of 0.3 or more, and an optical density (OD) at a wavelength of 500 nm of 0.1 or less.

(3) The infrared-light-blocking composition according to (1) or (2), further including a copper compound.

(4) The infrared-light-blocking composition according to (3), in which the copper compound includes at least one selected from a sulfonic acid-copper complex, a carboxylic acid-copper complex, and a phosphorus-containing copper complex.

(5) The infrared-light-blocking composition according to any one of (1) to (4), in which the 90% particle size (D90) of the inorganic microparticles dispersed in the infrared-light-blocking composition is 0.05 μm or more.

(6) The infrared-light-blocking composition according to any one of (1) to (5), in which the 50% particle size (D50) of the inorganic microparticles dispersed in the infrared-light-blocking composition is 0.03 μm or more.

(7) The infrared-light-blocking composition according to any one of (1) to (6), in which the inorganic microparticles include at least one selected from the group consisting of metal oxide particles and metal particles.

(8) The infrared-light-blocking composition according to any one of (1) to (7), in which the content of the inorganic microparticles is 40% by mass or more relative to the total solid content.

(9) The infrared-light-blocking composition according to any one of (1) to (8), in which the inorganic microparticles include at least one selected from the group consisting of indium tin oxide particles and antimony tin oxide particles.

(10) The infrared-light-blocking composition according to any one of (1) to (9), in which the dispersing agent includes a polymer compound represented by the following Formula (1), which has a weight average molecular weight of 20,000 or less, or a resin which has a repeating unit having a group X that has a functional group with a pKa of 14 or less, and an oligomer chain or polymer chain Y having a number of atoms of 40 to 20,000 as a side chain, and contains a basic nitrogen atom.

(11) The infrared-light-blocking composition according to any one of (1) to (10), further including at least one selected from the group consisting of a polymerization initiator, a polymerizable monomer, and a binder polymer.

(12) The infrared-light-blocking composition according to any one of (1) and (3) to (11), in which the composition is an absorption type infrared-light-blocking composition.

(13) The infrared-light-blocking composition according to any one of (1) and (3) to (12), in which the transmittance at a wavelength ranging from 700 nm to 1,100 nm of the infrared-light-blocking layer formed from the infrared-light-blocking composition is 20% or less.

(14) The infrared-light-blocking composition according to any one of (1) and (3) to (13), in which the transmittance at a wavelength ranging from 800 nm to 900 nm of the infrared-light-blocking layer formed from the infrared-light-blocking composition is 10% or less.

(15) An infrared-light-blocking layer formed from the infrared-light-blocking composition according to any one of (1) to (14).

(16) The infrared-light-blocking layer according to (15), in which the film thickness is 200 μm or less.

(17) An infrared cut-off filter including a blue glass substrate; and an infrared-light-blocking layer disposed on the blue glass substrate, in which the infrared-light-blocking layer contains inorganic microparticles and a dispersing agent and has a transmittance at a wavelength of 1,000 nm of 60% or less, a transmittance at a wavelength of 1,100 nm of 50% or less, and a transmittance at a wavelength of 500 nm of 80% or more.

(18) An infrared cut-off filter including a blue glass substrate; and an infrared-light-blocking layer disposed on the blue glass substrate, in which the infrared-light-blocking layer contains inorganic microparticles and a dispersing agent and has an optical density (OD) at a wavelength of 1,000 nm of 0.2 or more, an optical density (OD) at a wavelength of 1,100 nm of 0.3 or more, and an optical density (OD) at a wavelength of 500 nm of 0.1 or less.

(19) An infrared cut-off filter including a support; and an infrared-light-blocking layer disposed on the support, in which the infrared-light-blocking layer contains inorganic microparticles and a dispersing agent and has an optical density (OD) at a wavelength of 1,000 nm of 0.2 or more, an optical density (OD) at a wavelength of 1,100 nm of 0.3 or more, and an optical density (OD) at a wavelength of 500 nm of 0.1 or less.

(20) The infrared cut-off filter according to any one of (17) to (19), in which the film thickness of the infrared-light-blocking layer is 2 μm to 6 μm.

(21) The infrared cut-off filter according to any one of (17) to (20), further including a layer containing a copper compound separately from the infrared-light-blocking layer.

(22) The infrared cut-off filter according to (21), in which the copper compound includes at least one selected from a sulfonic acid-copper complex, a carboxylic acid-copper complex, and a phosphorus-containing copper complex.

(23) A camera module including a solid-state imaging element substrate; and the infrared cut-off filter according to any one of (17) to (22).

According to the invention, an infrared-light-blocking composition capable of forming an infrared-light-blocking layer having excellent light-transmitting performance in the visible region and excellent light-blocking performance in the infrared region, can be provided.

Furthermore, according to the invention, an infrared cut-off filter having excellent light-transmitting performance in the visible region and excellent light-blocking performance in the infrared region can also be provided.

### BRIEF DESCRIPTION OF THE DRAWINGS

FIG. 1 is a schematic cross-sectional diagram illustrating the configuration of a camera module including the infrared cut-off filter of the invention.

FIG. 2 is a magnified cross-sectional diagram of the solid-state imaging element shown in FIG. 1 of the invention.

FIG. 3 is a schematic cross-sectional diagram illustrating the configuration of the camera module including an infrared cut-off filter, which is related to an embodiment of the invention.

FIG. 4 is a schematic cross-sectional diagram illustrating an example of a peripheral portion of the infrared cut-off filter in the camera module.

FIG. 5 is a schematic cross-sectional diagram illustrating an example of a peripheral portion of the infrared cut-off filter in the camera module.

FIG. 6 is a schematic cross-sectional diagram illustrating an example of a peripheral portion of the infrared cut-off filter in the camera module.

FIG. 7 is a diagram showing the transmission spectrum of the multilayer infrared-light-blocking layer obtained in Example 6.

### DESCRIPTION OF THE PREFERRED EMBODIMENTS

Hereinafter, suitable embodiments of the infrared-light-blocking composition (composition for forming an infrared-light-blocking layer) and the infrared cut-off filter of the invention will be explained.

In regard to the description of groups and atomic groups in the present specification, in a case in which substitution or unsubstitution is not clearly indicated, it is meant to include both the case that does not have a substituent and the case that has a substituent. For example, an “alkyl group” for which substitution or unsubstitution is not clearly indicated, it is implied that the alkyl group includes an alkyl group which does not have a substituent (unsubstituted alkyl group) as well as an alkyl group which has a substituent (substituted alkyl group).

In the present specification, “(meth)acrylate” means “at least one of acrylate and methacrylate”.

Meanwhile, a value range indicated using the symbol “˜” in the present specification means a range that includes the values described before and after the symbol “˜” as the lower limit value and the upper limit value.

The infrared-light-blocking composition (hereinafter, also simply referred to as “composition”) includes at least inorganic microparticles and a dispersing agent, and the composition can form an absorption type infrared-light-blocking layer that will be described below, preferably by coating. That is, the infrared-light-blocking composition is preferably an absorption type infrared-light-blocking composition.

In the following description, first, the various components included in the composition are described in detail.

(Inorganic Microparticles)

Inorganic microparticles are particles that mainly accomplish the role of blocking (absorbing) infrared light.

From the viewpoint of having superior infrared light-blocking performance, it is preferable that the inorganic microparticles correspond to at least one selected from the group consisting of metal oxide particles and metal particles.

Examples of the inorganic microparticles include metal oxide particles such as indium tin oxide (ITO) particles, antimony tin oxide (ATO) particles, particles of zinc oxide that may be doped with aluminum (ZnO that may be doped with Al), fluorine-doped tin dioxide (F-doped SnO₂) particles, and niobium-doped titanium dioxide (Nb-doped TiO₂) particles; and metal particles such as silver (Ag) particles, gold (Au) particles, copper (Cu) particles, and nickel (Ni) particles. Meanwhile, in order to achieve a balance between the infrared-light-blocking performance and the photolithographic performance, inorganic microparticles having a high transmittance at the exposure wavelength (365 nm to 405 nm) are desirable, and indium tin oxide (ITO) particles or antimony tin oxide (ATO) particles are preferred.

The shape of the inorganic microparticles is not particularly limited, and regardless of being spherical or non-spherical, the shape may also be a sheet shape, a wire shape, or a tube shape.

Only one kind of inorganic microparticles may be used, or two or more kinds thereof may be used.

The 90% particle diameter (D90) of the inorganic microparticles is not particularly limited; however, from the viewpoint of obtaining superior performance of the infrared-light-blocking layer to be formed, the 90% particle diameter is preferably 0.05 μm or more, more preferably 0.05 μm to 0.1 μm, and even more preferably 0.06 μm to 0.08 μm.

Furthermore, the 50% particle diameter (D50) of the inorganic microparticles is not particularly limited; however, from the viewpoint of obtaining superior performance of the infrared-light-blocking layer to be formed, the 50% particle diameter is preferably 0.03 μm or more, more preferably 0.03 μm to 0.08 μm, even more preferably 0.03 μm to 0.05 μm, and particularly preferably 0.04 μm to 0.05 μm.

Meanwhile, the 50% particle diameter (D50) and the 90% particle diameter (D90) are the cumulative 50% particle diameter (D50) and the cumulative 90% particle diameter (D90), respectively, in a volume cumulative particle size distribution curve. More specifically, in a graph plotting the particle size on the horizontal axis and the cumulative frequency from the smaller diameter side on the vertical axis (volume-based particle size distribution), the particle diameter at which the cumulative value of volume percentage from the smaller diameter side is equivalent to 50% with respect to the cumulative value of all particles (100%), corresponds to D50, and the particle diameter at which the cumulative value is equivalent to 90%, corresponds to D90. The 50% particle diameter (D50) and the 90% particle diameter (D90) can be measured using a laser diffraction scattering particle size distribution analyzer (MICROTRAC UPA-EX150 manufactured by Nikkiso Co., Ltd.).

Meanwhile, usually, the 50% particle diameter (D50) is smaller than the 90% particle diameter (D90).

The method for producing inorganic microparticles having the predetermined particle diameter described above is not particularly limited, and any known method can be employed. Above all, inorganic microparticles produced by performing a mechanical pulverization treatment are preferred. More specifically, it is preferable to produce inorganic microparticles having the predetermined particle diameter described above by subjecting a mixture of an inorganic material powder, a dispersing agent which will be described below and a solvent which will be described below, to a mechanical pulverization treatment.

Meanwhile, the inorganic material powder is intended to mean a powder of an inorganic material that has not been adjusted to have a predetermined particle diameter, which serves as a raw material of the inorganic microparticles.

Regarding the mechanical pulverization treatment, any known method can be employed, and examples thereof include a ball mill, a rod mill, a bead mill, a disc mill, and a mixer.

Regarding a more specific method for producing a composition including inorganic microparticles (preferably, a composition further including a dispersing agent which will be described below and a solvent which will be described below), for example, the composition can be prepared by mixing and stirring each of the components using a container-driven medium mill such as a ball mill, a centrifugal mill or a planetary ball mill; a high-speed rotation mill such as a sand mill; a medium stirring mill such as a stirring tank type mill; or a simple dispersing machine such as a disper, and dispersing the resulting mixture. The order of adding the various components is arbitrary.

Furthermore, in addition to the methods described above, a method of uniformly mixing components in a simple stirrer such as a three-one motor, a magnetic stirrer, a Disper, or a homogenizer may also be employed. It is also acceptable to mix the components using a mixing machine such as a line mixer. Moreover, in order to further micronize the inorganic microparticles, it is also acceptable to mix the components using a dispersing machine such as a bead mill or a high pressure jet mill.

Particularly, from the viewpoint that the adjustment of the particle diameter is achieved more easily, a bead mill is preferred. In the following, the conditions for the bead mill will be described in detail.

Regarding the conditions for use of a bead mill, it is desirable to perform the operation in a short time period, and the retention time (dispersion time) is preferably 1 minute to 180 minutes, more preferably 1 minute to 120 minutes, and even more preferably 45 minutes to 90 minutes.

The circumferential velocity of the roller of the bead mill is preferably 2 m/sec to 30 m/sec, and more preferably 8 m/sec to 12 m/sec, from the viewpoint of obtaining superior dispersibility of the inorganic microparticles and superior performance of the infrared-light-blocking layer thus formed.

The diameter of the beads used therein is preferably 0.01 mm to 5 mm, and more preferably 0.01 mm to 0.3 mm, from the viewpoint of obtaining superior dispersibility of the inorganic microparticles and superior performance of the infrared-light-blocking layer thus formed.

The beads filling ratio is preferably 30% by volume to 90% by volume, and more preferably 50% by volume to 80% by volume, from the viewpoint of obtaining superior dispersibility of the inorganic microparticles and superior performance of the infrared-light-blocking layer thus formed.

The content of the inorganic microparticles in the composition is not particularly limited; however, the content is preferably 30% by mass or more, more preferably 40% by mass or more, and even more preferably 50% by mass or more, relative to the total solid content in the composition (hereinafter, referred to the total solid content of the composition). There are no particular limitations on the upper limit of the content; however, the upper limit is preferably 95% by mass or less, and more preferably 80% by mass or less, relative to the total solid content of the composition.

Meanwhile, the total solid content of the composition is intended to mean the total amount of the components constituting the infrared-light-blocking layer (solid content), which are included in the composition, and the relevant components do not include a solvent and the like.

In addition, when a copper compound which will be described below is included in the composition, the content of the inorganic microparticles in the composition is preferably 20% by mass or less, more preferably 10% by mass or less, and even more preferably 5% by mass or less, relative to the total solid content of the composition. There are no particular limitations on the lower limit; however, the lower limit is more than 0%, and is preferably 0.5% by mass or more.

<Dispersing Agent>

The dispersing agent is a compound intended for securing dispersibility of the inorganic microparticles in the composition.

There are no particular limitations on the kind of the dispersing agent, and an optimal compound is appropriately selected depending on the kind of the inorganic microparticles described above. Above all, preferred examples include a dispersing resin which will be described below, and a polymer compound represented by the following Formula (1) (hereinafter, also simply referred to as a polymer compound), from the viewpoint of being capable of dispersing the inorganic microparticles at a high concentration in the composition and being capable of achieving thickness reduction of the infrared-light-blocking layer thus formed.

The resin and the polymer compound will be described in detail below.

(Resin (Hereinafter, Also Referred to as Dispersing Resin))

A dispersing resin has a repeating unit having a group X that has a functional group with a pKa of 14 or less, and an oligomer chain or polymer chain Y having a number of atoms of 40 to 20,000 as a side chain, and also contains a basic nitrogen atom.

As will be described below, since both the nitrogen atom and the functional group having a pKa of 14 or less of the group X in the dispersing resin interact with the inorganic microparticles, and since the dispersing resin has an oligomer chain or polymer chain Y having a number of atoms of 40 to 20,000, the oligomer chain or polymer chain Y functions as a steric repulsive group, and thereby the dispersing resin exhibits satisfactory dispersibility and can uniformly disperse the inorganic microparticles. Furthermore, even in a case in which the composition is stored for a long period of time at room temperature or the like, the oligomer chain or polymer chain Y interacts with a solvent, and thereby sedimentation of the inorganic microparticles can be suppressed for a long period of time. Furthermore, since the oligomer chain or polymer chain Y functions as a steric repulsive group, aggregation of the inorganic microparticles is prevented, and therefore, even if the content of the inorganic microparticles is increased, dispersibility and dispersion stability are not likely to be impaired, as discussed above.

Here, the basic nitrogen atom is not particularly limited as long as it is a nitrogen atom exhibiting basicity; however, it is preferable that the dispersing resin contains a structure having a nitrogen atom having a pKb of 14 or less, and it is more preferable that the dispersing resin contains a structure having a nitrogen atom having a pKb of 10 or less.

The base strength pKb as used in the present invention refers to the pKb at a water temperature of 25° C., which is one of the indices for quantitatively representing the strength of a base and has the same meaning as the basicity constant. The base strength pKb and the acid strength pKa are in a relationship of pKb=14−pKa.

Examples of the dispersing resin include resins containing a repeating unit having a group X that has a functional group with a pKa of 14 or less as represented by the following formula, a repeating unit having a basic nitrogen atom as represented by the following formula, and a repeating unit having an oligomer chain or polymer chain Y having a number of atoms of 40 to 20,000 as represented by the following formula (corresponding to the structures of repeating units shown below in order from the left).

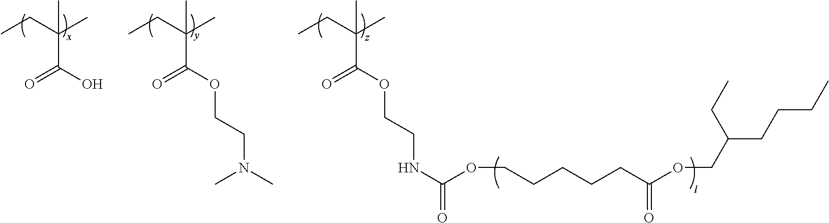

In the above formulae, x, y, and z each represent the molar ratio of polymerization of a repeating unit; and x is preferably 5 to 50, y is preferably 5 to 60, and z is preferably 10 to 90. l represents a connectivity number of a polyester chain, and is an integer with which an oligomer chain or polymer chain having a number of atoms of 40 to 20,000 can be formed. l is preferably 70 to 2,000.

The dispersing resin is preferably a resin having a repeating unit containing a nitrogen atom to which the group X having a functional group having a pKa of 14 or less is bonded, and an oligomer chain or polymer chain Y having a number of atoms of 40 to 20,000 as a side chain.

The dispersing resin is particularly preferably a dispersing resin having (i) a repeating unit containing a nitrogen atom and having a group X that has a functional group with a pKa of 14 or less, which is bonded to the nitrogen atom, the repeating unit being at least one selected from a poly(lower-alkyleneimine)-based repeating unit, a polyallylamine-based repeating unit, a polydiallylamine-based repeating unit, a meta-xylenediamine-epichlorohydrin polycondensate-based repeating unit, and a polyvinylamine-based repeating unit; and (ii) an oligomer chain or polymer chain Y having a number of atoms of 40 to 20,000 as a side chain (hereinafter, appropriately referred to as “dispersing resin 2-1”).

((i) Repeating unit containing nitrogen atom as at least one selected from a poly(lower-alkyleneimine)-based repeating unit, a polyallylamine-based repeating unit, a polydiallylamine-based repeating unit, a meta-xylenediamine-epichlorohydrin a polycondensate-based repeating unit, and a polyvinylamine-based repeating unit)

The dispersing resin 2-1 has a repeating unit (i) containing a nitrogen atom, which is at least one selected from a poly(lower-alkyleneimine)-based repeating unit, a polyallylamine-based repeating unit, a polydiallylamine-based repeating unit, a metaxylenediamine-epichlorohydrin polycondensate-based repeating unit, and a polyvinylamine-based repeating unit. Thereby, the adsorptive force to the inorganic microparticle surfaces is enhanced, and the interaction between the inorganic microparticles can be reduced.

The poly(lower-alkyleneimine) may be in a straight-chain form or in a network form.

The number average molecular weight of a main chain obtainable by polymerizing the repeating unit (i) containing a nitrogen atom, which is at least one selected from a poly(lower-alkyleneimine)-based repeating unit, a polyallylamine-based repeating unit, a polydiallylamine-based repeating unit, a meta-xylenediamine-epichlorohydrin polycondensate-based repeating unit, and a polyvinylamine-based repeating unit, that is, the number average molecular weight of the portion of the side chain remaining after excluding the oligomer chain or polymer chain Y portion from the dispersing resin 2-1, is preferably 100 to 10,000, more preferably 200 to 5,000, and most preferably 300 to 2,000. The number average molecular weight of the main chain portion can be determined from the ratio of the hydrogen atom integrated values of terminal groups and the main chain portion measured by nuclear magnetic resonance spectroscopy, or can be determined by measuring the molecular weight of the oligomer or polymer containing an amino group, which is a raw material.

The repeating unit (i) containing a nitrogen atom is particularly preferably a poly(lower-alkyleneimine)-based repeating unit or a polyallylamine-based repeating unit. Meanwhile, according to the invention, being lower in connection with the poly(lower-alkyleneimine) means that the number of carbon atoms is 1 to 5, and a lower-alkyleneimine means an alkyleneimine having 1 to 5 carbon atoms. If this structure is manifested, it is preferable that the dispersing resin 2-1 contains a structure having a repeating unit represented by the following Formula (I-1) and a repeating unit represented by the following Formula (I-2).

(Repeating Unit Represented by Formula (I-1) and Repeating Unit Represented by Formula (I-2))

The repeating unit represented by Formula (I-1) and the repeating unit represented by Formula (I-2), which are preferred constituent components of the dispersing resin 2-1, will be described in detail.

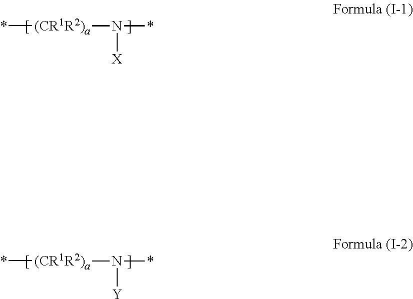

In Formulae (I-1) and (I-2), R¹ and R² each independently represent a hydrogen atom, a halogen atom, or an alkyl group. a's each independently represent an integer from 1 to 5. The symbol * represents a linking part between repeating units.

X represents a group having a functional group with a pKa of 14 or less.

Y represents an oligomer chain or polymer chain having a number of atoms of 40 to 20,000.

It is preferable that the dispersing resin 2-1 further has a repeating unit represented by Formula (I-3) as a copolymerization component, in addition to the repeating unit represented by Formula (I-1) or Formula (I-2). When such a repeating unit is used in combination, the dispersion performance of the inorganic microparticles is further enhanced.

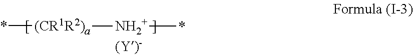

In Formula (I-3), *, R¹, R², and a have the same meanings as *, R¹, R², and a in Formula (I-1), respectively.

Y′ represents an oligomer chain or polymer chain having a number of atoms of 40 to 10,000 and having an anionic group.

The repeating unit represented by Formula (I-3) can be formed by adding an oligomer or polymer having a group which reacts with an amine and forms a salt, to a resin having a primary or secondary amino group in the main chain portion, and reacting the components.

In regard to Formula (I-1), Formula (I-2), and Formula (I-3), it is particularly preferable that R¹ and R² represent hydrogen atoms. It is preferable that a represents 2, from the viewpoint of raw material availability.

Meanwhile, the definition for a group having a functional group with a pKa of 14 or less may be found from the definition described in paragraphs “0043” to “0050” of JP2009-203462A (paragraphs “0069” to “0079” of corresponding US2011/0003241A), the disclosure of which is incorporated herein.

Furthermore, the definition for the oligomer chain or polymer chain having a number of atoms of 40 to 10,000 may be found from the definition described in paragraphs “0083” to “0098” of JP2013-064979A, the disclosure of which is incorporated herein.

Regarding another embodiment of the dispersing resin, there may be mentioned a structure or exemplary resin having a repeating unit represented by Formula (II-1) and a repeating unit represented by Formula (II-2), which is described in paragraphs “0034” to “0042” and paragraphs “0071” to “0080” of JP2009-203462A (paragraph “0105” of corresponding US2011/0003241A), the disclosure of which is incorporated herein.

(Polymer Compound)

A preferred example of the dispersing agent is a polymer compound represented by Formula (1).

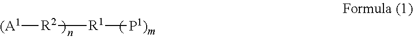

In Formula (1), A¹ represents a functional group having an adsorption ability toward inorganic microparticles, such as an acid group, a group having a basic nitrogen atom, a urea group, a urethane group, a group having a coordinating oxygen atom, a phenol group, an alkyl group, an aryl group, a group having an alkyleneoxy chain, an imide group, an alkyloxycarbonyl group, an alkylaminocarbonyl group, a carboxylic acid salt group, a sulfonamide group, an alkoxysilyl group, an epoxy group, an isocyanate group, a hydroxyl group, or a heterocyclic group.

Meanwhile, in the following description, this site having an adsorption ability to metal oxide particles (A) (aforementioned functional group) will be collectively referred to as “adsorption site” as appropriate, and will be explained.

Regarding the adsorption site, it is desirable that at least one adsorption site is included in one A¹, and it is also acceptable that two or more adsorption sites are included therein.

An example of the embodiment in which two or more adsorption sites are included in one A¹ is an embodiment in which two or more adsorption sites are linked through a chain-like saturated hydrocarbon group (may be linear or branched, and a group having 1 to 10 carbon atoms is preferred), a cyclic saturated hydrocarbon group (a group having 3 to 10 carbon atoms is preferred), an aromatic group (a group having 5 to 10 carbon atoms is preferred; for example, a phenylene group), or the like, to form a monovalent substituent A¹. An embodiment in which two or more adsorption sites are linked through a chain-like saturated hydrocarbon group to form a monovalent substituent A¹ is preferred.

Meanwhile, in a case in which the adsorption site itself constitutes a monovalent substituent, the adsorption site itself may be a monovalent substituent represented by A¹.

First, the adsorption site that constitutes A¹ will be explained below.

Regarding the “acid group”, for example, preferred examples thereof include a carboxylic acid group, a sulfonic acid group, a sulfuric acid monoester group, a phosphoric acid group, a phosphoric acid monoester group, a phosphonic acid group, a phosphinic acid group, and a boric acid group. A carboxylic acid group, a sulfonic acid group, a sulfuric acid monoester group, a phosphoric acid group, a phosphoric acid monoester group, a phosphonic acid group, and a phosphinic acid group are more preferred, and a carboxylic acid group is particularly preferred.

Regarding the “urea group”, for example, preferred examples thereof include —NR¹⁵CONR¹⁶R¹⁷ (wherein R¹⁵, R¹⁶ and R¹⁷ each independently represent a hydrogen atom, an alkyl group having from 1 to 20 carbon atoms, an aryl group having 6 or more carbon atoms, or an aralkyl group having 7 or more carbon atoms). —NR¹⁵CONHR¹⁷ (wherein V and R¹⁷ each independently represent a hydrogen atom, an alkyl group having from 1 to 10 carbon atoms, an aryl group having 6 or more carbon atoms, or an aralkyl group having 7 or more carbon atoms) is more preferred, and —NHCONHR¹⁷ (wherein R¹⁷ represents a hydrogen atom, an alkyl group having from 1 to 10 carbon atoms, an aryl group having 6 or more carbon atoms, or an aralkyl group having 7 or more carbon atoms) is particularly preferred.

Regarding the “urethane group”, for example, preferred examples thereof include —NHCOOR¹⁸, —NR¹⁹COOR²⁰, —OCONHR²¹, and —OCONR²²R²³ (wherein R¹⁸, R¹⁹, R²⁰, R²¹, R²², and R²³ each independently represent an alkyl group having from 1 to 20 carbon atoms, an aryl group having 6 or more carbon atoms, or an aralkyl group having 7 or more carbon atoms). —NHCOOR¹⁸, —OCONHR²¹ (wherein R¹⁸ and R²¹ each independently represent an alkyl group having from 1 to 20 carbon atoms, an aryl group having 6 or more carbon atoms, or an aralkyl group having 7 or more carbon atoms), and the like are more preferred, and —NHCOOR¹⁸, —OCONHR²¹ (wherein R¹⁸ and R²¹ each independently represent an alkyl group having from 1 to 10 carbon atoms, an aryl group having 6 or more carbon atoms, or an aralkyl group having 7 or more carbon atoms), and the like are particularly preferred.

Examples of the “group having a coordinating oxygen atom” include an acetylacetonate group and a crown ether.

Regarding the “group having a basic nitrogen atom”, for example, preferred examples thereof include an amino group (—NH₂), a substituted imino group (—NHR⁸, —NR⁹R¹⁰; wherein R⁸, R⁹ and R¹⁰ each independently represent an alkyl group having from 1 to 20 carbon atoms, an aryl group having 6 or more carbon atoms, or an aralkyl group having 7 or more carbon atoms), a guanidyl group represented by the following Formula (a1), and an amidinyl group represented by the following Formula (a2).

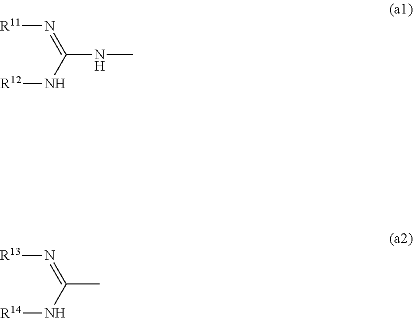

In Formula (a1), R¹¹ and R¹² each independently represent an alkyl group having from 1 to 20 carbon atoms, an aryl group having 6 or more carbon atoms, or an aralkyl group having 7 or more carbon atoms.

In Formula (a2), R¹³ and R¹⁴ each independently represent an alkyl group having from 1 to 20 carbon atoms, an aryl group having 6 or more carbon atoms; or an aralkyl group having 7 or more carbon atoms.

Among these, an amino group (—NH₂), a substituted imino group (—NHR⁸, —NR⁹R¹⁰; wherein R⁸, R⁹ and R¹⁰ each independently represent an alkyl group having from 1 to 10 carbon atoms, a phenyl group, or a benzyl group), a guanidyl group represented by Formula (a1) [in Formula (a1), R¹¹ and R¹² each independently represent an alkyl group having from 1 to 10 carbon atoms, a phenyl group, or a benzyl group], an amidinyl group represented by Formula (a2) [in Formula (a2), R¹³ and R¹⁴ each independently represent an alkyl group having from 1 to 10 carbon atoms, a phenyl group, or a benzyl group], and the like are more preferred.

Particularly, an amino group (—NH₂), a substituted imino group (—NHR⁸, —NR⁹R¹⁰; wherein R⁸, R⁹, and R¹⁰ each independently represent an alkyl group having from 1 to 5 carbon atoms, a phenyl group, or a benzyl group), a guanidyl group represented by Formula (a1) [in Formula (a1), R¹¹ and R¹² each independently represent an alkyl group having from 1 to 5 carbon atoms, a phenyl group, or a benzyl group], an amidinyl group represented by Formula (a2) [in Formula (a2), R¹³ and R¹⁴ each independently represent an alkyl group having from 1 to 5 carbon atoms, a phenyl group, or a benzyl group], and the like are preferably used.

The “alkyl group” may be linear or branched, and is preferably an alkyl group having 1 to 40 carbon atoms, more preferably an alkyl group having 4 to 30 carbon atoms, and even more preferably an alkyl group having 10 to 18 carbon atoms.

The “aryl group” is preferably an aryl group having 6 to 10 carbon atoms.

The “group having an alkyleneoxy chain” is preferably a group having an alkyloxy group or a hydroxyl group formed at an end, and is more preferably a group having an alkyloxy group having 1 to 20 carbon atoms formed at an end. Furthermore, the alkyleneoxy chain is not particularly limited as long as the chain has at least one alkyleneoxy group; however, it is preferable that the alkyleneoxy chain is composed of an alkyleneoxy group having 1 to 6 carbon atoms. Examples of the alkyleneoxy group include —CH₂CH₂O— and —CH₂CH₂CH₂O—.

The alkyl moiety in the “alkyloxycarbonyl group” is preferably an alkyl group having 1 o 20 carbon atoms.

The alkyl moiety in the “alkylaminocarbonyl group” is preferably an alkyl group having 1 to 20 carbon atoms.

Examples of the “carboxylic acid salt group” include a group formed from an ammonium salt of a carboxylic acid.

In regard to the “sulfonamide group”, the hydrogen atoms bonded to a nitrogen atom may be substituted by an alkyl group (a methyl group or the like), an acyl group (an acetyl group, a trifluoroacetyl group, or the like), or the like.

Regarding the “heterocyclic group”, for example, preferred examples thereof include a thiophene group, a furan group, a xanthene group, a pyrrole group, a pyrroline group, a pyrrolidine group, a dioxolane group, a pyrazole group, a pyrazoline group, a pyrazolidine group, an imidazole group, an oxazole group, a thiazole group, an oxadiazole group, a triazole group, a thiadiazole group, a pyran group, a pyridine group, a piperidine group, a dioxane group, a morpholine group, a pyridazine group, a pyrimidine group, a piperazine group, a triazine group, a trithiane group, an isoindoline group, an isoindolinone group, a benzimidazolone group, a benzothiazole group; an imide group such as a succinimide group, a phthalimide group or a naphthalimide group; a hydantoin group, an indole group, a quinoline group, a carbazole group, an acridine group, an acridone group, and an anthraquinone group.

Examples of the “imide group” include succinimide, phthalimide, and naphthalimide.

Meanwhile, the “heterocyclic group” and the “imide group” may further have substituents, and examples of the substituents include an alkyl group having from 1 to 20 carbon atoms, an aryl group having 6 to 16 carbon atoms, a hydroxyl group, an amino group, a carboxyl group, a sulfonamide group, a N-sulfonylamide group; an acyloxy group having 1 to 6 carbon atoms, such as an acetoxy group; an alkoxy group having from 1 to 20 carbon atoms, such as a methoxy group or an ethoxy group; a halogen atom; an alkoxycarbonyl group having from 2 to 7 carbon atoms, such as a methoxycarbonyl group, an ethoxycarbonyl group, or a cyclohexyloxycarbonyl group; a cyano group, and a carbonic acid ester group such as t-butyl carbonate.

The “alkoxysilyl group” may be any of a monoalkoxysilyl group, a dialkoxysilyl group, and a trialkoxysilyl group; however, the alkoxysilyl group is preferably a trialkoxysilyl group, and examples thereof include a trimethoxysilyl group and a triethoxysilyl group.

Examples of the “epoxy group” include a substituted or unsubstituted oxiranyl group (ethylene oxide group).

Particularly, A¹ is preferably a monovalent substituent having at least one functional group having a pKa of 5 or more, and more preferably a monovalent substituent having at least one functional group having a pKa of 5 to 14.

The “pKa” as used herein has the definition described in Kagaku Binran (Handbook of Chemistry) (II) (4^{th} revision, 1993, edited by the Chemical Society of Japan, Maruzen Co., Ltd.).

Examples of the functional group having a pKa of 5 or more include a group having a coordinating oxygen atom, a group having a basic nitrogen atom, a phenol group, a urea group, a urethane group, an alkyl group, an aryl group, an alkyloxycarbonyl group, an alkylaminocarbonyl group, a group having an alkyleneoxy chain, an imide group, a carboxylic acid salt group, a sulfonamide group, a hydroxyl group, and a heterocyclic group.

Specific examples of the functional group having a pKa of 5 or more include a phenol group (pKa of about 8 to 10), an alkyl group (pKa of about 46 to 53), an aryl group (pKa of about 40 to 43), a urea group (pKa of about 12 to 14), a urethane group (pKa of about 11 to 13), —COCH2CO— as a coordinating oxygen atom (pKa of about 8 to 10), a sulfonamide group (pKa of about 9 to 11), a hydroxyl group (pKa of about 15 to 17), and a heterocyclic group (pKa of about 12 to 30).

Among those mentioned above, A¹ is preferably a monovalent substituent having at least one group selected from the group consisting of an acid group, a phenol group, an alkyl group, an aryl group, a group having an alkyleneoxy chain, a hydroxyl group, a urea group, a urethane group, a sulfonamide group, an imide group, and a group having a coordinating oxygen atom.

In Formula (1), R² represents a single bond or a divalent linking group. n units of R² may be identical or different.

The divalent linking group represented by R² includes a group composed of from 1 to 100 carbon atoms, from 0 to 10 nitrogen atoms, from 0 to 50 oxygen atom, from 1 to 200 hydrogen atoms, and from 0 to 20 sulfur atoms, and the divalent linking group may be unsubstituted or may have a substituent.

R² is preferably a single bond, or a divalent linking group composed of from 1 to 10 carbon atoms, from 0 to 5 nitrogen atoms, from 0 to 10 oxygen atoms, from 1 to 30 hydrogen atoms, and from 0 to 5 sulfur atoms.

R² is more preferably a group selected from the group consisting of a chain-like saturated hydrocarbon group (may be linear or branched, and a group having 1 to 20 carbon atoms is preferred), a cyclic saturated hydrocarbon group (a group having 3 to 20 carbon atoms is preferred), an aromatic group (a group having 5 to 20 carbon atoms is preferred, and for example, a phenylene group), a thioether bond, an ester bond, an amide bond, an ether bond, a nitrogen atom, and a carbonyl group, or a group combining two or more thereof; even more preferably a group selected from the group consisting of a chain-like saturated hydrocarbon group, a cyclic saturated hydrocarbon group, an aromatic group, a thioether bond, an ester bond, an ether bond, and an amide bond, or a group combining two or more thereof; and particularly preferably a group selected from the group consisting of a chain-like saturated hydrocarbon group, a thioether bond, an ester bond, an ether bond, and an amide bond, or a group combining two or more thereof.

Among those mentioned above, when the divalent linking group represented by R² has a substituent, examples of the substituent include an alkyl group having from 1 to 20 carbon atoms, an aryl group having from 6 to 16 carbon atoms, a hydroxyl group, an amino group, a carboxyl group, a sulfonamide group; a N-sulfonylamide group, an acyloxy group having from 1 to 6 carbon atoms, such as an acetoxy group; an alkoxy group having from 1 to 6 carbon atoms, such as a methoxy group or an ethoxy group; a halogen atom such as chlorine or bromine; an alkoxycarbonyl group having from 2 to 7 carbon atoms, such as a methoxycarbonyl group, an ethoxycarbonyl group, or a cyclohexyloxycarbonyl group; a cyano group; and a carboxylic acid ester group such as t-butyl carbonate.

In Formula (1), R¹ represents a linking group having a valence of (m+n). The sum m+n satisfies the value from 3 to 10.

The linking group having a valence of (m+n) represented by R¹ includes a group composed of from 1 to 100 carbon atoms, from 0 to 10 nitrogen atoms, from 0 to 50 oxygen atoms, from 1 to 200 hydrogen atoms, and from 0 to 20 sulfur atoms, and the linking group may be unsubstituted or may have a substituent.

The linking group having a valence of (m+n) represented by R¹ is preferably a group represented by any one of the following formulae.

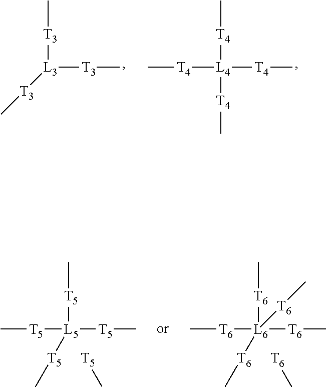

In the above formulae,

L₃ represents a trivalent group. T₃ represents a single bond or a divalent linking group, and three T₃'s may be identical with or different from each other.

L₄ represents a tetravalent group. T₄ represents a single bond or a divalent linking group, and four T₄'s may be identical with or different from each other.

L₅ represents a pentavalent group. T₅ represents a single bond or a divalent linking group, and five T₅'s may be identical with or different from each other.

L₆ represents a hexavalent group. T₆ represents a single bond or a divalent linking group, and six T₆'s may be identical with or different from each other.

Specific examples of the linking group having a valence of (m+n) represented by R¹ [specific examples (1) to (17)] are shown below. However, in this invention, examples of the linking group having a valence of (m+n) are not limited to these.

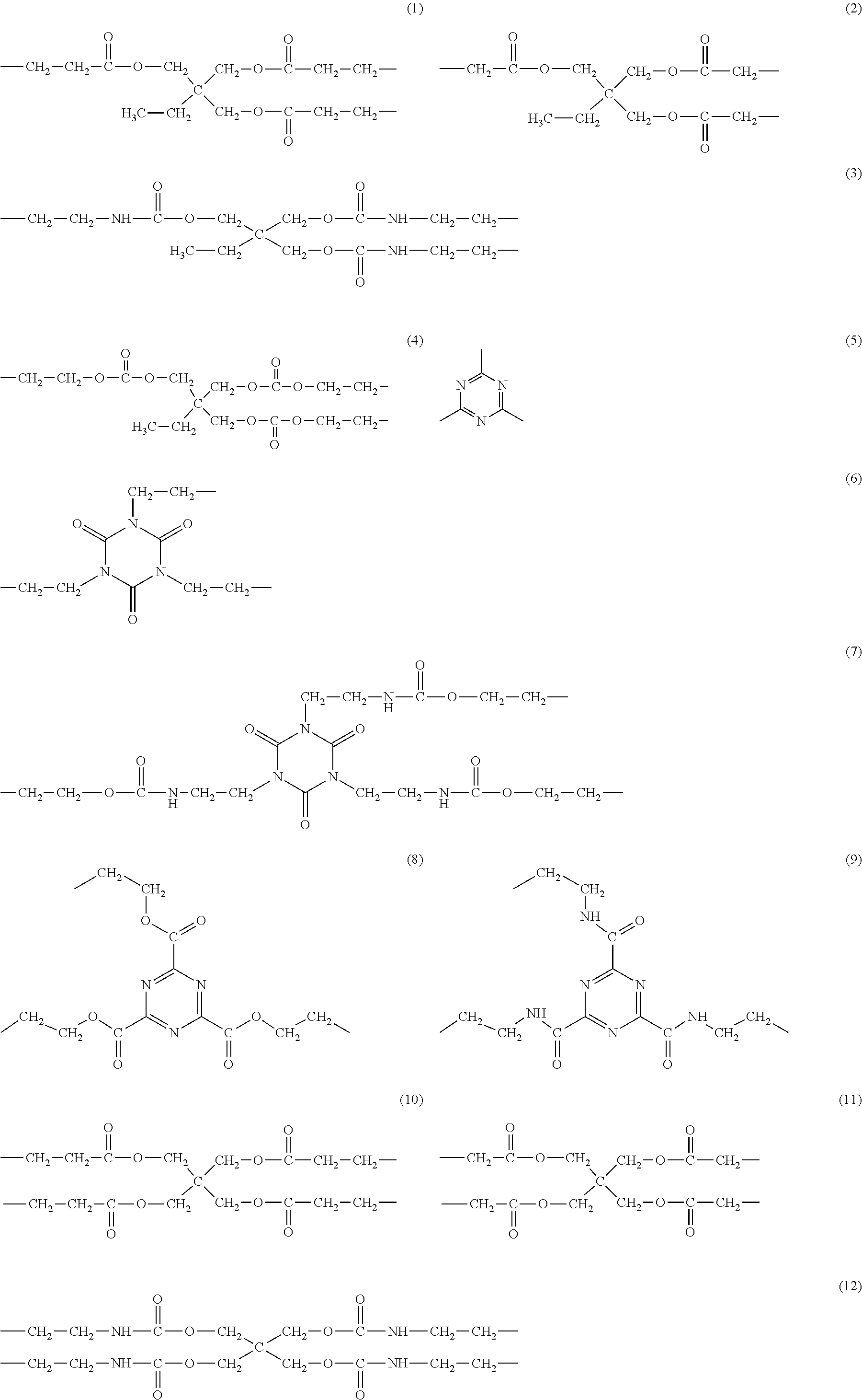

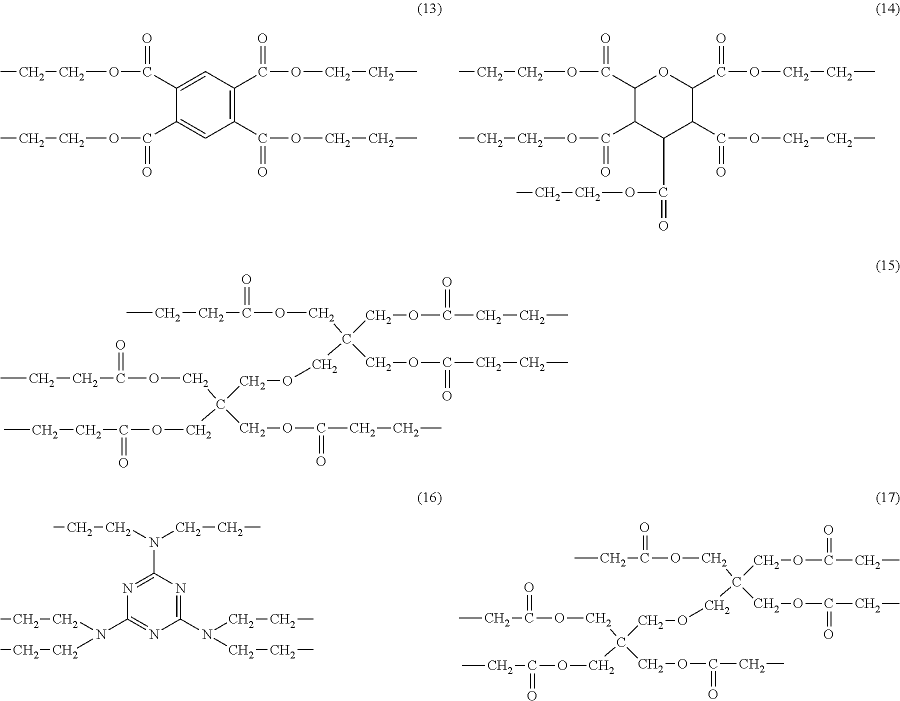

Among the specific examples described above, the most preferred linking groups having a valence of (m+n) are the following groups of (1), (2), (10), (11), (16), and (17), from the viewpoints of the availability of raw materials, the ease of synthesis, and the solubility in various solvents.

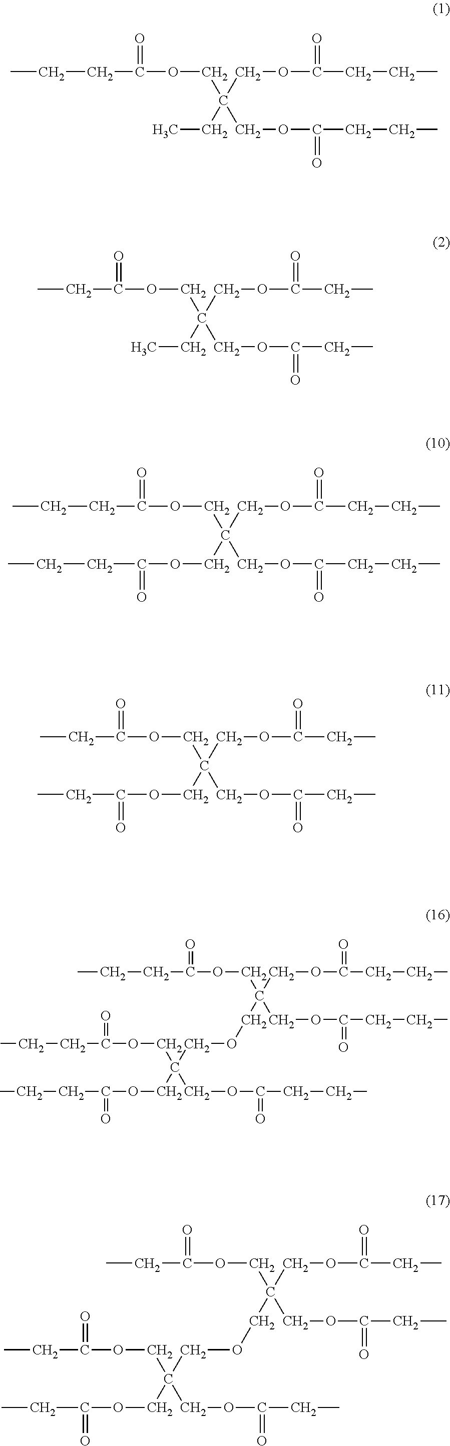

In Formula (1), m represents a positive number of 8 or less. m is preferably 0.5 to 5, more preferably 1 to 4, and particularly preferably 1 to 3.

Furthermore, in Formula (1), n represents 1 to 9. n is preferably 2 to 8, more preferably 2 to 7, and particularly preferably 3 to 6.

In Formula (1), P¹ represents a polymer chain, and can be selected according to the purpose or the like from known polymers. m units of P¹ may be identical or different.

Among polymers, in order to constitute a polymer chain, at least one selected from the group consisting of a polymer or a copolymer of a vinyl monomer, an ester-based polymer, an ether-based polymer, a urethane-based polymer, an amide-based polymer, an epoxy-based polymer, a silicone-based polymer, and modification products or copolymers thereof [for example, including a polyether/a polyurethane copolymer, a copolymer of a polyether/a polymer of a vinyl monomer (may be any one of a random copolymer, a block copolymer, and a graft copolymer)] is preferred; at least one selected from the group consisting of a polymer or a copolymer of a vinyl monomer, an ester-based polymer, an ether-based polymer, a urethane-based polymer, and modification products or copolymers thereof is more preferred; and a polymer or a copolymer of a vinyl monomer is particularly preferred.

Regarding the polymer or copolymer of a vinyl monomer, the ester-based polymer, and the ether-based polymer that can be included in the polymer chain P¹, structures represented by the following Formulae (L), (M), and (N) are respectively preferred.

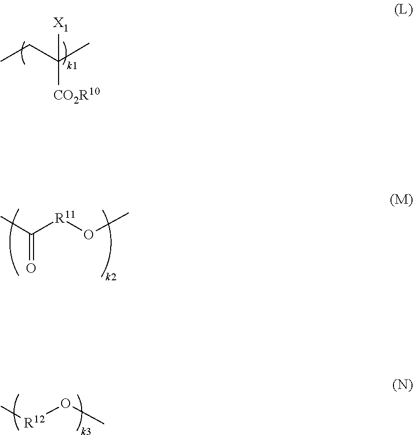

In the above formulae,
X¹ represents a hydrogen atom or a monovalent organic group. From the viewpoint of the restrictions on synthesis, X¹ is preferably a hydrogen atom or an alkyl group having 1 to 12 carbon atoms, more preferably a hydrogen atom or a methyl group, and particularly preferably a methyl group.

R¹⁰ represents a hydrogen atom or a monovalent organic group, and although there are no particular limitations on the structure, R¹⁰ is preferably a hydrogen atom, an alkyl group, an aryl group, or a heteroaryl group; and more preferably a hydrogen atom or an alkyl group. When this R¹⁰ is an alkyl group, the alkyl group is preferably a linear alkyl group having 1 to 20 carbon atoms, a branched alkyl group having 3 to 20 carbon atoms, or a cyclic alkyl group having 5 to 20 carbon atoms; more preferably a linear alkyl group having 1 to 20 carbon atoms; and particularly preferably a linear alkyl group having 1 to 6 carbon atoms. Formula (L) may have two or more R¹⁰'s having different structures.

R¹¹ and R¹² each represent a branched or linear alkylene group (preferably having 1 to 10 carbon atoms, more preferably 2 to 8 carbon atoms, and even more preferably 3 to 6 carbon atoms). Each of the formulae may have two or more of R¹¹ or R¹² having different structures.

k1, k2, and k3 each independently represent a number from 5 to 140.

It is preferable that the polymer chain P¹ contains at least one kind of repeating unit.

The number of repetitions k of at least one kind of repeating unit in the polymer chain P¹ is preferably 5 or more, and more preferably 7 or more, from the viewpoint of manifesting the steric repulsive force and enhancing the dispersion stability.

Furthermore, from the viewpoint of suppressing bulking-up of the polymer compound, and achieving a compact existence of the inorganic microparticles in a cured film (infrared-light-blocking layer), the number of repeating units k of the at least one repeating unit is preferably 140 or less, more preferably 130 or less, and even more preferably 60 or less.

Meanwhile, it is preferable that the polymer is soluble in an organic solvent. If the affinity of the polymer with an organic solvent is low, the affinity of the polymer with a dispersing medium is weakened, and an adsorbing layer sufficient for dispersion stabilization may not be secured.

The vinyl monomer is not particularly limited; however, for example, a (meth)acrylic acid ester, a crotonic acid ester, a vinyl ester, a vinyl monomer having an acid group, a maleic acid diester, a fumaric acid diester, an itaconic acid diester, a (meth)acrylamide, a styrene, a vinyl ether, a vinyl ketone, an olefin, a maleimide, a (meth)acrylonitrile, and the like are preferred; a (meth)acrylic acid ester, a crotonic acid ester, a vinyl ester, a monomer having an acid group are more preferred; and a (meth)acrylic acid ester and a crotonic acid ester are even more preferred.

Preferred examples of such a vinyl monomer include the vinyl monomers described in paragraphs “0089” to “0094” and paragraphs “0096” and “0097” of JP2007-277514A (paragraphs “0105” to “0117” and paragraphs “0119” to “0120” of corresponding US2010/233595A), the disclosure of which is incorporated in the present specification.

In addition to the compounds described above, for example, vinyl monomers having functional groups such as a urethane group, a urea group, a sulfonamide group, a phenol group, and an imide group can also be used. Such a monomer having a urethane group or a urea group can be appropriately synthesized by utilizing, for example, an addition reaction of an isocyanate group and a hydroxyl group or an amino group. Specifically, the monomer can be appropriately synthesized by an addition reaction between an isocyanate group-containing monomer and a compound containing one hydroxyl group or a compound containing one primary or secondary amino group, an addition reaction between a hydroxyl group-containing monomer or a primary or secondary amino group-containing monomer and a monoisocyanate, or the like.

Among the polymer compounds represented by Formula (1), a polymer compound represented by the following Formula (2) is preferred.

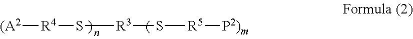

In Formula (2), A² has the same meaning as A¹ in Formula (1), and preferred embodiments thereof are also the same.

In regard to Formula (2), R⁴ and R⁵ each independently represent a single bond or a divalent linking group. n units of R⁴ may be identical or different. Also, m units of R⁵ may be identical or different.

Regarding the divalent linking group represented by R⁴ or R⁵, the same linking groups as those mentioned as the divalent linking group represented by R² in Formula (1) can be used, and preferred embodiments thereof are also the same.

Among them, the divalent linking group represented by R⁴ or R⁵ is preferably a group selected from the group consisting of a chain-like saturated hydrocarbon group (may be linear or branched, and a group having 1 to 20 carbon atoms is preferred), a cyclic saturated hydrocarbon group (a group having 3 to 20 carbon atoms is preferred), an aromatic group (a group having 5 to 20 carbon atoms is preferred; for example, a phenylene group), an ester bond, an amide bond, an ether bond, a nitrogen atom, and a carbonyl group, or a group combining two or more thereof; more preferably a group selected from the group consisting of a chain-like saturated hydrocarbon group, a cyclic saturated hydrocarbon group, an aromatic group, an ester bond, an ether bond, and an amide bond, or a group combining two or more thereof; and even more preferably a group selected from the group consisting of a chain-like saturated hydrocarbon group, an ester bond, an ether bond, and an amide bond, or a group combining two or more thereof.

In regard to Formula (2), R³ represents a linking group having a valence of (m+n). The sum (m+n) satisfies the value from 3 to 10.

The linking group having a valence of (m+n) represented by R³ may be unsubstituted or may have a substituent, and the same linking groups as those mentioned as the linking group having a valence of (m+n) represented by R¹ of Formula (1) are used, while preferred embodiments thereof are also the same.

In Formula (2), m and n have the same meanings as m and n in Formula (1), respectively, and preferred embodiments thereof are also the same.

Furthermore, P² in Formula (2) has the same meaning as P¹ in Formula (1), and preferred embodiments thereof are also the same. m units of P² may be identical or different.

Among the polymer compounds represented by Formula (2), a polymer compound which satisfies all of R³, R⁴, R⁵, P², m and n described below is most preferred.

R³: specific example (1), (2), (10), (11), (16), or (17) above

R⁴: a single bond, or a group selected from the group consisting of a chain-like saturated hydrocarbon group, a cyclic saturated hydrocarbon group, an aromatic group, an ester bond, an amide bond, an ether bond, a nitrogen atom, and a carbonyl group, or a group combining two or more thereof

R⁵: a single bond, an ethylene group, a propylene group, the following group (a), or the following group (b)

Meanwhile, in the following groups, R¹² represents a hydrogen atom or a methyl group, and 1 represents 1 or 2.

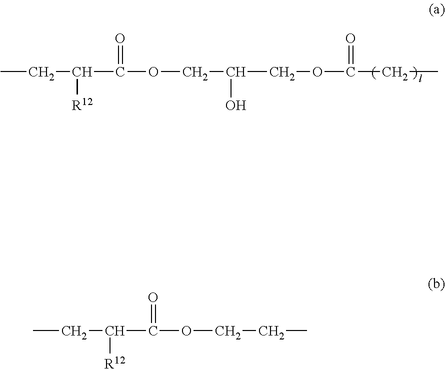

P²: a polymer or a copolymer of a vinyl monomer, an ester-based polymer, an ether-based polymer, a urethane-based polymer, and modification products thereof

m: 1 to 3

n: 3 to 6

Among the polymer compounds represented by Formula (1) or (2), a polymer compound represented by the following Formula (5) is more preferred from the viewpoints of dispersion stability, the state of a coated surface, and the like.

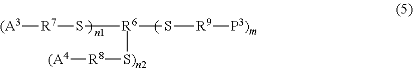

In Formula (5),

R⁶ represents a linking group having a valence of (m+n1+n2), and R⁷ to R⁹ each independently represent a single bond or a divalent linking group.

A³ represents a monovalent substituent having at least one acid group. A⁴ represents a monovalent substituent which is different from A³. n1 units of A³ and R⁷ may be respectively identical or different. n2 units of A⁴ and R⁸ may be respectively identical or different.

m has the same meaning as m in Formula (1), and preferred embodiments thereof are also the same.

n1 represents 1 to 8, n2 represents 1 to 8, and the sum m+n1+n2 satisfies the value from 3 to 10.

P³ has the same meaning as P² in Formula (2), and preferred embodiments thereof are also the same. m units of P³ and R⁹ may be respectively identical or different.

Regarding the linking group having a valence of (m+n1+n2) for R⁶, the same linking groups as those mentioned as the linking group having a valence of (m+n) represented by R¹ of Formula (1) or by R³ of Formula (2) are used, and preferred embodiments thereof are also the same.

Regarding the divalent linking group for R⁷ to R⁹, the same linking groups as those mentioned as the divalent linking group represented by R⁴ or R⁵ of Formula (2) are used, and preferred embodiments thereof are also the same.

Specific examples and preferred examples of the acid group of the substituent A³ include the same groups as the aforementioned specific examples and preferred examples of the acid group for Formula (1).

It is more preferable that the substituent A³ is a monovalent substituent having at least one acid group having a pKa of less than 5, and it is particularly preferable that the substituent A³ is a monovalent substituent having at least one group selected from the group consisting of a sulfonic acid group, a carboxylic acid group, a phosphoric acid group, a phosphonic acid group, and a phosphinic acid group, while a carboxylic acid group is most preferred.

Specific examples and preferred examples of the monovalent substituent A⁴ that is different from A³ include the same groups as the groups other than the acid groups among the aforementioned specific examples and preferred examples for A¹ in Formula (1). Among them, the substituent A⁴ is more preferably a monovalent substituent having at least one functional group having a pKa of 5 or more; even more preferably a monovalent substituent having at least one group selected from the group consisting of a group having a coordinating oxygen atom, a group having a basic nitrogen atom, a phenol group, a urea group, a urethane group, an alkyl group, an aryl group, an alkyloxycarbonyl group, an alkylaminocarbonyl group, a group having an alkyleneoxy chain, an imide group, a carboxylic acid salt group, a sulfonamide group, a hydroxyl group, and a heterocyclic group; and particularly preferably an alkyl group, an aryl group, a group having a coordinating oxygen atom, a group having a basic nitrogen atom, a urea group, or a urethane group.

Regarding the combination of the substituent A³ and the substituent A⁴, a combination in which the substituent A³ is a monovalent substituent having at least one functional group having a pKa of less than 5, and the substituent A⁴ is a monovalent substituent having at least one functional group having a pKa of 5 or more, is preferred.

A combination in which the substituent A³ is a monovalent substituent having at least one group selected from the group consisting of a carboxylic acid group, a sulfonic acid group, a phosphoric acid group, a phosphonic acid group, and a phosphinic acid group, and the substituent A⁴ is a monovalent substituent having at least one group selected from the group consisting of a group having a coordinating oxygen atom, a group having a basic nitrogen atom, a phenol group, a urea group, a urethane group, an alkyl group, an aryl group, an alkyloxycarbonyl group, an alkylaminocarbonyl group, a group having an alkyleneoxy chain, an imide group, a carboxylic acid salt group, a sulfonamide group, a hydroxyl group, and a heterocyclic group, is more preferred.

A combination in which the substituent A³ is a monovalent substituent having a carboxylic acid group, and the substituent A⁴ is an alkyl group, an aryl group, a group having a coordinating oxygen atom, a group having a basic nitrogen atom, a urea group, or a urethane group, is even more preferred.

From the viewpoint that the adsorption of the inorganic microparticles and the alkyl group of the substituent A³ becomes satisfactory, it is particularly preferable that the substituent A³ is a carboxylic acid group, and the substituent A⁴ is an alkyl group.

The molecular weight of the polymer compound as the weight average molecular weight is preferably 20,000 or less, preferably 1,000 to 15,000, and more preferably 3,000 to 12,000. When the weight average molecular weight is within this range, the effect of the plural adsorption sites introduced to the chain ends of the polymer is sufficiently manifested, and the polymer can exhibit superior adsorption performance to the inorganic microparticle surfaces.

Regarding the method for measuring the weight average molecular weight, the weight average molecular weight can be determined by using HLC-8129 (manufactured by Tosoh Corporation), TSKgel Multipore HXL-M (manufactured by Tosoh Corporation) as a column, and THF (tetrahydrofuran) as an eluent.

(Method for Synthesizing Polymer Compound)

The polymer compound represented by Formula (1) or (2) is not particularly limited; however, the polymer compound can be synthesized according to the synthesis method described in paragraphs “0114” to “0140” and paragraphs “0266” to “0348” of JP2007-277514A.

Particularly, it is preferable to synthesize the polymer (B) represented by Formula (1) or (2) by a method of radical polymerization of a vinyl monomer in the presence of a mercaptan compound having plural adsorption sites.

The vinyl monomer described above may be polymerized singly, or two or more kinds thereof may be used in combination to copolymerize the monomers.

Here, specific examples of the vinyl monomer (M-1) to (M-9) and (M-14) to (M-16) are shown below; however, the invention is not intended to be limited to these.

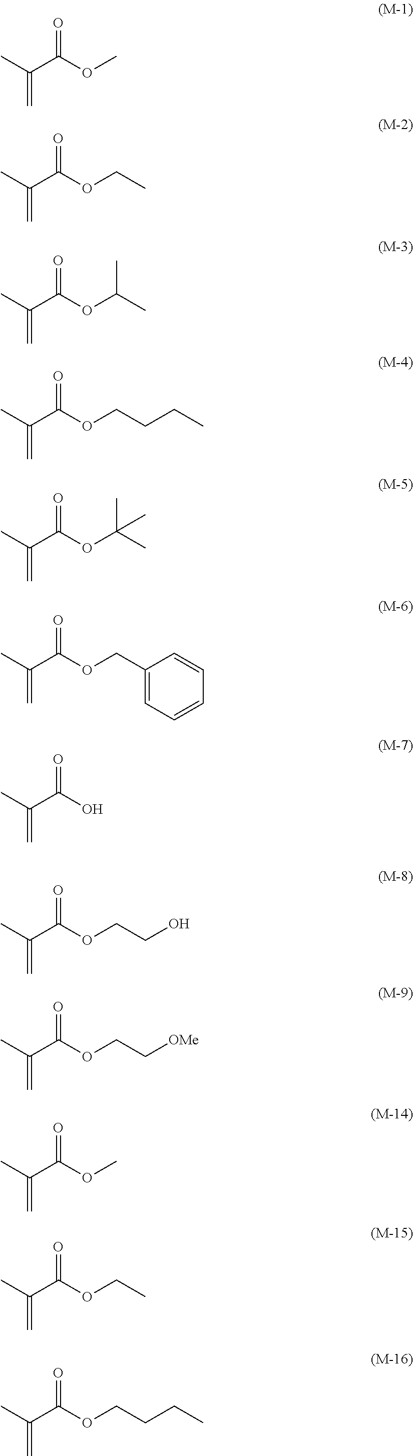

Regarding the method for synthesizing the polymer compound (B) represented by Formula (1) or (2), more specifically, a method of radical polymerization of a vinyl monomer in the presence of a compound represented by the following Formula (3) is preferred.

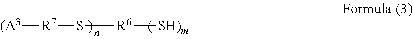

In regard to Formula (3), R⁶, R⁷, A³, m, and n have the same meanings as R³, R⁴, A², m, and n in Formula (2), respectively, and preferred embodiments thereof are also the same.

Furthermore, regarding the method for synthesizing the polymer compound represented by Formula (1) or (2), a method of adding a macromonomer having a carbon-carbon double bond to the compound represented by Formula (3) (thiol-ene reaction method) is also preferred. It is preferable to use a radical generator or a base as a catalyst for the reaction.

Specific examples of the macromonomer having a carbon-carbon double bond are shown below; however, the invention is not intended to be limited to these. In the specific examples described below, the number of repeating units k is an integer from 3 to 50.

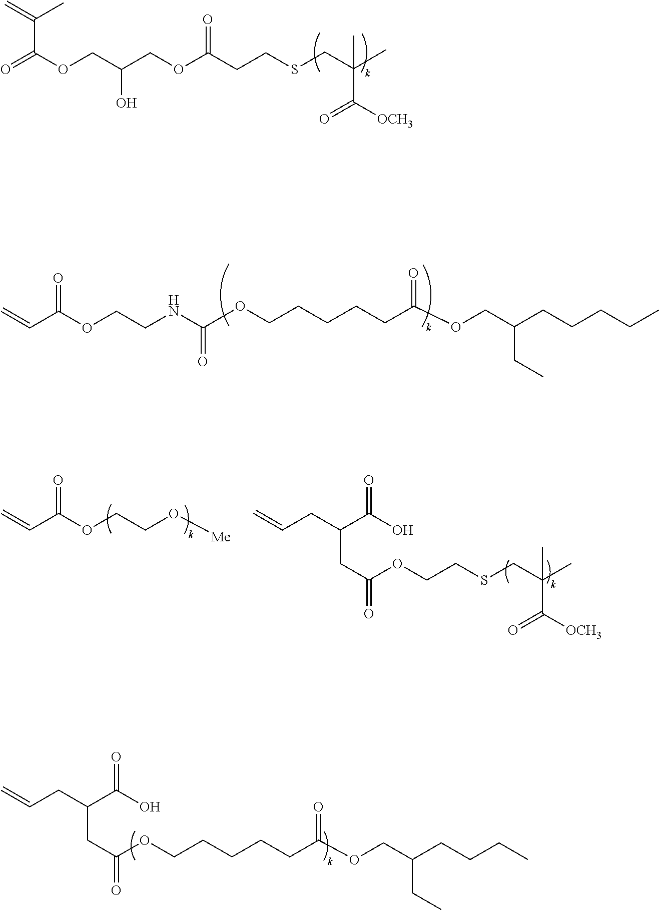

Furthermore, regarding the method for synthesizing the polymer compound represented by Formula (1) or (2), a method of forming a thioester group by a dehydration-condensation reaction between the compound represented by Formula (3) and a polymer compound having a carboxylic acid group is also preferred.

Specific examples of the polymer compound having a carboxylic acid group are shown below; however, the invention is not intended to be limited to these. In the specific examples described below, the number of repeating units k is an integer from 3 to 50.

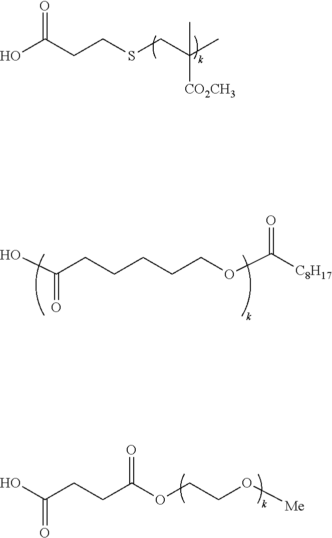

Furthermore, regarding the method for synthesizing the polymer compound represented by Formula (1) or (2), a method of forming a thioether group by a nucleophilic substitution reaction between the compound represented by Formula (3) and a polymer compound having a leaving group is also preferred. The leaving group is preferably a halogen such as iodine, bromine, or chlorine, or a sulfonic acid ester such as tosylate, mesylate, or trifluoromethanesulfonate.

Specific examples of the polymer compound having a leaving group are shown below; however, the invention is not intended to be limited to these. In the specific examples described below, the number of repeating units k is an integer from 3 to 50.

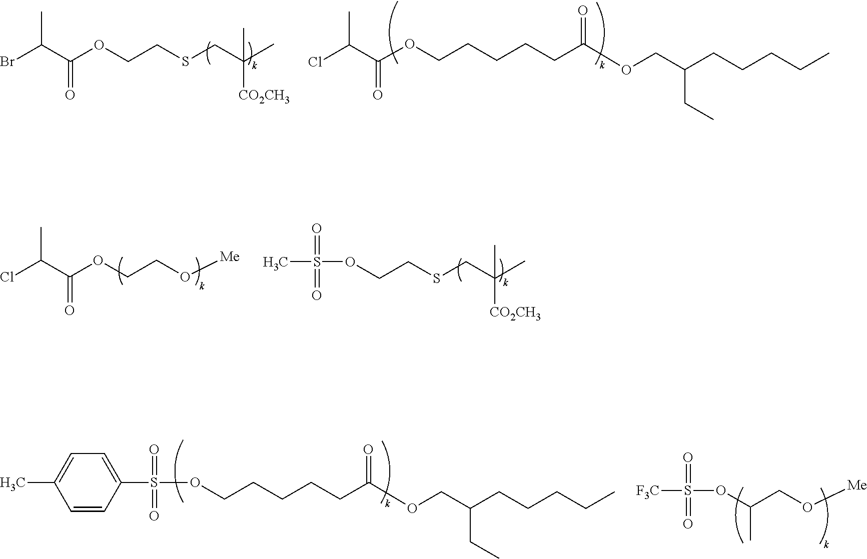

It is preferable that the compound represented by Formula (3) is synthesized by the method described below:

a method of subjecting a compound having 3 to 10 mercapto groups in one molecule, and a compound which has a carbon-carbon double bond and has an adsorption site so that the compound can react with a mercapto group, to an addition reaction.

It is particularly preferable that the addition reaction is a radical addition reaction. Meanwhile, the carbon-carbon double bond is more preferably a monosubstituted or disubstituted vinyl group, from the viewpoint of the reactivity with a mercapto group.

Specific examples of the compound having 3 to 10 mercapto groups in one molecule [specific examples (18) to (34)] include the following compounds.

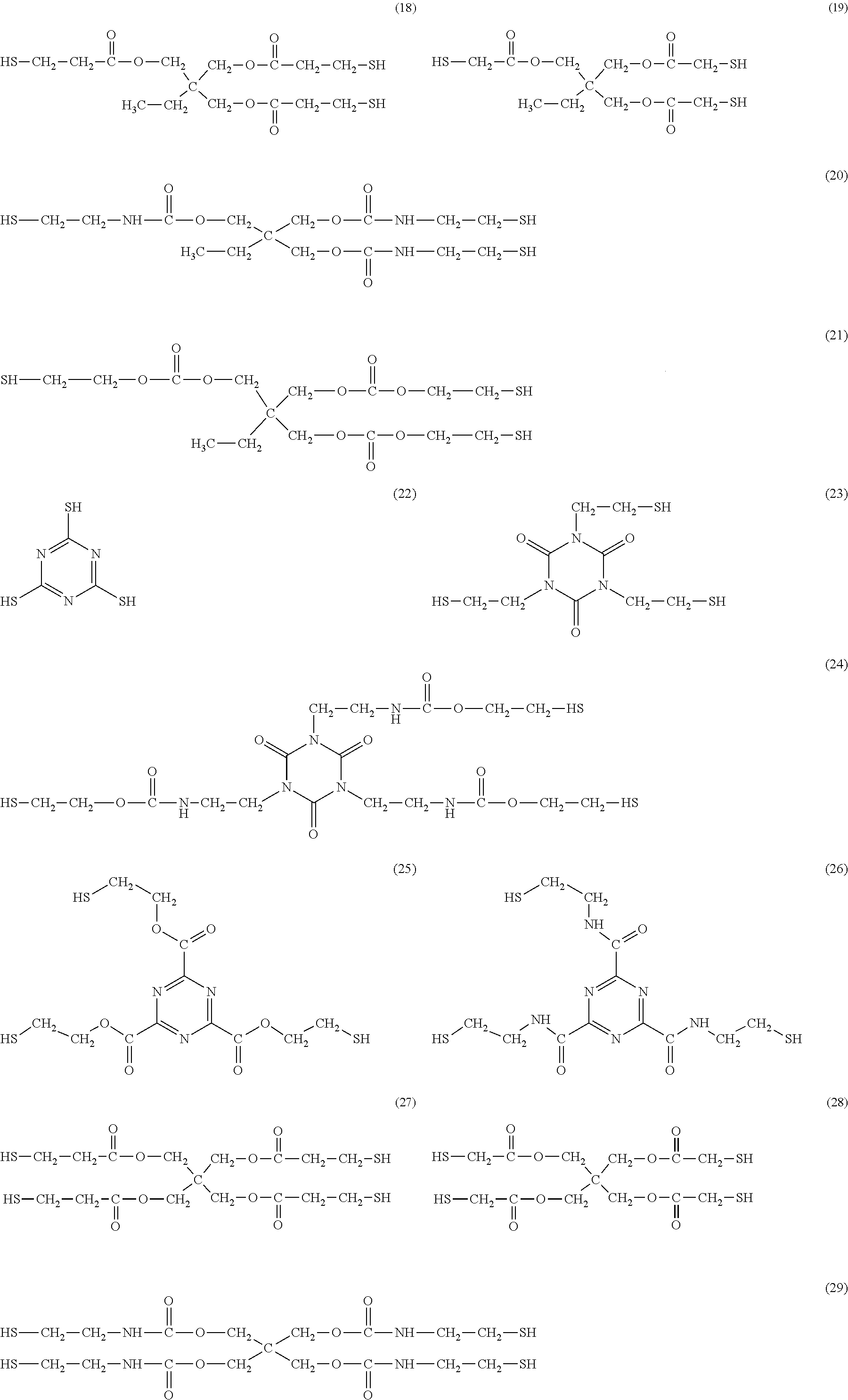

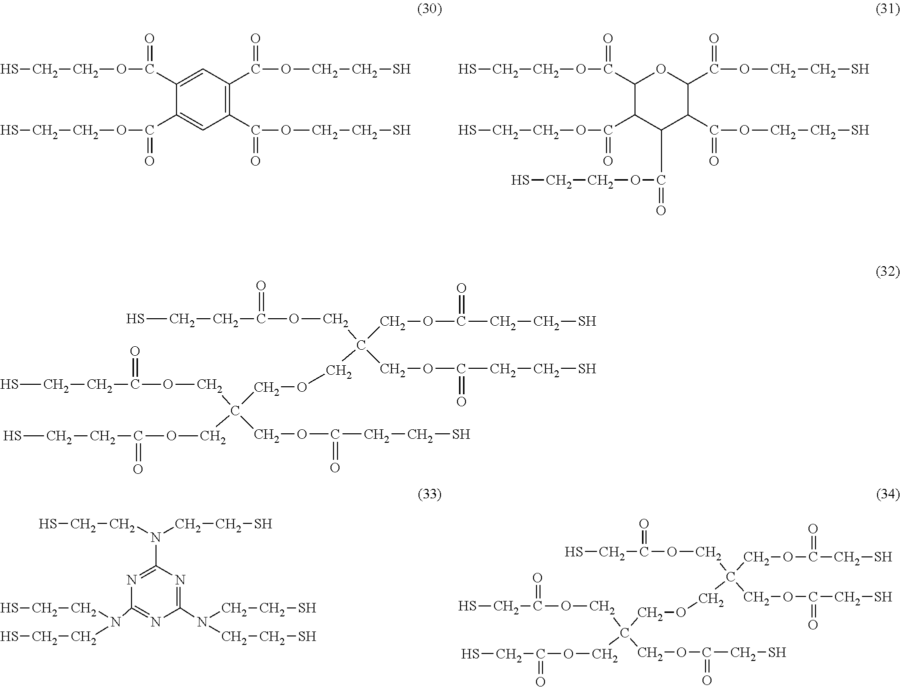 [SMILES: O=C(OCCS)c1cc(C(=O)OCCS)c(C(=O)OCCS)cc1C(=O)OCCS ; O=C(OCCS)C1OC(C(=O)OCCS)C(C(=O)OCCS)C(C(=O)OCCS)C1C(=O)OCCS ; O=C(CCS)OCC(COCC(COC(=O)CCS)(COC(=O)CCS)COC(=O)CCS)(COC(=O)CCS)COC(=O)CCS ; SCCN(CCS)c1nc(N(CCS)CCS)nc(N(CCS)CCS)n1 ; O=C(CS)OCC(COCC(COC(=O)CS)(COC(=O)CS)COC(=O)CS)(COC(=O)CS)COC(=O)CS]

Among the compounds described above, from the viewpoints of the availability of raw materials, the ease of synthesis, and the solubility in various solvents, particularly preferred compounds include specific examples (18), (19), (27), (28), (33), and (34) described above.

The above compounds are available as commercially available products (for example, (33) is dipentaerythritol hexakis(3-mercaptopropionate): manufactured by Sakai Chemical Industry Co., Ltd.).

The compound having a carbon-carbon double bond and having an adsorption site (specifically, a compound having at least one group selected from the group consisting of an acid group, a urea group, a urethane group, a group having a coordinating oxygen atom, a group having a basic nitrogen atom, a phenol group, an alkyl group, an aryl group, a group having an alkyleneoxy chain, an imide group, an alkyloxycarbonyl group, an alkylaminocarbonyl group, a carboxylic acid salt group, a sulfonamide group, a heterocyclic group, an alkoxysilyl group, an epoxy group, an isocyanate group, and a hydroxyl group, and having a carbon-carbon double bond) is not particularly limited; however, compounds such as those shown below may be used.

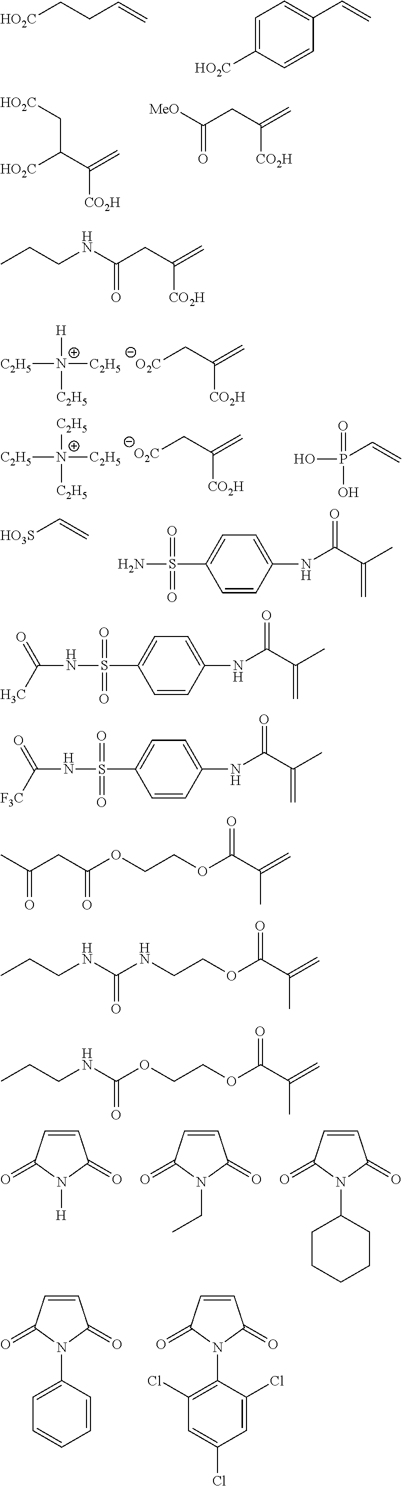

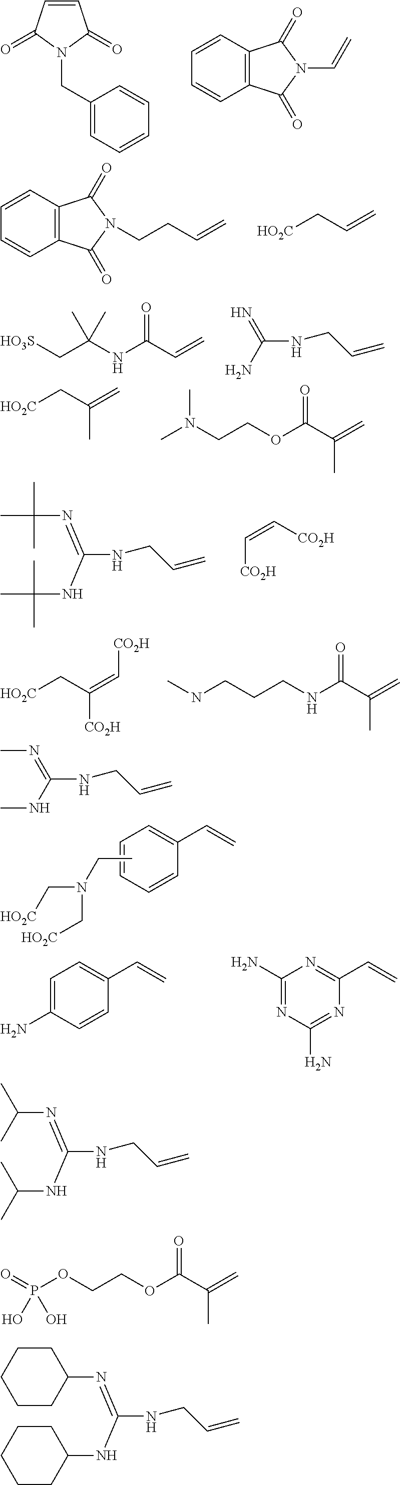

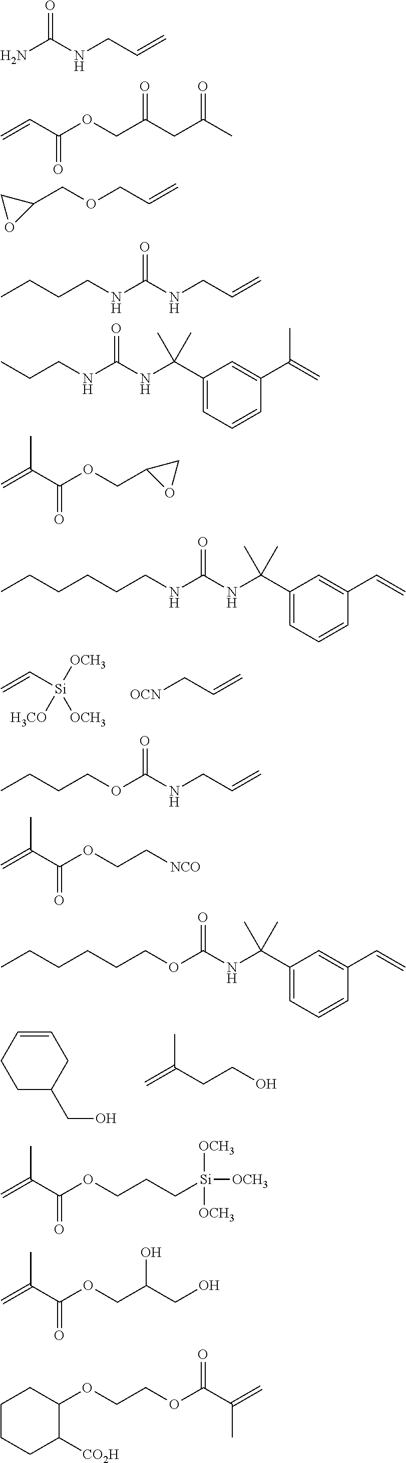

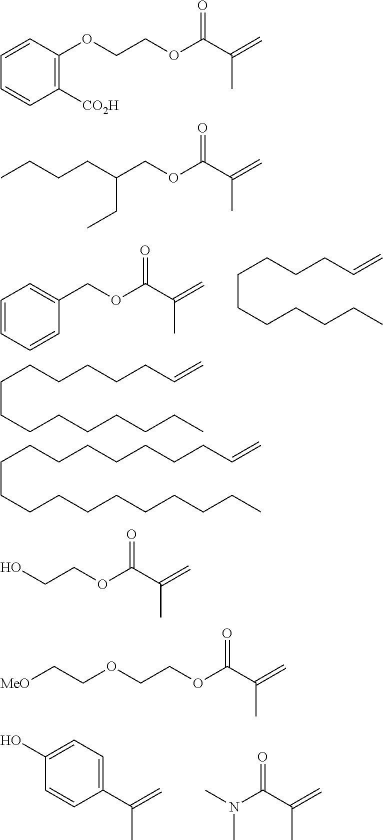

The radical addition reaction product between the “compound having 3 to 10 mercapto groups in one molecule” and the “compound having a carbon-carbon double bond and having an adsorption site” is obtained by utilizing, for example, a method of dissolving the aforementioned “compound having 3 to 10 mercapto groups in one molecule” and the “compound having a carbon-carbon double bond and having an adsorption site” in an appropriate solvent, adding a radical generator thereto, and subjecting the components to addition at about 50° C. to 100° C. (thiol-ene reaction method).

Regarding the example of the appropriate solvent that is used in the thiol-ene reaction method, the solvent can be arbitrarily selected depending on the solubility of the “compound having 3 to 10 mercapto groups in one molecule” and the “compound having a carbon-carbon double bond and having an adsorption site” to be used, and the “radical addition reaction product thus produced”.

Examples of the solvent include methanol, ethanol, propanol, isopropanol, 1-methoxy-2-propanol, 2-ethylhexanol, 1-methoxy-2-propyl acetate, acetone, methyl ethyl ketone, methyl isobutyl ketone, methoxypropyl acetate, ethyl lactate, ethyl acetate, acetonitrile, tetrahydrofuran, dimethylformamide, chloroform, and toluene. These solvents may be used as mixtures of two or more kinds thereof.

Furthermore, as the radical generator, azo compounds such as 2,2′-azobis(isobutyronitrile) (AIBN), 2,2′-azobis-(2,4′-dimethylvaleronitrile), and dimethyl 2,2′-azobisisobutyrate [V-601, manufactured by Wako Pure Chemical Industries, Ltd.]; peroxides such as benzoyl peroxide; persulfates such as potassium persulfate and ammonium persulfate; and the like can be utilized.

Regarding the polymer compound, a compound obtained by performing polymerization according to a conventional method based on a known method, using these vinyl monomers and the compound represented by Formula (3), is preferred. Meanwhile, the compound represented by Formula (3) according to the invention is a compound which functions as a chain transfer agent, and hereinafter, the compound may be simply referred to as “chain transfer agent”.

For example, the polymer compound is obtained by utilizing a method of dissolving these vinyl monomers and a chain transfer agent in an appropriate solvent, adding a radical polymerization initiator thereto, and polymerizing the monomers in the solution at about 50° C. to 220° C. (solution polymerization method).

Regarding the example of the appropriate solvent to be used for the solution polymerization method, the solvent can be arbitrarily selected depending on the solubility of the monomers used and the copolymer thus produced. Examples thereof include methanol, ethanol, propanol, isopropanol, 1-methoxy-2-propanol, 2-ethylhexanol, 1-methoxy-2-propyl acetate, acetone, methyl ethyl ketone, methyl isobutyl ketone, methoxypropyl acetate, ethyl lactate, ethyl acetate, acetonitrile, tetrahydrofuran, dimethylformamide, chloroform, and toluene. These solvents may be used as mixtures of two or more kinds thereof.

Furthermore, as the radical polymerization initiator, azo compounds such as 2,2′-azobis(isobutyronitrile) (AIBN), 2,2′-azobis-(2,4′-dimethylvaleronitrile), and dimethyl 2,2′-azobisisobutyrate [V-601, manufactured by Wako Pure Chemical Industries, Ltd.]; peroxides such as benzoyl peroxide; persulfates such as potassium persulfate and ammonium persulfate; and the like can be utilized.

The content of the dispersing agent relative to the total solid content of the composition of the invention is preferably in the range of 1% by mass to 70% by mass, more preferably in the range of 3% by mass to 50% by mass, and even more preferably in the range of 4% by mass to 40% by mass, from the viewpoint of the dispersion stability of the inorganic microparticles.

The content of the dispersing agent with respect to the inorganic microparticles is not particularly limited; however, the content is preferably 5 parts by mass to 50 parts by mass, and more preferably 10 parts by mass to 40 parts by mass, relative to 100 parts by mass of the inorganic microparticles.

The dispersing agent may be used singly, or two or more kinds thereof may be used in combination.

(Copper Compound)

The composition of the invention may further include a copper compound as an infrared shielding agent. When a copper compound is included, superior infrared-light-blocking performance (particularly, near-infrared-light-blocking performance) is obtained.

Copper compounds are materials having infrared-light-absorption properties. Specifically, a copper compound having the maximum absorption wavelength in the wavelength range of 700 nm to 1,000 nm (near-infrared region) is preferred.

The copper in the copper compound is preferably monovalent copper or divalent copper, and divalent copper is more preferred. The copper content in the copper compound is preferably 2% by mass to 40% by mass, and more preferably 5% by mass to 40% by mass.

The content of the copper compound in the composition of the invention is not particularly limited; however, from the viewpoint of dispersion stability of the inorganic microparticles and from the viewpoint of infrared-light-blocking performance, the mass ratio between the mass of the inorganic microparticles and the mass of the copper compound (mass of inorganic microparticles/mass of copper compound) is preferably 0.00001 to 1.0, and more preferably 0.0001 to 0.5.

The copper compound is preferably a copper complex. As the copper compound, copper or a compound containing copper can be used. Regarding the compound containing copper, for example, copper oxide or a copper salt can be used. More preferred examples of the copper salt include copper acetate, copper chloride, copper formate, copper hydroxide, copper stearate, copper benzoate, copper ethyl acetoacetate, copper pyrophosphate, copper naphthenate, copper citrate, copper nitrate, copper sulfate, copper carbonate, copper chlorate, copper (meth)acrylate, and copper perchlorate; and even more preferred examples thereof include copper acetate, copper chloride, copper sulfate, copper hydroxide, copper benzoate, and copper (meth)acrylate. The copper salt is preferably a monovalent copper salt or a divalent copper salt, and a divalent copper salt is more preferred.

According to this invention, particularly, a copper compound formed by reacting a compound having an acid group with a copper component is preferred; a copper compound formed by reacting a compound containing at least one of a sulfonic acid group, a carboxylic acid group, a carboxylic acid ester group, phosphinic acid, and a phosphoric acid group with a copper component is more preferred (hereinafter, these compounds may be respectively referred to as a copper sulfonate compound, a copper carboxylate compound, a copper phosphinate compound, and a copper phosphate compound); a copper sulfonate compound (preferably, a copper sulfonate complex), a copper carboxylate (preferably, a copper carboxylate complex), and a copper phosphate compound (preferably, a phosphorus-containing copper complex) are even more preferred; and a copper sulfonate compound and a copper carboxylate compound are even more preferred.

Furthermore, the copper compound may be a low molecular weight compound, or may be a polymer compound. These compounds will be specifically explained below.

(Low Molecular Weight Type)

The copper compound used for this invention is preferably a compound represented by the following Formula (iA).

Cu(L)ₙ₁.(X)ₙ₂ Formula (iA)

In Formula (iA), L represents a ligand coordinated to copper, and X either does not exist, or represents a halogen atom, H₂O, NO₃, ClO₄, SO₄, CN, SCN, BF₄, PF₆, BPh₄ (wherein Ph represents a phenyl group), or an alcohol. n1 and n2 each independently represent an integer from 1 to 4.

It is preferable that the ligand L has a substituent containing C, N, O or S as atoms capable of being coordinated to copper, and it is more preferable that the ligand L has a group having a lone pair of electrons, such as N, O, or S. The group capable of coordinating is not limited to be of a single kind in the molecule, and the molecule may contain two or more kinds thereof. The group capable of coordinating may be dissociable or non-dissociable. In the case of being non-dissociable, X does not exist.

In a case in which the copper compound is a copper complex, the copper complex has a form in which ligands are coordinated to copper as the metal center. The copper in the copper complex used for the invention is preferably divalent copper, and for example, the copper complex can be obtained by mixing and reacting a compound that serves as a ligand, or a salt thereof, with a copper component, or the like. Therefore, when a “composition including copper and a ligand” is used, it is anticipated that a copper complex has been formed in the composition.

The compound that serves as a ligand, or a salt thereof, is not particularly limited; however, suitable examples thereof include organic acid compounds (for example, a sulfonic acid compound, a carboxylic acid compound, and a phosphoric acid compound), or salts thereof.

The compound that serves as a ligand, or a salt thereof, is preferably a compound containing an acid group or a salt thereof, and a compound represented by the following Formula (ii) is preferred.

R¹X¹)ₙ₃ Formula (ii)

In Formula (ii), R¹ represents a n-valent organic group (corresponding to the valence of n3); X¹ represents an acid group; and n3 represents an integer from 1 to 6.

The n-valent organic group is preferably a hydrocarbon group or an oxyalkylene group, and more preferably an aliphatic hydrocarbon group or an aromatic hydrocarbon group. The hydrocarbon group may have a substituent, and examples of the substituent include an alkyl group, a halogen atom (preferably, a fluorine atom), a polymerizable group (for example, a vinyl group, a (meth)acryloyl group, an epoxy group, or an oxetane group), a sulfonic acid group, a carboxylic acid group, an acid group containing a phosphorus atom, a carboxylic acid ester group (for example, —CO₂CH₃), a hydroxyl group, an alkoxy group (for example, a methoxy group), an amino group, a carbamoyl group, a carbamoyloxy group, and a halogenated alkyl group (for example, a fluoroalkyl group or a chloroalkyl group). When the hydrocarbon group has a substituent, the substituent may further have a substituent, and examples of the substituent include an alkyl group, the aforementioned polymerizable group, and a halogen atom.

When the hydrocarbon group is monovalent, an alkyl group, an alkenyl group or an aryl group is preferred, and an aryl group is more preferred. When the hydrocarbon group is divalent, an alkylene group, an arylene group, or an oxyalkylene group is preferred, and an arylene group is more preferred. When the hydrocarbon group is trivalent or higher-valent, a hydrocarbon group corresponding to the aforementioned monovalent hydrocarbon group or divalent hydrocarbon group is preferred.

The alkyl group and the alkylene group may be any of a linear, branched, or cyclic group. The number of carbon atoms of a linear alkyl group and a linear alkylene group is preferably 1 to 20, more preferably 1 to 12, and even more preferably 1 to 8. The number of carbon atoms of a branched alkyl group and a branched alkylene group is preferably 3 to 20, more preferably 3 to 12, and even more preferably 3 to 8. A cyclic alkyl group and a cyclic alkylene group may be any of a monocyclic group and a polycyclic group. The number of carbon atoms of a cyclic alkyl group and a cyclic alkylene group is preferably 3 to 20, more preferably 4 to 10, and even more preferably 6 to 10.

The number of carbon atoms of the alkenyl group and the alkenylene group is preferably 2 to 10, more preferably 2 to 8, and even more preferably 2 to 4.

The number of carbon atoms of the aryl group and the arylene group is preferably 6 to 18, more preferably 6 to 14, and even more preferably 6 to 10.

In Formula (ii), X¹ is preferably at least one selected from the group consisting of a sulfonic acid group, a carboxylic acid group, and an acid group containing a phosphorus atom. X¹ may be of a single kind, or may be of two or more kinds; however, it is preferable that there are two or more kinds of X₁, and it is preferable that the compound of Formula (ii) has a sulfonic acid group and a carboxylic acid group.

In Formula (ii), n3 is preferably 1 to 3, more preferably 2 or 3, and even more preferably 3.

The molecular weight of the compound that serves as a ligand, or a salt thereof (a compound containing an acid group or a salt thereof), is preferably 1,000 or less, preferably 80 to 750, and more preferably 80 to 600.

(Sulfonic Acid-Copper Complex)

The sulfonic acid-copper complex used for the invention has copper as the metal center, and a sulfonic acid compound as a ligand.

The sulfonic acid compound is more preferably a compound represented by the following Formula (iii).

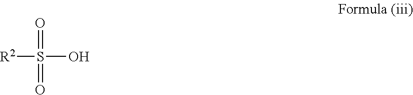

In Formula (iii), R² represents a monovalent organic group.

The sulfonic acid represented by Formula (iii) and a salt thereof acts as ligands coordinated to copper.

A specific monovalent organic group of R² may be a hydrocarbon group, and specific examples thereof include a linear, branched, or cyclic alkyl group, an alkenyl group, and an aryl group. These groups may also be groups interrupted by divalent linking groups (for example, a linear or branched alkylene group, a cyclic alkylene group, an arylene group, —O—, —S—, —CO—, —COO—, —OCO—, —SO₂—, and —NR— (R represents a hydrogen atom or an alkyl group)).

The number of carbon atoms of the linear alkyl group, the branched alkyl group, the cyclic alkyl group, the alkenyl group, and the aryl group are the same as described for R¹ in Formula (ii) described above, and preferred ranges thereof are also the same.

The monovalent organic group may have a substituent, and examples of the substituent include those substituents that may be carried by R¹ in Formula (ii) described above. The substituent that may be carried by the linear alkyl group and the branched alkyl group is at least one of a halogen atom, a polymerizable group, and a carboxylic acid group. The substituent that may be carried by the aryl group is at least one of an alkyl group, an alkoxy group, a halogenated alkyl group, a halogen atom, a polymerizable group, a sulfonic acid group, a carboxylic acid group, and a methyl carboxylate group, and at least one of a sulfonic acid group and a carboxylic acid group is preferred.

Examples of the linear or branched alkylene group, the cyclic alkylene group, and the arylene group as divalent linking groups include divalent linking groups that are each derived by excluding one hydrogen atom from the linear, branched, or cyclic alkyl group and the aryl group described above.

The molecular weight of the compound represented by Formula (iii) is preferably 80 to 750, more preferably 80 to 600, and even more preferably 80 to 450.

Furthermore, the sulfonic acid-copper complex of the invention contains a structure represented by the following Formula (iv).

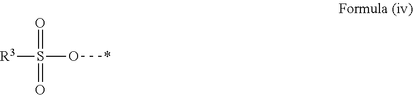

In Formula (iv), R³ represents a monovalent organic group. The symbol “*” represents a site that is coordination-bonded to copper.

In Formula (iv), R³ has the same meaning as R² in Formula (iii), and a preferred range thereof is also the same.

Specific examples of the sulfonic acid compound represented by Formula (iii) are show below; however, the specific examples are not limited to these.

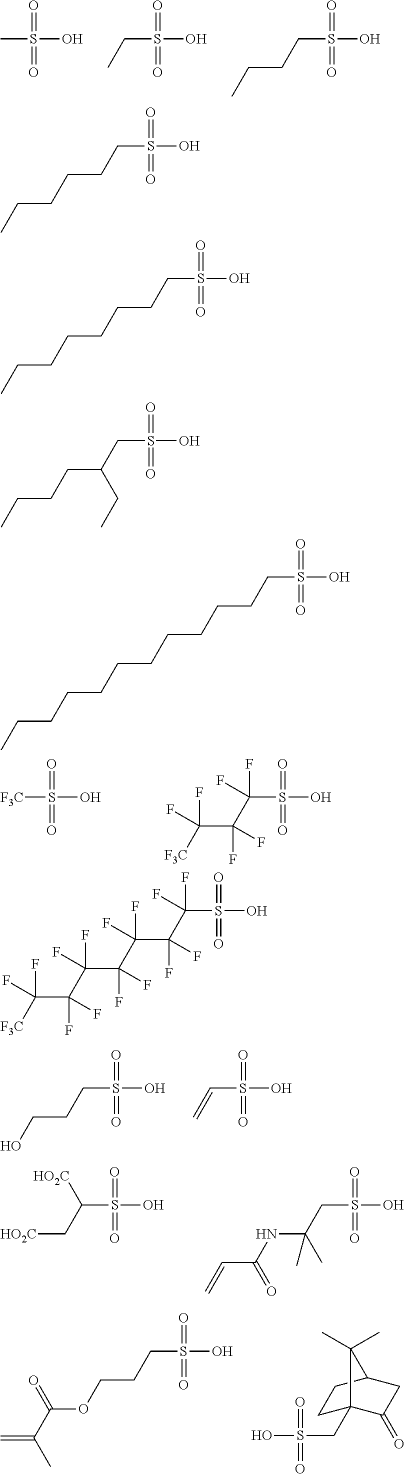

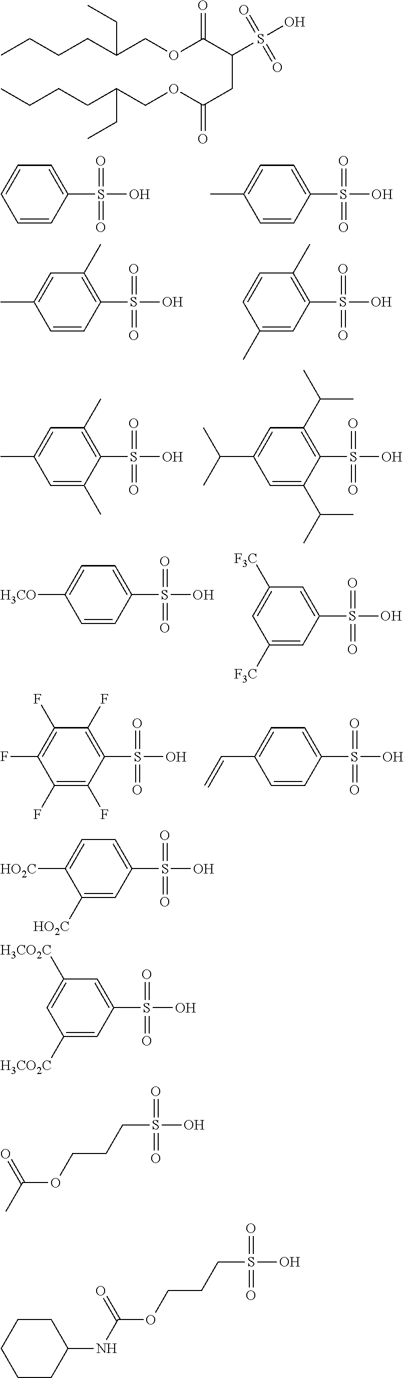

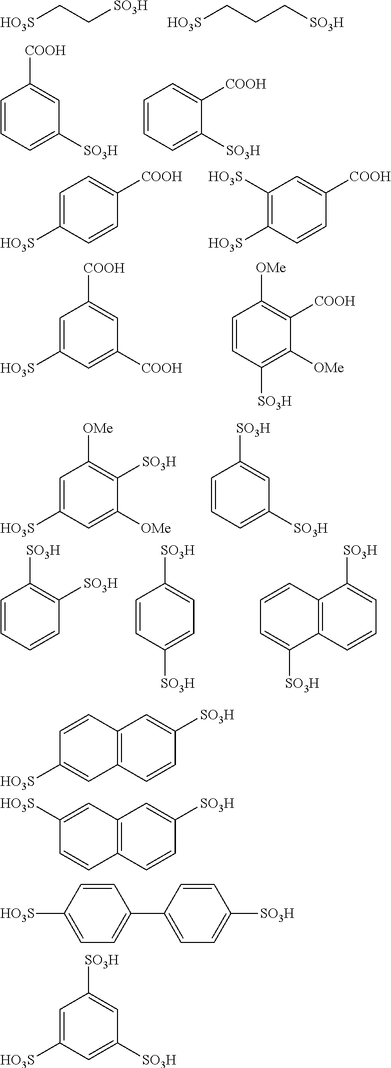

The sulfonic acid-copper complex used for the invention can be obtained by reacting a sulfonic acid compound or a salt thereof that serves as a ligand, with a copper component.

Regarding the copper component, copper or a compound containing copper can be used. As the compound containing copper, for example, copper oxide or a copper salt can be used. The copper salt is preferably monovalent copper or divalent copper, and more preferably divalent copper. More preferred examples of the copper salt include copper acetate, copper chloride, copper formate, copper stearate, copper benzoate, copper ethyl acetoacetate, copper pyrophosphate, copper naphthenate, copper citrate, copper nitrate, copper sulfate, copper carbonate, copper chlorate, copper (meth)acrylate, and copper perchlorate; and even more preferred examples thereof include copper acetate, copper chloride, copper sulfate, copper benzoate, and copper (meth)acrylate.

Regarding the sulfonic acid compound used for the invention, commercially available sulfonic acid can be used, or the sulfonic acid compound can be synthesized by considering a known method. The salt of the sulfonic acid compound is preferably, for example, a metal salt, and specific examples thereof include a sodium salt and a potassium salt.

The reaction ratio applicable when the copper component is reacted with the sulfonic acid compound or a salt thereof is preferably adjusted to 1:1.5 to 1:4 as a molar ratio. At this time, the sulfonic acid compound or a salt thereof may be used singly, or two or more kinds thereof may be used in combination.

Furthermore, the reaction conditions applicable when the copper component is reacted with the sulfonic acid compound or a salt thereof described above are preferably set to, for example, 20° C. to 50° C. and 0.5 hours or longer.

(Carboxylic Acid-Copper Complex or Carboxylic Acid Ester)

Regarding the copper compound used for the invention, a copper compound having a carboxylic acid or a carboxylic acid ester as a ligand (carboxylic acid-copper complex) may also be used, in addition to the copper compounds mentioned above. Meanwhile, in the present specification, a copper compound having a carboxylic acid ester as a ligand is also included in the carboxylic acid-copper complex. Regarding the carboxylic acid used for the copper compound having a carboxylic acid as a ligand, for example, a compound represented by the following Formula (v) is preferred.

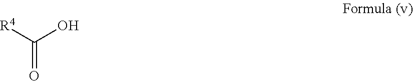

In Formula (v), R⁴ represents a monovalent organic group. The monovalent organic group is not particularly limited; however, the monovalent organic group has the same meaning as the monovalent organic group R² in Formula (iii) described above, and a preferred range thereof is also the same.

(Phosphorus-Containing Copper Complex)

As the copper compound used for the invention, a copper compound having a phosphoric acid ester as a ligand (phosphoric acid ester-copper compound) can also be used. Regarding the phosphoric acid ester compound used for the phosphoric acid ester-copper compound, reference can be made to paragraphs “0015” to “0027” of JP2013-253224A, the disclosure of which is incorporated herein.

(Polymer Type)

Regarding the copper compound used for the invention, a polymer-copper complex may also be used. When the copper compound contains a polymer-copper complex, heat resistance can be enhanced.

A polymer-copper complex is a polymer-type copper compound which includes a polymer containing an acid group ion site (polymer containing an acid group or a salt thereof) and copper ions, and a preferred embodiment thereof is a polymer-type copper compound having an acid group ion site in a polymer as the ligand. This polymer-type copper compound usually has an acid group ion site in a side chain of the polymer, and as the acid group ion site is bonded (for example, coordination bonding) to copper, a crosslinked structure is formed between side chains, with the copper functioning as a starting point. Examples of the polymer-type copper complex include a copper complex of a polymer having a carbon-carbon bond in the main chain; a copper complex of a polymer having a carbon-carbon bond in the main chain and containing fluorine atoms; and a copper complex of a polymer having an aromatic hydrocarbon group and/or an aromatic heterocyclic group in the main chain (hereinafter, referred to as an aromatic group-containing polymer).

The copper component is preferably a compound containing divalent copper. The copper content in the copper component is preferably 2% by mass to 40% by mass, and more preferably 5% by mass to 40% by mass. The copper component may be used singly, or two or more kinds thereof may be used in combination. Regarding the compound containing copper, for example, copper oxide or a copper salt can be used. The copper salt is more preferably divalent copper. The copper salt is particularly preferably copper hydroxide, copper acetate, or copper sulfate.

The acid group that is carried by the polymer containing an acid group or a salt thereof is not particularly limited as long as the acid group can react with the copper component mentioned above; however, it is preferable that the acid group is capable of coordination bonding to the copper component. Specifically, an acid group having an acid dissociation constant (pKa) of 12 or less may be used, and preferred examples thereof include a sulfonic acid group, a carboxylic acid group, a phosphoric acid group, a phosphonic acid group, a phosphinic acid group, and an imide acid group. The acid groups may be used singly or in combination of two or more kinds thereof.

Examples of the atoms or atomic groups that constitute the salt of the acid group used for the invention include metal atoms (particularly alkali metal atoms) such as sodium, and atomic groups such as tetrabutylammonium. Furthermore, in regard to the polymer containing an acid group or a salt thereof, it is desirable that the acid group or the salt thereof is included in at least one of the main chain and a side chain, and it is preferable that the acid group or the salt thereof is included at least in a side chain.

The polymer containing an acid group or a salt thereof is preferably a polymer containing a carboxylic acid group or a salt thereof, and/or a sulfonic acid group or a salt thereof, and more preferably a polymer containing a sulfonic acid group or a salt thereof.

<<First Polymer Containing Acid Group or Salt Thereof>>

A preferred example of the polymer containing an acid group or a salt thereof is a structure in which the main chain has carbon-carbon bonds, and it is preferable that the polymer contains a constituent unit (repeating unit) represented by the following Formula (A1-1).

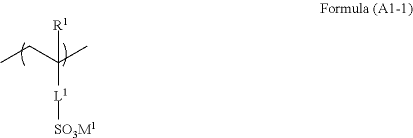

In Formula (A1-1), R¹ represents a hydrogen atom or a methyl group; L¹ represents a single bond or a divalent linking group; and M¹ represents a hydrogen atom, or an atom or atomic group that constitutes a salt with a sulfonic acid group.

In Formula (A1-1), R¹ is preferably a hydrogen atom.

In Formula (A1-1), when L¹ represents a divalent linking group, the divalent linking group is not particularly limited; however, examples thereof include a divalent hydrocarbon group, a heteroarylene group, —O—, —S—, —CO—, —COO—, —OCO—, —SO₂—, —NX— (wherein X represents a hydrogen atom or an alkyl group, and is preferably a hydrogen atom), and groups composed of combinations thereof.

Examples of the divalent hydrocarbon group include a linear, branched or cyclic alkylene group, and an arylene group. The hydrocarbon group may have a substituent, but it is preferable that the hydrocarbon group is unsubstituted.

The number of carbon atoms of the linear alkylene group is preferably 1 to 30, more preferably 1 to 15, and even more preferably 1 to 6. Furthermore, the number of carbon atoms of the branched alkylene group is preferably 3 to 30, more preferably 3 to 15, and even more preferably 3 to 6.

The cyclic alkylene group may be any of a monocyclic group and a polycyclic group. The number of carbon atoms of the cyclic alkylene group is preferably 3 to 20, more preferably 4 to 10, and even more preferably 6 to 10.

The number of carbon atoms of the arylene group is preferably 6 to 18, more preferably 6 to 14, and even more preferably 6 to 10. A phenylene group is particularly preferred.

The heteroarylene group is not particularly limited; however, the heteroarylene group preferably has a 5-membered ring or a 6-membered ring. Furthermore, the heteroarylene group may be a monocyclic group or a fused ring group, and a monocyclic group or a fused ring group having 2 to 8 fused rings is preferred, and a monocyclic group or a fused ring group having 2 to 4 fused rings is more preferred.

In Formula (A1-1), the atom or atomic group that constitutes a salt with a sulfonic acid group, which is represented by M1, has the same meaning as the atom or atomic group that constitutes a salt of an acid group as described above, and the atom or atomic group is preferably a hydrogen atom or an alkali metal atom.

Regarding other constituent units in addition to the constituent unit represented by Formula (A1-1), reference can be made to the description of the copolymerization components disclosed in paragraphs “0068” to “0075” of JP2010-106268A (paragraphs “0112” to “0118” of corresponding US2011/0124824A), the disclosure of which is incorporated herein.

A preferred example of the other constituent unit is a constituent unit represented by the following Formula (A1-2).

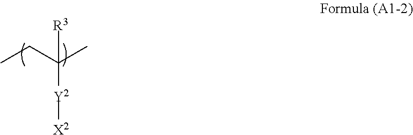

In Formula (A1-2), R³ represents a hydrogen atom or a methyl group, and is preferably a hydrogen atom.

Y² represents a single bond or a divalent linking group, and the divalent linking group has the same meaning as the divalent linking group for Formula (A1-1) described above. Particularly, Y² is preferably a group formed from —COO—, —CO—, —NH—, a linear or branched alkylene group, or a combination thereof, or is preferably a single bond.

In Formula (A1-2), X² represents —PO₃H, —PO₃H₂, —OH, or —COOH, and is preferably —COOH.

In a case in which the polymer (A1-1) contains another constituent unit (preferably, a constituent unit represented by Formula (A1-2)), the molar ratio of the constituent unit represented by Formula (A1-1) and the constituent unit represented by Formula (A1-2) is preferably 95:5 to 20:80, and more preferably 90:10 to 40:60.

<<Second Polymer Containing Acid Group or Salt Thereof>

Regarding the copper compound that can be used for the invention, a polymer-type copper compound which is obtainable by a reaction between a polymer having an acid group or a salt thereof and having an aromatic hydrocarbon group and/or an aromatic heterocyclic group in the main chain (hereinafter, referred to as an aromatic group-containing polymer) and a copper component, may also be used. It is desirable that the aromatic group-containing polymer has at least one of an aromatic hydrocarbon group and an aromatic heterocyclic group in the main chain, and the aromatic group-containing polymer may have two or more kinds thereof. In regard to the acid group or a salt thereof and the copper component, the same details as those of the copper compound obtainable by a reaction between a polymer containing an acid group or a salt thereof and a copper component as described above, are applicable, and preferred ranges thereof are also the same.

The aromatic hydrocarbon group is preferably, for example, an aryl group. The number of carbon atoms of the aryl group is preferably 6 to 20, more preferably 6 to 15, and even more preferably 6 to 12. Particularly, a phenyl group, a naphthyl group, or a biphenyl group is preferred. The aromatic hydrocarbon group may be a monocyclic group or a polycyclic group, but a monocyclic group is preferred.

As the aromatic heterocyclic group, for example, an aromatic heterocyclic group having 2 to 30 carbon atoms can be used. The aromatic heterocyclic group preferably has a 5-membered ring or a 6-membered ring. Furthermore, the aromatic heterocyclic group is a monocyclic group or a fused ring group, and examples thereof include a monocyclic group and a fused ring group having 2 to 8 fused rings. Examples of the heteroatom included in the heterocyclic ring include nitrogen, oxygen, and sulfur atoms, and nitrogen or oxygen is preferred.

In a case in which the aromatic hydrocarbon group and/or the aromatic heterocyclic group has a substituent T, examples of the substituent T include an alkyl group, a polymerizable group (preferably, a polymerizable group containing a carbon-carbon double bond), a halogen atom (a fluorine atom, a chlorine atom, a bromine atom, or an iodine atom), a carboxylic acid ester group, a halogenated alkyl group, an alkoxy group, a methacryloyloxy group, an acryloyloxy group, an ether group, a sulfonyl group, a sulfide group, an amide group, an acyl group, a hydroxy group, a carboxyl group, and an aralkyl group. An alkyl group (particularly, an alkyl group having 1 to 3 carbon atoms) is preferred.

Particularly, it is preferable that the aromatic group-containing polymer is at least one polymer selected from a polyether sulfone-based polymer, a polysulfone-based polymer, a polyether ketone-based polymer, a polyphenylene ether-based polymer, a polyimide-based polymer, a polybenzimidazole-based polymer, a polyphenylene-based polymer, a phenol resin-based polymer, a polycarbonate-based polymer, a polyamide-based polymer and a polyester-based polymer. Examples of the various polymers are described below.

Polyether sulfone-based polymer: a polymer having a main chain structure represented by (—O-Ph-SO₂-Ph-) (wherein Ph represents a phenylene group; hereinafter, the same applies)

Polysulfone-based polymer: a polymer having a main chain structure represented by (—O-Ph-Ph-O-Ph-SO₂-Ph-)

Polyether ketone-based polymer: a polymer having a main chain structure represented by (—O-Ph-O-Ph-C(═O)-Ph-)

Polyphenylene ether-based polymer: a polymer having a main chain structure represented by (-Ph-O—, -Ph-S—)

Polyphenylene-based polymer: a polymer having a main chain structure represented by (-Ph-)

Phenol resin-based polymer: a polymer having a main chain structure represented by (-Ph(OH)—CH₂—)

Polycarbonate-based polymer: a polymer having a main chain structure represented by (-Ph-O—C(═O)—O—)

As a polyamide-based polymer, for example, a polymer having a main chain structure represented by (-Ph-C(═O)—NH—)

As a polyester-based polymer, for example, a polymer having a main chain structure represented by (-Ph-C(═O)O—)

Regarding the polyether sulfone-based polymer, the polysulfone-based polymer, and the polyether ketone-based polymer, for example, reference can be made to the main chain structure described in paragraph “0022” of JP2006-310068A and paragraph “0028” of JP2008-27890A, the disclosures of which are incorporated herein.

Regarding the polyimide-based polymer, reference can be made to the main chain structure described in paragraphs “0047” to “0058” of JP2002-367627A and paragraphs “0018” to “0019” of JP2004-35891A, the disclosures of which are incorporated herein.

According to a preferred example of the aromatic group-containing polymer, it is preferable that the aromatic group-containing polymer contains a constituent unit represented by the following Formula (A1-3).

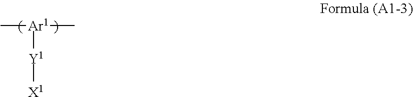

In Formula (A1-3), Ar¹ represents an aromatic hydrocarbon group and/or an aromatic heterocyclic group; Y¹ represents a single bond or a divalent linking group; and X¹ represents an acid group or a salt thereof.

In Formula (A1-3), when Ar¹ represents an aromatic hydrocarbon group, the aromatic hydrocarbon group has the same meaning as the aromatic hydrocarbon group described above, and a preferred range thereof is also the same. When Ar¹ represents an aromatic heterocyclic group, the aromatic heterocyclic group has the same meaning as the aromatic heterocyclic group described above, and a preferred range thereof is also the same.

Ar¹ may have a substituent in addition to —Y¹—X¹ in Formula (A1-3). When Ar¹ has a substituent, the substituent has the same meaning as the substituent T described above, and a preferred range thereof is also the same.

In Formula (A1-3), Y¹ is preferably a single bond. When Y¹ represents a divalent linking group, examples of the divalent linking group include a hydrocarbon group, an aromatic heterocyclic group, —O—, —S—, —SO₂—, —CO—, —C(═O)O—, —O—C(═O)—, —SO₂—, —NX— (where X represents a hydrogen atom or an alkyl group, and a hydrogen atom is preferred), —C(RY¹)(RY²)—, and groups composed of combinations thereof. Here, RY¹ and RY² each independently represent a hydrogen atom, a fluorine atom, or an alkyl group.

Examples of the hydrocarbon group include a linear, branched or cyclic alkylene group, and an arylene group. The number of carbon atoms of the linear alkylene group is preferably 1 to 20, more preferably 1 to 10, and even more preferably 1 to 6. The number of carbon atoms of the branched alkylene group is preferably 3 to 20, more preferably 3 to 10, and even more preferably 3 to 6. The cyclic alkylene group may be any of a monocyclic group and a polycyclic group. The number of carbon atoms of the cyclic alkylene group is preferably 3 to 20, more preferably 4 to 10, and even more preferably 6 to 10. These linear, branched or cyclic alkylene groups may have hydrogen atoms in the alkylene group substituted by fluorine atoms.

The arylene group has the same meaning as in the case in which the divalent linking group of Formula (A1-1) described above is an arylene group.

The aromatic heterocyclic group is not particularly limited; however, the aromatic heterocyclic group preferably has a 5-membered ring or a 6-membered ring. Furthermore, the aromatic heterocyclic group may be a monocyclic group or a fused ring group, and a monocyclic group or a fused ring group having 2 to 8 fused rings is preferred, while a monocyclic group or a fused ring group having 2 to 4 fused rings is more preferred.

In Formula (A1-3), the acid group represented by X¹ or a salt thereof has the same meaning as the acid group or a salt thereof described above, and preferred ranges thereof are also the same.

The weight average molecular weight of the polymer containing a constituent unit represented by Formula (A1-1), Formula (A1-2) or Formula (A1-3) is preferably 1,000 or more, more preferably 1,000 to 10,000,000, even more preferably 3,000 to 1,000,000, and particularly preferably 4,000 to 400,000.

Specific examples of the polymer containing a constituent unit represented by Formula (A1-1), Formula (A1-2) or Formula (A1-3) include compounds described below and salts of compounds described below, but the invention is not intended to be limited to these.

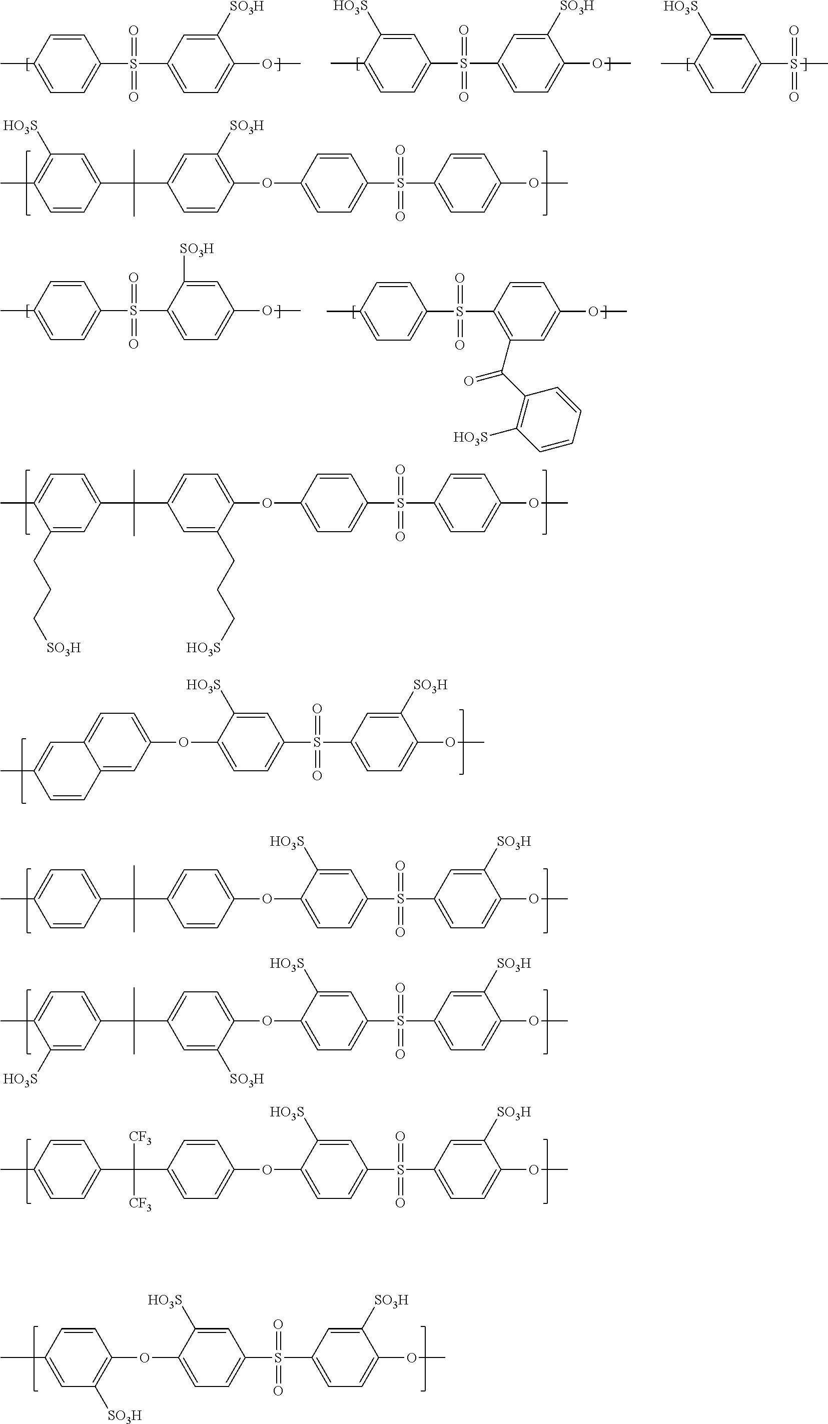

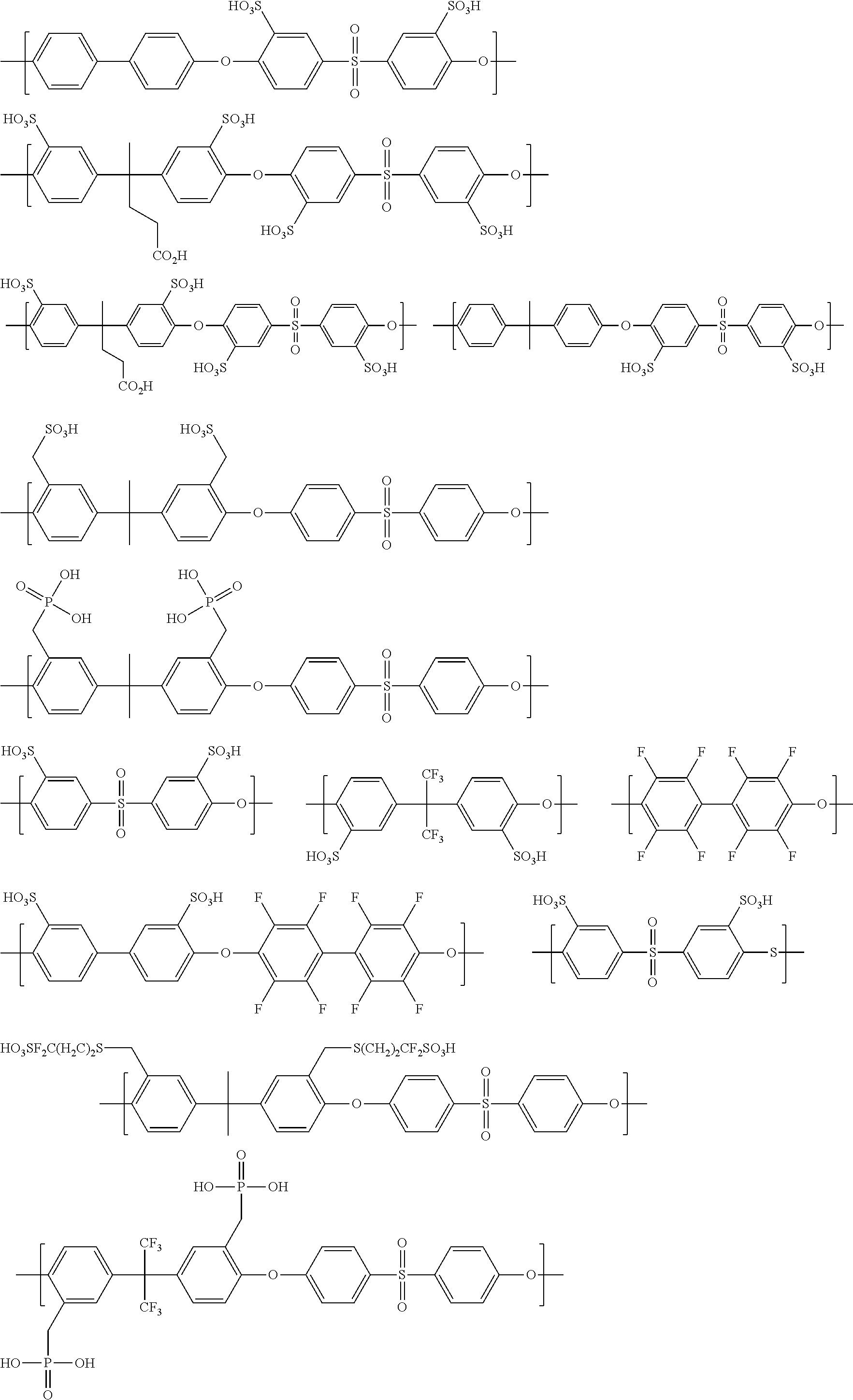

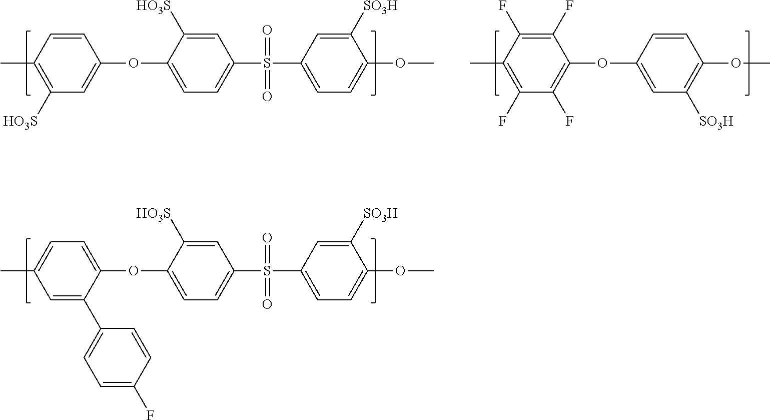

Meanwhile, an embodiment in which a copper compound is included in the composition of the invention has been described in the above; however, as will be described below, it is also acceptable to use an infrared-light-blocking layer formed from the composition of the invention and a layer containing the copper compound in combination. More specifically, a multilayer infrared-light-blocking layer including an infrared-light-blocking layer formed from the composition of the invention and a layer containing a copper compound may be formed.

<Other Components>

The composition of the invention may also include components other than inorganic microparticles, a dispersing agent and a copper compound. Examples thereof include a binder polymer, a polymerizable monomer, a polymerization initiator, a surfactant, an adhesion promoter, an ultraviolet absorber, a solvent, a polymerization inhibitor, a chain transfer agent, and a sensitizer.

These components will be described in detail below.

(Binder Polymer)

It is preferable that the composition of the invention further includes a binder polymer, from the viewpoint of enhancing the film characteristics of the infrared-light-blocking layer thus formed.

Regarding the binder polymer, it is preferable to use a linear organic polymer. As the linear organic polymer, any known polymer can be arbitrarily used. Preferably, a linear organic polymer which is soluble or swellable in water or weakly alkaline water is selected in order to enable developing with water or developing with weakly alkaline water. The linear organic polymer is selected and used according to the use as a film forming agent as well as a developing agent used with water, weakly alkaline water or an organic solvent. For example, when a water-soluble organic polymer is used, developing with water is enabled. Examples of such a linear organic polymer include radical polymers having carboxylic acid groups in side chains, for example, those described in JP1984-44615A (JP-S59-44615A), JP1979-34327B (JP-S54-34327B), JP1983-12577B (JP-S58-12577B), JP1979-25957B (JP-S54-25957B), JP1979-92723A (JP-S54-92723A), JP1984-53836A (JP-S59-53836A), and JP1984-71048A (JP-S59-71048A), that is, a resin obtained by homopolymerizing or copolymerizing a monomer having a carboxyl group; a resin obtained by homopolymerizing or copolymerizing a monomer having an acid anhydride and subjecting the acid anhydride unit to hydrolysis, half-esterification or half-amidation; and an epoxy acrylate obtained by modifying an epoxy resin with an unsaturated monocarboxylic acid and an acid anhydride. Examples of the monomer having a carboxyl group include acrylic acid, methacrylic acid, itaconic acid, crotonic acid, maleic acid, fumaric acid, and 4-carboxylstyrene. Examples of the monomer having an acid anhydride include maleic anhydride.

Furthermore, acidic cellulose derivatives similarly having carboxylic acid groups in side chains are also available. In addition to these, a polymer obtained by adding a cyclic acid anhydride to a polymer having hydroxyl groups, and the like are useful.

According to the invention, in a case in which a copolymer is used as the binder polymer, monomers other than the monomers described above can also be used as the compound to be copolymerized. Examples of the other monomers include the compounds of the following (1) to (12).

(1) Acrylic acid esters and methacrylic acid esters having aliphatic hydroxyl groups, such as 2-hydroxyethyl acrylate, 2-hydroxypropyl acrylate, 3-hydroxypropyl acrylate, 4-hydroxybutyl acrylate, 2-hydroxyethyl methacrylate, 2-hydroxypropyl methacrylate, 3-hydroxypropyl methacrylate, and 4-hydroxybutyl methacrylate.

(2) Alkyl acrylates such as methyl acrylate, ethyl acrylate, propyl acrylate, butyl acrylate, isobutyl acrylate, amyl acrylate, hexyl acrylate, 2-ethylhexyl acrylate, octyl acrylate, benzyl acrylate, 2-chloroethyl acrylate, glycidyl acrylate, 3,4-epoxycyclohexylmethyl acrylate, vinyl acrylate, 2-phenylvinyl acrylate, 1-propenyl acrylate, allyl acrylate, 2-allyloxyethyl acrylate, and propargyl acrylate.

(3) Alkyl methacrylates such as methyl methacrylate, ethyl methacrylate, propyl methacrylate, butyl methacrylate, isobutyl methacrylate, amyl methacrylate, hexyl methacrylate, 2-ethylhexyl methacrylate, cyclohexyl methacrylate, benzyl methacrylate, 2-chloroethyl methacrylate, glycidyl methacrylate, 3,4-epoxycyclohexylmethyl methacrylate, vinyl methacrylate, 2-phenylvinyl methacrylate, 1-propenyl methacrylate, allyl methacrylate, 2-allyloxyethyl methacrylate, and propargyl methacrylate.

(4) Acrylamides or methacrylamides, such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, N-ethyl-N-phenylacrylamide, vinylacrylamide, vinylmethacrylamide, N,N-diallylacrylamide, N,N-diallylmethacrylamide, allylacrylamide, and allylmethacrylamide.

(5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(6) Vinyl esters such as vinyl acetate, vinyl chloroacetate, vinyl butyrate, and vinyl benzoate.

(7) Styrenes such as styrene, α-methylstyrene, methylstyrene, chloromethylstyrene, and p-acetoxystyrene.

(8) Vinyl ketones such as methyl vinyl ketone, ethyl vinyl ketone, propyl vinyl ketone, and phenyl vinyl ketone.

(9) Olefins such as ethylene, propylene, isobutylene, butadiene, and isoprene.

(10) N-vinylpyrrolidone, acrylonitrile, methacrylonitrile, and the like.

(11) Unsaturated imides such as maleimide, N-acryloylacrylamide, N-acetylmethacrylamide, N-propionylmethacrylamide, and N-(p-chlorobenzoyl)methacrylamide.

(12) Methacrylic acid-based monomers having heteroatoms bonded to the α-position, for example, the compounds described in JP2002-309057A, JP2002-311569A, and the like.

According to the invention, these monomers can be applied to the synthesis of copolymers by combining the monomers without any particular limitations in the scope of the invention. For example, examples of copolymers obtainable by polymerizing monomer components including these monomers are shown below; however, the invention is not intended to be limited to these. The composition ratios of the exemplary compounds described below are on the basis of mol %.

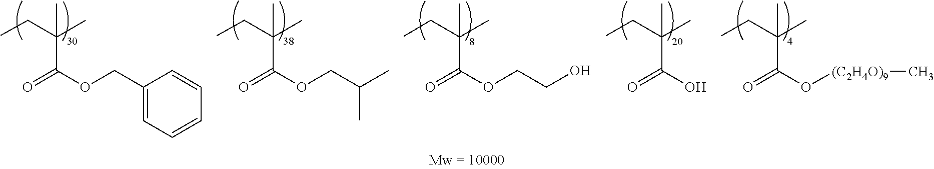

It is preferable that the binder polymer contains a repeating unit obtainable by polymerizing a monomer component of a compound represented by the following Formula (ED) (hereinafter, also referred to as “ether dimer”).

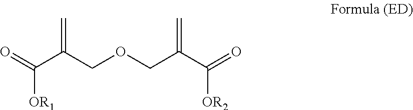

In Formula (ED), R₁ and R₂ each independently represent a hydrogen atom, or a hydrocarbon group having 1 to 25 carbon atoms which may be substituted.

In Formula (ED) that represents an ether dimer, the hydrocarbon group having 1 to 25 carbon atoms which may be substituted as represented by R₁ and R₂ is not particularly limited; however, examples thereof include a linear or branched alkyl group; an aryl group; an alicyclic group such as cyclohexyl, t-butylcyclohexyl, dicyclopentadienyl, tricyclodecanyl, isobornyl, adamantyl, or 2-methyl-2-adamantyl; an alkyl group substituted with an alkoxy such as 1-methoxyethyl or 1-ethoxyethyl; and an alkyl group substituted with an aryl group such as benzyl. Among these, substituents having primary or secondary carbon atoms that are not easily detached by acid or heat, such as methyl, ethyl, cyclohexyl and benzyl, are particularly preferred in view of heat resistance.

Regarding specific examples of the ether dimer, reference can be made to the description of the ether dimer in paragraph “0565” of JP2012-208494A (paragraph “0694” of corresponding US2012/235099A), the disclosure of which is incorporated herein. Among these, dimethyl-2,2′-[oxybis(methylene)]bis-2-propenoate, diethyl-2,2′-[oxybis(methyl ene)]bis-2-propenoate, dicyclohexyl-2,2′-[oxybis(methylene)]bis-2-propenoate, and dibenzyl-2,2′-[oxybis(methylene)]bis-2-propenoate are preferred. These ether dimers may be used singly, or in combination of two or more kinds thereof. Furthermore, a structure derived from the compound represented by Formula (ED) may be copolymerized with other monomers.

Examples of the other monomer that can be copolymerized with an ether dimer include a monomer for introducing an acid group, a monomer for introducing a radical polymerizable double bond, a monomer for introducing an epoxy group, and other copolymerizable monomers in addition to these. These monomers may be used singly, or two or more kinds thereof may be used in combination.

Examples of the monomer for introducing an acid group include monomers having carboxyl groups, such as (meth)acrylic acid and itaconic acid; monomers having phenolic hydroxyl groups, such as N-hydroxyphenylmaleimide; and monomers having carboxylic acid anhydride groups, such as maleic anhydride and itaconic anhydride. Among these, (meth)acrylic acid is particularly preferred.

Furthermore, the monomer for introducing an acid group may be a monomer which can provide an acid group after polymerization, and examples thereof include monomers having hydroxyl groups, such as 2-hydroxyethyl (meth)acrylate; monomers having epoxy groups, such as glycidyl (meth)acrylate; and monomers having isocyanate groups, such as 2-isocyanatoethyl (meth)acrylate. When a monomer which can provide an acid group after polymerization is used, it may be required to perform a treatment for providing an acid group after polymerization. The treatment for providing an acid group after polymerization may vary depending on the kind of the monomer, and for example, the following treatments may be used. In the case of using a monomer having a hydroxyl group, for example, a treatment of adding an acid anhydride such as succinic anhydride, tetrahydrophthalic anhydride or maleic anhydride may be used. In the case of using a monomer having an epoxy group, for example, a treatment of adding a compound having an amino group and an acid group, such as N-methyl aminobenzoate or N-methylaminophenol, or adding, for example, an acid anhydride such as succinic anhydride, tetrahydrophthalic anhydride or maleic anhydride to, for example, a hydroxyl group produced after adding an acid such as (meth)acrylic acid, may be used. In the case of using a monomer having an isocyanate group, for example, a treatment of adding a compound having a hydroxyl group and an acid group, such as 2-hydroxybutyric acid, may be used.

When a polymer obtainable by polymerizing monomer components including a compound represented by Formula (ED) contains a monomer for introducing an acid group, the content proportion of the monomer is not particularly limited; however, the content proportion is preferably 5% by mass to 70% by mass, and more preferably 10% by mass to 60% by mass, relative to the total amount of the monomer components.

Examples of the monomer for introducing a radical polymerizable double bond include monomers having carboxyl groups, such as (meth)acrylic acid and itaconic acid; monomers having carboxylic acid anhydride groups, such as maleic anhydride and itaconic acid anhydride; and monomers having epoxy groups, such as glycidyl (meth)acrylate, 3,4-epoxycyclohexylmethyl (meth)acrylate, and o- (or m- or p-)vinylbenzyl glycidyl ether. When a monomer for introducing a radical polymerizable double bond is to be used, it is necessary to perform a treatment for providing a radical polymerizable double bond after polymerization. The treatment for providing a radical polymerizable double bond after polymerization may vary depending on the kind of the monomer capable of providing a radical polymerizable double bond to be used, and for example, the following treatments may be used. In the case of using a monomer having a carboxyl group, such as (meth)acrylic acid or itaconic acid, a treatment of adding a compound having an epoxy group and a radical polymerizable double bond, such as glycidyl (meth)acrylate, 3,4-epoxycyclohexylmethyl (meth)acrylate, or o- (or m- or p-)vinylbenzyl glycidyl ether, may be used. In the case of using a monomer having a carboxylic acid anhydride group, such as maleic anhydride or itaconic acid anhydride, a treatment of adding a compound having a hydroxyl group and a radical polymerizable double bond, such as 2-hydroxyethyl (meth)acrylate, may be used. In the case of using a monomer having an epoxy group, such as glycidyl (meth)acrylate, 3,4-epoxycyclohexylmethyl (meth)acrylate, or o- (or m- or p-)vinylbenzyl glycidyl ether, a treatment of adding a compound having an acid group and a radical polymerizable double bond, such as (meth)acrylic acid, may be used.

When a polymer obtainable by polymerizing monomer components including a compound represented by Formula (ED) contains a monomer for introducing a radical polymerizable double bond, the content proportion of the monomer is not particularly limited; however, the content proportion is preferably 5% by mass to 70% by mass, and more preferably 10% by mass to 60% by mass, relative to the total amount of the monomer components.

Examples of the monomer for introducing an epoxy group include glycidyl (meth)acrylate, 3,4-epoxycyclohexylmethyl (meth)acrylate, and o- (or m- or p-)vinylbenzyl glycidyl ether.

When a polymer obtainable by polymerizing monomer components including a compound represented by Formula (ED) contains a monomer for introducing an epoxy group, the content proportion of the monomer is not particularly limited; however, the content proportion is preferably 5% by mass to 70% by mass, and more preferably 10% by mass to 60% by mass, relative to the total amount of the monomer components.

Examples of other copolymerizable monomers include (meth)acrylic acid esters such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, methyl 2-ethylhexyl (meth)acrylate, cyclohexyl (meth)acrylate, benzyl (meth)acrylate, and 2-hydroxyethyl (meth)acrylate; aromatic vinyl compounds such as styrene, vinyltoluene, and α-methylstyrene; N-substituted maleimides such as N-phenylmaleimide and N-cyclohexylmaleimide; butadiene or substituted butadiene compounds such as butadiene and isoprene; ethylene or substituted ethylene compounds such as ethylene, propylene, vinyl chloride, and acrylonitrile; and vinyl esters such as vinyl acetate. Among these, methyl (meth)acrylate, cyclohexyl (meth)acrylate, benzyl (meth)acrylate, and styrene are preferred from the viewpoint that transparency is satisfactory, and heat resistance is not easily impaired.

When a polymer obtainable by polymerizing monomer components including a compound represented by Formula (ED) contains another copolymerizable monomer, the content proportion of the monomer is not particularly limited; however, the content proportion is preferably 95% by mass or less, and more preferably 85% by mass or less.

The weight average molecular weight of the polymer obtainable by polymerizing monomer components including a compound represented by Formula (ED) is not particularly limited; however, from the viewpoints of the viscosity of the infrared-light-blocking composition and the heat resistance of a coating film formed from the composition, the weight average molecular weight is preferably 2,000 to 200,000, more preferably 5,000 to 100,000, and even more preferably 5,000 to 20,000.

Furthermore, when a polymer obtainable by polymerizing monomer components including a compound represented by Formula (ED) has acid groups, a polymer having an acid value of preferably 20 mgKOH/g to 500 mgKOH/g, and more preferably 50 mgKOH/g to 400 mgKOH/g, is desirable.

A polymer obtainable by polymerizing monomer components including a compound represented by Formula (ED) can be easily obtained by polymerizing at least the aforementioned monomers including an ether dimer. At this time, a cyclization reaction of the ether dimer proceeds simultaneously with polymerization, and thus a tetrahydropyran ring structure is formed.

The polymerization method to be applied to the synthesis of a polymer obtainable by polymerizing monomer components including a compound represented by Formula (ED) is not particularly limited, and various conventionally known polymerization methods can be employed; however, it is particularly preferable to employ a solution polymerization method. More specifically, a polymer obtainable by polymerizing monomer components including a compound represented by Formula (ED) can be synthesized according to, for example, the synthesis method for polymer (a) described in JP2004-300204A.

Exemplary compounds of the polymer obtainable by polymerizing monomer components including a compound represented by Formula (ED) are shown below; however, the invention is not intended to be limited to these. The composition ratios of the exemplary compounds shown below are on the basis of mol %.

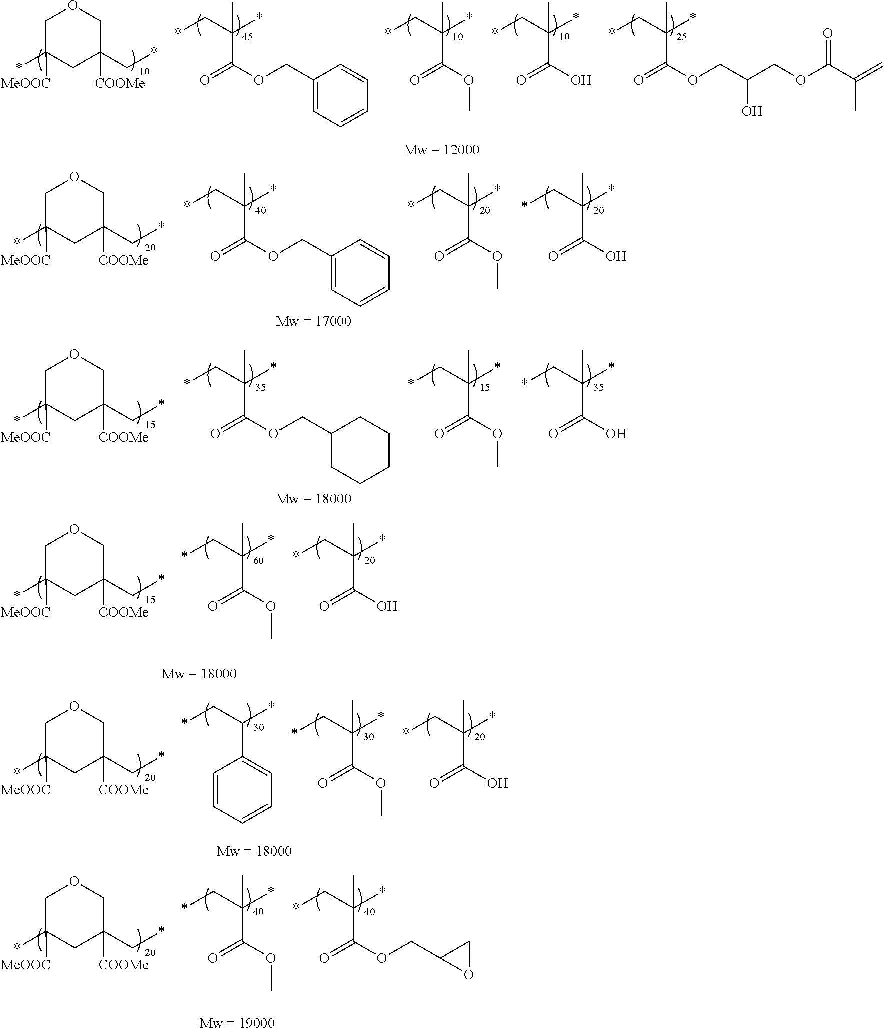

According to the invention, a polymer obtained by copolymerizing dimethyl-2,2′-[oxybis(methylene)]bis-2-propenoate (hereinafter, referred to as “DM”), benzyl methacrylate (hereinafter, referred to as “BzMA”), methyl methacrylate (hereinafter, referred to as “MMA”), methacrylic acid (hereinafter, referred to as “MAA”), and 2-hydroxypropylene glycol dimethacrylate (hereinafter, referred to as “X”) is particularly preferred. Particularly, it is preferable that the molar ratio of DM:BzMA:MMA:MAA:X is 5 to 15:40 to 50:5 to 15:5 to 15:20 to 30. It is preferable that 95% by mass or more of the components constituting the copolymer used in the invention is composed of these components. Furthermore, the weight average molecular weight of such a polymer is preferably 9,000 to 20,000.

Among these, a (meth)acrylic resin having an allyl group or a vinyl ester group and a carboxyl group in a side chain, and an alkali-soluble resin having a double bond in a side chain, which is described in JP2000-187322A and JP2002-62698A, or an alkali-soluble resin having an amide group in a side chain, which is described in JP2001-242612A, are suitable because the resins are excellently balanced between film strength, sensitivity, and developability. Examples of the polymer described above include DIANAL NR series (manufactured by Mitsubishi Rayon Co., Ltd.), PHOTOMER 6173 (COOH-containing polyurethane acrylic oligomer, manufactured by Diamond Shamrock Co. Ltd.), VISCOAT R-264, KS RESIST 106 (all manufactured by Osaka Organic Chemical Industry, Ltd.), CYCLOMER P series such as CYCLOMER P ACA230AA, PLACCEL CF200 series (all manufactured by Daicel Corporation.), and EBECRYL 3800 (manufactured by Daicel-UCB Co., Ltd.).

The weight average molecular weight of the binder polymer that can be used in the composition of the invention (value measured by a GPC method and calculated relative to polystyrene standards) is preferably 3,000 or more, more preferably in the range of from 3,000 to 300,000, and even more preferably in the range of from 3,000 to 150,000. The dispersity (weight average molecular weight/number average molecular weight) is preferably 1 or more, and more preferably in the range of from 1.1 to 10.

These binder polymers may be any of random polymers, block polymers, and graft polymers.

The binder polymer that can be used for the invention can be synthesized by a conventionally known method. Examples of the solvent that is used when synthesis is conducted include tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethyl sulfoxide, and water. These solvents are used singly or as mixtures of two or more kinds thereof.

Examples of the radical polymerization initiator used when the binder polymer is synthesized include known compounds such as azo-based initiators and peroxide initiators.

In the composition of the invention, the binder polymer can be used singly or in combination of two or more kinds thereof.

When the binder polymer is included in the composition, the content of the binder polymer is preferably 1% by mass to 60% by mass, more preferably 3% by mass to 50% by mass, and even more preferably 5% by mass to 50% by mass, and particularly preferably 10% by mass to 25% by mass, relative to the total solid content of the composition. When the content of the binder polymer is in the range described above, an excellent balance between the mechanical strength and the infrared-light-blocking performance of the infrared-light-blocking layer thus formed is achieved.

The binder polymer may be used singly, or two or more kinds thereof may be used.

Furthermore, the mass ratio between the mass of the binder polymer and the mass of the inorganic microparticles (mass of binder polymer/mass of inorganic microparticles) is not particularly limited; however, from the viewpoint that an excellent balance between the mechanical strength and the infrared-light-blocking performance of the infrared-light-blocking layer thus formed is achieved, the mass ratio is preferably 0.01 to 1.0, preferably 0.1 to 0.8, and more preferably 0.2 to 0.5.

(Polymerizable Monomer (Polymerizable Compound))

The composition may include a polymerizable monomer. When a polymerizable monomer is included, the mechanical strength of the infrared-light-blocking layer thus formed is enhanced, and pattern formation is enabled.

It is desirable that the polymerizable monomer contains a polymerizable group, and examples of the polymerizable group include a radical polymerizable group (for example, a vinyl group or a (meth)acryloyl group), and a cationic polymerizable group (for example, an epoxy group). Regarding the polymerizable monomer, it is preferable to use an addition polymerizable compound having at least one ethylenically unsaturated double bond, and it is more preferable to use a compound having at least one terminal ethylenically unsaturated bond, and preferably two or more terminal ethylenically unsaturated bonds. Such compounds are widely known in the relevant technical field, and these can be used without any particular limitations in this invention.

Furthermore, regarding the polymerizable monomer, a compound having an ethylenically unsaturated group, which has at least one addition polymerizable ethylene group and has a boiling point of 100° C. or higher at normal pressure, is also preferred. Examples thereof include monofunctional acrylates or methacrylates such as polyethylene glycol mono(meth)acrylate, polypropylene glycol mono(meth)acrylate, and phenoxyethyl (meth)acrylate; polyethylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol penta(meth)acrylate, dipentaerythritol hexa(meth)acrylate, hexanediol (meth)acrylate, trimethylolpropane tri(acryloyloxypropyl) ether, tri(acryloyloxyethyl) isocyanurate, and mixtures thereof. It is preferable that the polymerizable monomer is pentaerythritol tetra(meth)acrylate.

Among them, preferred examples of the polymerizable monomer and the like include pentaerythritol tetraacrylate (a commercially available product thereof is A-TMMT; manufactured by Shin-Nakamura Chemical Co., Ltd.), dipentaerythritol triacrylate (a commercially available product is KAYARAD D-330; manufactured by Nippon Kayaku Co., Ltd.), dipentaerythritol tetraacrylate (a commercially available product thereof is KAYARAD D-320; manufactured by Nippon Kayaku Co., Ltd.), dipentaerythritol penta(meth)acrylate (a commercially available product thereof is KAYARAD D-310; manufactured by Nippon Kayaku Co., Ltd.), and dipentaerythritol hexa(meth)acrylate (a commercially available product thereof is KAYARAD DPHA; manufactured by Nippon Kayaku Co., Ltd.), and pentaerythritol tetraacrylate is more preferred.

In addition to the above-mentioned compounds, examples of the polymerizable monomer include DENACOL EX-211L, EX-212L, EX-214L, EX-216L, EX-321L, and EX-850L (all manufactured by Nagase ChemteX Corporation.), JER-152, JER-154, JER-157S70, and JER 157565 (all manufactured by Mitsubishi Chemical Corporation), SR-494 (manufactured by Arkema Inc.), A-TMMT (manufactured by Shin-Nakamura Chemical Co., Ltd.), DPCA-20, DPCA-30, DPCA-60, and DPCA-120 (all manufactured by Nippon Kayaku Co., Ltd.).

The polymerizable monomer is a polyfunctional monomer, which may have an acid group such as a carboxyl group, a sulfonic acid group, or a phosphoric acid group. Therefore, when the ethylenic compound is a compound having an unreacted carboxyl group as in the case of using a mixture as described above, this ethylenic compound can be directly utilized; however, if necessary, an acid group may be introduced into the ethylenic compound by reacting a non-aromatic carboxylic acid anhydride with a hydroxyl group of the ethylenic compound described above. In this case, specific examples of the non-aromatic carboxylic acid anhydride used include tetrahydrophthalic anhydride, alkylated tetrahydrophthalic anhydride, hexahydrophthalic anhydride, alkylated hexahydrophthalic anhydride, succinic anhydride, and maleic anhydride.

The monomer having an acid group is an ester between an aliphatic polyhydroxy compound and an unsaturated carboxylic acid. A polyfunctional monomer having an acid group provided by reacting an unreacted hydroxyl group of an aliphatic polyhydroxy compound with a non-aromatic carboxylic acid anhydride is preferred, and particularly preferably, in regard to this ester, the aliphatic polyhydroxy compound is pentaerythritol and/or dipentaerythritol. Examples of commercially available products thereof include polybasic acid-modified acrylic oligomers, ARONIX series M-305, M-510, and M-520, manufactured by Toagosei Co., Ltd.

A preferred acid value of the polyfunctional monomer having an acid group is 0.1 mgKOH/g to 40 mgKOH/g, and particularly preferably 5 mgKOH/g to 30 mgKOH/g. In a case in which two or more kinds of polyfunctional monomers having different acid groups are used in combination, or in a case in which a polyfunctional monomer which does not have an acid group is used in combination, it is essential to prepare the composition such that the overall acid value of the polyfunctional monomers is within the range described above.

In regard to these polymerizable monomers, the details of the method for use, such as the structure, the matter of single use or combined use, and the amount added, can be arbitrarily set according to the final performance design of the composition. For example, these factors are selected from the viewpoints described below.

In view of sensitivity, a structure having a high content of unsaturated groups per molecule is preferred, and in many cases, a bifunctional or higher-functional structure is preferred. Also, in order to obtain high strength of the infrared-light-blocking layer, a trifunctional or higher-functional structure is desirable, and a method of regulating both sensitivity and strength by using compounds having different functionalities and different polymerizable groups (for example, acrylic acid esters, methacrylic acid esters, styrene-based compounds, and vinyl ether-based compounds) in combination, is also effective.

Furthermore, the selection and the method for use of the polymerizable monomer are important factors also for the compatibility with other components (for example, a polymerization initiator and inorganic microparticles) that are included in the composition, and for dispersibility, and for example, compatibility may be enhanced by using a low-purity compound or by using two or more kinds of different components in combination. Also, a particular structure may be selected for the purpose of enhancing the adhesiveness to a hard surface of a substrate or the like.

When the composition includes a polymerizable monomer, the content of the polymerizable monomer is preferably in the range of 1% by mass to 40% by mass, more preferably in the range of 3% by mass to 35% by mass, even more preferably in the range of 5% by mass to 30% by mass, and particularly preferably in the range of 10% by mass to 25% by mass, relative to the total solid content of the composition. When the content of the polymerizable monomer is in this range, satisfactory curability is obtained, which is preferable.

The polymerizable monomer may be used singly, or two or more kinds thereof may be used in combination.

Furthermore, the mass ratio between the mass of the polymerizable monomer and the mass of the inorganic microparticles (mass of polymerizable monomer/mass of inorganic microparticles) is not particularly limited; however, from the viewpoint that an excellent balance between the mechanical strength and the infrared-light-blocking performance of the infrared-light-blocking layer thus formed is achieved, the mass ratio is preferably 0.01 to 1.0, preferably 0.1 to 0.8, and more preferably 0.2 to 0.5.

(Polymerization Initiator)

The composition may include a polymerization initiator. When a polymerization initiator is included, curability is enhanced.

The polymerization initiator is not particularly limited as long as the polymerization initiator has an ability to initiate polymerization of a polymerizable monomer, and can be appropriately selected from known polymerization initiators.

Furthermore, from the viewpoint of achieving satisfactory curing in a treatment for curing the composition that will be described below, for example, a compound having radiation sensitivity for light from the ultraviolet region to the visible region (photopolymerization initiator) is preferred. Also, the polymerization initiator may be an activator which causes a certain action with a photo-excited sensitizer and produces an active radical, or may be an initiator which initiates cationic polymerization depending on the kind of the monomer.

Furthermore, it is preferable that the polymerization initiator includes at least one compound having a molecular extinction coefficient of at least about 50 in the range of about 300 nm to 800 nm (more preferably 330 nm to 500 nm).

The polymerization initiator that can be used for the invention is preferably at least a compound having an aromatic group, and examples thereof include an acylphosphine compound, an acetophenone-based compound, an α-aminoketone compound, a benzophenone-based compound, a benzoin ether-based compound, a ketal derivative compound, a thioxanthone compound, an oxime compound, a hexaarylbiimidazole compound, a trihalomethyl compound, an azo compound, an organic peroxide, a diazonium compound, an iodonium compound, a sulfonium compound, an azinium compound, a benzoin ether-based compound, a ketal derivative compound, an onium salt compound such as a metallocene compound, an organic boron salt compound, and a disulfone compound.

In view of sensitivity, an oxime compound, an acetophenone-based compound, an α-aminoketone compound, a trihalomethyl compound, a hexaarylbiimidazole compound, and a thiol compound are preferred.

Regarding specific examples of the oxime-based initiator, the compounds described in JP2001-233842A, the compounds described in JP2000-80068A, and the compounds described in JP2006-342166A can be used.

Examples of the oxime compound such as an oxime derivative, which may be suitably used as a polymerization initiator, include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-(4-toluenesulfonyloxy)iminobutan-2-one, and 2-ethoxycarbonyloxyimino-1-phenylpropan-1-one.

Examples of an oxime ester compound include the compounds described in J.C.S. Perkin II (1979), pp. 1653-1660, J.C.S. Perkin II (1979), pp. 156-162, Journal of Photopolymer Science and Technology (1995), pp. 202-232, Journal of Applied Polymer Science (2012), pp. 725-731, and JP2000-66385A; and the compounds described in JP2000-80068A, JP2004-534797A, and JP2006-342166A.

Furthermore, as oxime ester compounds other than those described above, the compound described in JP2009-519904A, in which oxime is linked to the N-position of carbazole; the compound described in U.S. Pat. No. 7,626,957B, in which a hetero-substituent has been introduced to a benzophenone site; the compounds described in JP2010-15025A and US2009/292039A, in which a nitro group has been introduced into a dye site; the keto-oxime-based compound described in WO2009/131189A; the compound described in U.S. Pat. No. 7,556,910B, which contains a triazine skeleton and an oxime skeleton in a same molecule; and the compound described in JP2009-221114A, which has satisfactory sensitivity to a g-line light source having an absorption maximum at 405 nm, may also be used.

Furthermore, the cyclic oxime compounds described in JP2007-231000A and JP2007-322744A can also be suitably used. Among cyclic oxime compounds, in particular, the cyclic oxime compounds fused to carbazole dyes, which are described in JP2010-32985A and JP2010-185072A, have high light absorption properties and can be highly sensitized.

Furthermore, the compound described in JP2009-242469A, which has an unsaturated bond at a particular site of an oxime compound, can also be highly sensitized by regenerating an active radical from a polymerized inactive radical.

In addition to those, other examples include an oxime compound having a particular substituent, which is described in JP2007-269779A, and an oxime compound having a thioaryl group, which is described in JP2009-191061A.

Regarding the oxime initiator, reference can be made to the description of a compound represented by Formula (OX-1), (OX-2) or (OX-3) paragraph “0513” of JP2012-208494A (paragraph “0632” of corresponding US2012/235099A) and thereafter, the disclosure of which is incorporated herein.

Regarding commercially available products thereof, IRGACURE-OXE01 and IRGACURE-OXE02 are suitably used, and IRGACURE-OXE01 is particularly preferred.

Furthermore, as the acetophenone-based initiator, commercially available products such as IRGACURE-907, IRGACURE-369, and IRGACURE-379 (trade names; all manufactured by BASF Japan Ltd.) can be used. Furthermore, as the acylphosphine-based initiator, commercially available products such as IRGACURE-819 and DAROCUR-TPO (trade name; all manufactured by BASF Japan Ltd.) can be used.

When a polymerization initiator is included in the composition, the content of the polymerization initiator is preferably in the range of 0.1% by mass to 40% by mass, more preferably in the range of 0.5% by mass to 20% by mass, even more preferably in the range of 1% by mass to 15% by mass, and particularly preferably in the range of 2% by mass to 10% by mass, relative to the total solid content of the composition. When the content is in this range, satisfactory curability is obtained, which is preferable. When the content is in this range, satisfactory curability, satisfactory sensitivity, and pattern formability may be obtained.

The polymerization initiator may be used singly or in combination of two or more kinds thereof.

(Surfactant)

The composition of the invention may include various surfactants from the viewpoint of further enhancing coatability. Regarding the surfactant, various surfactants such as a fluorine-based surfactant, a nonionic surfactant, a cationic surfactant, an anionic surfactant, and a silicone-based surfactant can be used.

Particularly, when the composition of the invention includes a fluorine-based surfactant, the liquid characteristics (particularly, fluidity) exhibited when the composition is prepared into a coating liquid are further enhanced, and therefore, uniformity in the coating thickness and the liquid saving property can be further improved.

That is, in a case in which a coating liquid prepared by applying a composition including a fluorine-based surfactant is used to form a film, when the interfacial tension between the surface to be coated and the coating liquid is decreased, wettability of the surface to be coated is improved, and coatability of the surface to be coated is enhanced. Therefore, even in a case in which a thin film having a thickness of about several micrometers (μm) is formed using a small amount of liquid, it is effective from the viewpoint that formation of a film having a uniform thickness with less thickness unevenness can be more suitably implemented.

The percent content of fluorine in the fluorine-based surfactant is suitably 3% by mass to 40% by mass, more preferably 5% by mass to 30% by mass, and particularly preferably 7% by mass to 25% by mass. A fluorine-based surfactant having the percent content of fluorine in this range is effective from the viewpoints of evenness in the thickness of the coating film or the liquid saving performance, and solubility of the fluorine-based surfactant in the composition becomes satisfactory.

Examples of the fluorine-based surfactant include MEGAFAC F171, MEGAFACE F172, MEGAFACE F173, MEGAFACE F176, MEGAFACE F177, MEGAFACE F141, MEGAFACE F142, MEGAFACE F143, MEGAFACE F144, MEGAFACE R30, MEGAFACE F437, MEGAFACE F475, MEGAFACE F479, MEGAFACE F482, MEGAFACE F554, MEGAFACE F780, MEGAFACE F781 (all manufactured by DIC Corporation); FLUORAD FC430, FLUORAD FC431, FLUORAD FC171 (all manufactured by Sumitomo 3M Limited); SURFLON S-382, SURFLON SC-101, SURFLON SC-103, SURFLON SC-104, SURFLON SC-105, SURFLON SC1068, SURFLON SC-381, SURFLON SC-383, SURFLON S393, SURFLON KH-40 (all manufactured by Asahi Glass Co., Ltd.); and PF636, PF656, PF6320, PF6520, and PF7002 (manufactured by Omnova Solutions, Inc.).

Specific examples of the nonionic surfactant include the nonionic surfactants described in paragraph “0553” of JP2012-208494A (paragraph “0679” of corresponding US2012/0235099A), the disclosure of which is incorporated herein.

Specific examples of the cationic surfactant include the cationic surfactants described in paragraph “0554” of JP2012-208494A (paragraph “0680” of corresponding US2012/0235099A), the disclosure of which is incorporated herein.

Specific examples of the anionic surfactant include W004, W005, and W017 (manufactured by Yusho Co., Ltd.).

Examples of the silicone-based surfactant include “TORAY SILICONE DC3PA”, “TORAY SILICONE SH7PA”, “TORAY SILICONE SF8410”, “TORAY SILICONE DC11PA”, “TORAY SILICONE SH21PA”, “TORAY SILICONE SH28PA”, “TORAY SILICONE SH29PA”, “TORAY SILICONE SH30PA”, and “TORAY SILICONE SH8400” manufactured by Dow Corning Toray Co., Ltd.; “TSF-4440”, “TSF-4300”, “TSF-4445”, “TSF-4460”, and “TSF-4452” manufactured by Momentive Performance Materials, Inc.; “KP341”, “KF6001”, and “KF6002” manufactured by Shin-Etsu Chemical Co., Ltd.; and “BYK307”, “BYK323”, and “BYK330” manufactured by BYK Chemie GmbH.

The surfactants may be used singly or in combination of two or more kinds thereof.

In addition to the compounds described above, SURFYNOL 61 (manufactured by Nissin Chemical Co., Ltd.) can also be used.

When the composition includes a surfactant, the content of the surfactant is preferably 0.001% by mass to 2.0% by mass, and more preferably 0.005% by mass to 1.0% by mass, relative to the total mass of the composition.

The surfactants may be used singly, or in combination of two or more kinds thereof.

(Adhesion Enhancer)

The composition of the invention may also include an adhesion enhancer to the extent that the purpose of the invention is not impaired. When an adhesion enhancer is included, the adhesiveness between the substrate where an infrared-light-blocking layer is disposed, and the infrared-light-blocking layer is further enhanced.

Examples of the adhesion enhancer include 3-glycidyloxypropyltrimethoxysilane, 1-methacryloxypropylmethyldimethoxysilane, 3-aminoglycidyloxypropyltriethoxysilane, 3-glycidyloxypropylmethyldimethoxysilane, 3-aminopropyltrimethoxysilane, N-β-aminoethyl-γ-aminopropyl-methyldimethoxysilane (trade name; KBM-602 manufactured by Shin-Etsu Chemical Co., Ltd.), N-β-aminoethyl-γ-aminopropyl-trimethoxysilane (trade name; KBM-603 manufactured by Shin-Etsu Chemical Co., Ltd.), N-β-aminoethyl-γ-aminopropyl-triethoxysilane (trade name; KBE-602 manufactured by Shin-Etsu Chemical Co., Ltd.), γ-aminopropyl-trimethoxysilane (trade name; KBM-903 manufactured by Shin-Etsu Chemical Co., Ltd.), and γ-aminopropyl-triethoxysilane (trade name; KBE-903 manufactured by Shin-Etsu Chemical Co., Ltd.).

In addition to these, the compounds described in paragraph “0048” of JP2008-243945A are used.

When the composition includes an adhesion enhancer, the content of the adhesion enhancer is preferably 10% by mass or less, and more preferably 0.005% by mass to 5% by mass, relative to the total solid content of the composition.

The adhesion enhancer may be used singly, or two or more kinds thereof may be used in combination.

(Ultraviolet Absorber)

The composition of the invention may include an ultraviolet absorber to the extent that the purpose of the invention is not impaired.

Regarding the ultraviolet absorber, salicylate-based, benzophenone-based, benzotriazole-based, substituted acrylonitrile-based, and triazine-based ultraviolet absorbers can be used.

According to the invention, various ultraviolet absorbers may be used singly, or in combination of two or more kinds thereof.

When the composition includes an ultraviolet absorber, the content of the ultraviolet absorber is preferably 0.001% by mass to 5% by mass, and more preferably 0.01% by mass to 3% by mass, relative to the total solid content of the composition.

The ultraviolet absorber may be used singly, or two or more kinds thereof may be used in combination.

(Solvent)

The composition of the invention may include a solvent. The solvent can be constituted using various organic solvents.

Examples of the organic solvents include acetone, methyl ethyl ketone, cyclohexane, cyclopentanone, ethyl acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetylacetone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 3-methoxypropanol, methoxymethoxyethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethyl sulfoxide, γ-butyrolactone, methyl lactate, and ethyl lactate.

These organic solvents can be used singly or as mixtures.

When the composition includes a solvent, the concentration of the solid content in the composition is preferably 2% by mass to 60% by mass.

The solvent may be used singly, or two or more kinds thereof may be used in combination.

The composition (infrared-light-blocking composition) of the invention can be used as a light-blocking material for an infrared camera. For example, in an infrared camera having a microbolometer as a detection element, infrared light at a wavelength of 5.5 μm to 7.5 μm may become noise for image detection depending on the condition of the atmosphere. In order to suppress such noise, suppression of noise can be promoted by disposing the composition of the invention on the detection side of the microbolometer. Meanwhile, a microbolometer is a kind of bolometer. This utilizes the resistance value of fine vanadium oxide or amorphous silicon, both of which have high temperature coefficients. A silicon having a large surface area has a low heat capacity, and separation of heat is achieved efficiently. Vanadium oxide is irradiated with infrared light emitted from a particular wavelength band, and the electrical resistance of vanadium oxide is altered. The temperature of the bolometer changes as a result of a change in the temperature within a field of view, and the temperature change is converted to an electric signal and is imaged. The composition of the invention can be used in place of vanadium oxide or amorphous silicon.

Meanwhile, regarding the infrared cameras, the disclosures of JP2009-85964A (corresponding WO94/00950) and JP2008-258973A are incorporated herein.

<Infrared-Light-Blocking Layer>

An infrared-light-blocking layer is formed using an infrared-light-blocking composition including the components described above. In other words, an infrared-light-blocking layer corresponds to a cured product of the composition.

The method for forming an infrared-light-blocking layer is not particularly limited; however, a method of applying the above-mentioned composition on a predetermined substrate, and optionally performing a curing treatment, may be used.

The coating method is not particularly limited, and examples thereof include a dip coating method, an air knife coating method, a curtain coating method, a roller coating method, a wire bar coating method, a gravure coating method, and a die coating method.

Additionally, after coating, a heating and drying treatment may be carried out as necessary, in order to remove the solvent. The conditions for the heating and drying treatment are not particularly limited; however, in view of productivity, it is preferable to perform a heating treatment at 50° C. to 200° C. (preferably, 60° C. to 150° C.) for 30 seconds to 15 minutes (preferably, 60 seconds to 5 minutes).

The method for a curing treatment is not particularly limited, and an optimal method is selected according to the components that are included in the composition. For the curing treatment, an exposure treatment or a heating treatment is mainly practiced.

Particularly, in a case in which the composition includes a polymerizable monomer, and an infrared-light-blocking layer is formed in a pattern form, a developing treatment for removing unexposed parts may be carried out after an exposure treatment is performed.

Meanwhile, the method for the developing treatment is not particularly limited, and a method of treating the infrared-light-blocking layer with a developer liquid (solution) which can dissolve the composition of unexposed parts, may be used.

According to a first embodiment of the optical characteristics of the infrared-light-blocking layer, which is a cured product of the composition, the transmittance at a wavelength of 1,000 nm is 60% or less (preferably 50% or less, and more preferably 40% or less; the lower limit is not particularly limited, and is 0%), the transmittance at a wavelength of 1100 nm is 50% or less (preferably 30% or less, and more preferably 20% or less; the lower limit is not particularly limited, and is 0%), and the transmittance at a wavelength of 500 nm is 80% or more (preferably 85% or more, and more preferably 90% or more; the upper limit is not particularly limited, and is 100%).

Regarding the method for measuring the transmittance, an infrared-light-blocking layer is produced on a glass substrate using the composition described above, and the transmittances at an incident angle of 0°, a wavelength of 1,000 nm, a wavelength of 1,100 nm, and a wavelength of 500 nm are measured using a spectroscope UV 4100 manufactured by Hitachi High-Technologies Corporation.

Meanwhile, it is preferable that an infrared-light-blocking layer having a film thickness of 5 μm exhibits the above-mentioned transmittances at the various wavelengths. A film thickness of 5 μM is intended to mean an average film thickness of 5 μm. In regard to the method for measuring the average film thickness, the film thickness of the infrared-light-blocking layer is measured at any ten arbitrary sites, and an arithmetic means of those values is determined. The film thickness of 5 μm for calculating the transmittances is intended to include an error range that is tolerable in the art to which the invention is pertained, and the film thickness may be in the range of 5 μm±0.2 μm or less (4.8 μm to 5.2 μm).

According to a second embodiment of the optical characteristics of the infrared-light-blocking layer, which is a cured product of the composition, the optical density (OD) at a wavelength of 1,000 nm is 0.2 or more (preferably 0.20 or more, more preferably 0.22 or more, even more preferably 0.25 or more, and particularly preferably 0.30 or more; the upper limit is not particularly limited, and is 0.7 or less in many cases), the optical density (OD) at a wavelength of 1,100 nm is 0.3 or more (preferably 0.30 or more, more preferably 0.32 or more, even more preferably 0.35 or more, and particularly preferably 0.40 or more; the upper limit is not particularly limited, and is 0.7 or less in many cases), and the optical density (OD) at a wavelength of 500 nm is 0.1 or less (preferably 0.10 or less, and more preferably 0.08 or less; the lower limit is not particularly limited, and is 0).

In regard to the method for measuring the optical density (OD), a infrared-light-blocking layer is produced on a glass substrate, and the optical densities at an incident angle of 0°, a wavelength of 1,000 nm, a wavelength of 1,100 nm, and a wavelength of 500 nm are measured using a spectroscope UV4100 manufactured by Hitachi High-Technologies Corporation.

Meanwhile, it is preferable that an infrared-light-blocking layer having a film thickness of 5 μm exhibits the above-mentioned optical densities at the various wavelengths. A film thickness of 5 μm is intended to mean an average film thickness of 5 μm. In regard to the method for measuring the average film thickness, the film thickness of the infrared-light-blocking layer is measured at any ten arbitrary sites, and an arithmetic means of those values is determined. The film thickness of 5 μm for calculating the transmittances is intended to include an error range that is tolerable in the art to which the invention is pertained, and the film thickness may be in the range of 5 μm±0.2 μm or less.

Regarding the infrared-light-blocking layer, although the film thickness may be appropriately selected according to the purpose, the film thickness is preferably adjusted to 300 μm or less, more preferably to 200 μm or less, even more preferably to 100 μm or less, particularly preferably to 50 μm or less, more particularly preferably to 10 μm or less, and most preferably to 7 μm or less. The lower limit of the film thickness is, for example, preferably 0.1 μm or more, more preferably 0.5 μm or more, and more preferably 1 μm or more.

The film thickness of the infrared-light-blocking layer is not particularly limited; however, from the viewpoint of application of the infrared-light-blocking layer to an infrared cut-off filter of a solid-state imaging element or the like, the film thickness is preferably 2 μm to 6 μm, and preferably 3 μm to 5 μm.

Meanwhile, the film thickness is intended to mean an average film thickness, and in regard to the method for measuring the average film thickness, the film thickness of the infrared-light-blocking layer is measured at any ten arbitrary sites, and an arithmetic mean of the values is determined.

Meanwhile, when the above-described composition is used, since the concentration of the inorganic microparticles can be increased, thickness reduction of the infrared-light-blocking layer is enabled. Particularly, when a dispersing resin or a polymer compound represented by Formula (1) is used as a dispersing agent, an infrared-light-blocking layer can be easily produced as a thin film.

Furthermore, when the above-described composition is used, an infrared-light-blocking layer in a pattern form can be formed with high precision. That is, the composition has excellent resolution. Particularly, when the resin or the polymer compound represented by Formula (1) described above is used as a dispersing agent, superior effects are obtained.

The transmittance of the infrared-light-blocking layer at a wavelength in the range of 700 nm to 1,100 nm is not particularly limited; however, the transmittance is preferably 20% or less, and more preferably 10% or less. The lower limit is not particularly limited, but may be set to 0%.

The transmittance of the infrared-light-blocking layer at a wavelength in the range of 800 nm to 900 nm is not particularly limited; however, the transmittance is preferably 10% or less, and more preferably 5% or less. The lower limit is not particularly limited, but may be set to 0%.

The infrared-light-blocking layer can be applied as an infrared cut-off filter by disposing the infrared-light-blocking layer on a blue glass substrate. When a blue glass substrate and the infrared-light-blocking layer are combined, superior effects of the invention are obtained.

An example of the blue glass substrate that is used is fluorophosphate glass.

The thickness of the blue glass substrate is not particularly limited, but from the viewpoints of the strength of glass and the absorption in the infrared region, the thickness is preferably 50 μm to 2,000 μm, and more preferably 100 μm to 1,000 μm.

The embodiments of the infrared-light-blocking layer that is disposed on a blue glass substrate are as described above.

Meanwhile, according to a suitable embodiment of the infrared cut-off filter, an infrared cut-off filter including a blue glass substrate; and an infrared-light-blocking layer disposed on the blue glass substrate, the infrared-light-blocking layer containing inorganic microparticles and a dispersing agent and having a transmittance at a wavelength of 1,000 nm of 60% or less, a transmittance at a wavelength of 1,100 nm of 50% or less, and a transmittance at a wavelength of 500 nm of 80% or more, may be used. Suitable ranges for the transmittances at the various wavelengths of the infrared-light-blocking layer are the same as the suitable ranges for the transmittances at the various wavelengths disclosed in the first embodiment of the optical characteristics.

Furthermore, according to another suitable embodiment of the infrared cut-off filter, an infrared cut-off filter including a blue glass substrate; and an infrared-light-blocking layer containing inorganic microparticles and a dispersing agent and having an optical density (OD) at a wavelength of 1,000 nm of 0.2 or more, an optical density (OD) at a wavelength of 1,100 nm of 0.3 or more, and an optical density (OD) at a wavelength of 500 nm of 0.1 or less, may be used. Suitable ranges for the transmittances at the various wavelengths of the infrared-light-blocking layer are the same as the suitable ranges for the transmittances at the various wavelengths disclosed in the second embodiment of the optical characteristics.

Meanwhile, it is preferable that the infrared-light-blocking layer contains indium tin oxide particles or antimony tin oxide particles.

Additionally, the infrared-light-blocking layer may be an infrared-light-blocking layer formed by vapor deposition.

Meanwhile, an infrared cut-off filter having an infrared-light-blocking layer disposed on a blue glass plate has been described in detail in the above; however, the invention is not intended to be limited to this embodiment, and any support other than a blue glass plate (for example, a resin substrate) may also be used.

Furthermore, the infrared cut-off filter may further have a near-infrared reflective film. More specifically, the infrared-light-blocking layer described above may be disposed on a variety of substrates, and for example, a substrate including a glass substrate and a near-infrared reflective film disposed on the glass substrate may also be used. Furthermore, it is also acceptable to install a near-infrared reflective film on the infrared-light-blocking layer.

The kind of the glass substrate is not particularly limited, and any known glass substrate (for example, the blue glass substrate described above) is used.

A near-infrared reflective film is a film having an ability to reflect near-infrared light. For such a near-infrared reflective film, a dielectric multilayer film obtained by alternately laminating an aluminum vapor deposited film, a noble metal thin film, a high-refractive index material layer, and a low-refractive index material layer, or the like can be used. When a near-infrared reflective film is used, a filter which can sufficiently cut off near-infrared light can be obtained.

According to the invention, the near-infrared reflective film may be provided on one surface of a glass substrate, or may be provided on both surfaces of the substrate. In the case of providing the near-infrared reflective film on one surface, it is excellently advantageous in terms of the production cost or the ease of production. In the case of providing the near-infrared reflective film on both surfaces, the substrate has high strength, and warpage does not easily occur.

Among these near-infrared reflective films, a dielectric multilayer film obtained by alternately laminating a high-refractive index material layer and a low-refractive index material layer can be suitably used.

Regarding the material that constitutes the high-refractive index material layer, a material having a refractive index of 1.7 or more can be used, and materials having a refractive index in the range of 1.7 to 2.5 are usually selected. Examples of these materials include materials containing titanium oxide, zirconium oxide, tantalum pentoxide, niobium pentoxide, lanthanum oxide, yttrium oxide, zinc oxide, zinc sulfide, or indium oxide as main components, with small amounts of titanium oxide, tin oxide, cerium oxide and the like being incorporated therein.

Regarding the material that constitutes the low-refractive index material layer, a material having a refractive index of 1.6 or less can be used, and materials having a refractive index in the range of 1.2 to 1.6 are usually selected. Examples of these materials include silica, alumina, lanthanum fluoride, magnesium fluoride, and aluminum sodium hexafluoride.

The method for laminating a high-refractive index material layer and a low-refractive index material layer is not particularly limited as long as a dielectric multilayer film in which these material layers are laminated is formed. However, a dielectric multilayer film in which a high-refractive index material layer and a low-refractive index material layer are alternately laminated by, for example, a CVD method, a sputtering method, a vacuum vapor deposition method or the like, is formed, and this may be adhered to a glass substrate with an adhesive. Alternatively, a dielectric multilayer film in which a high-refractive index material layer and a low-refractive index material layer are alternately laminated can be formed directly on a glass substrate by a CVD method, a sputtering method, a vacuum vapor deposition method or the like.

Regarding the thicknesses of the respective layers of the high-refractive index material layer and the low-refractive index material layer, conventionally, when the wavelength of infrared light to be blocked is designated as λ (nm), a thickness of 0.1λ to 0.5λ is preferred. When the thickness does not fall in the range mentioned above, the product of the refractive index (n) and the film thickness (d) (n×d) is largely different from the optical film thickness calculated by λ/4, and the relationship of the optical characteristics in reflection and refraction is impaired. Thus, there is a tendency that blocking and transmission of particular wavelengths cannot be controlled.

Furthermore, the number of laminations in the dielectric multilayer film is preferably 5 layers to 50 layers, and more preferably 10 layers to 40 layers.

As discussed above, it is also acceptable to use an infrared-light-blocking layer and a layer containing the copper compound described above (hereinafter, also simply referred to as “copper-containing layer”) in combination. That is, a multilayer infrared-light-blocking layer including an infrared-light-blocking layer and a layer containing a copper compound may be mentioned as one of the embodiments of the invention.

Furthermore, the layer containing a copper compound may be included in the infrared cut-off filter. More specifically, an infrared cut-off filter having the blue glass plate (or a support), the infrared-light-blocking layer, and the copper-containing layer may be used. The definition of the copper compound is as described above.

It is preferable that the infrared-light-blocking layer and the copper-containing layer are disposed adjacently.

The content of the copper compound in the copper-containing layer is not particularly limited; however, the content is preferably 10% by mass or more, more preferably 20% by mass or more, even more preferably 25% by mass or more, and particularly preferably 30% by mass or more, relative to the total mass of the copper-containing layer. Furthermore, the content is preferably 85% by mass or less, more preferably 80% by mass or less, and even more preferably 70% by mass or less.

The copper-containing layer may also contain components other than the copper compound (for example, the binder polymer explained in connection with the infrared-light-blocking layer).

In regard to the multilayer infrared-light-blocking layer, the thickness of the infrared-light-blocking layer containing inorganic microparticles is preferably 10 μm or less, and more preferably 7 μm or less. The lower limit is not particularly limited; however, the lower limit is usually 0.1 μm or more in many cases, and is preferably 1 μm or more. Furthermore, in regard to the multilayer infrared-light-blocking layer, the thickness of the copper-containing layer is preferably 250 μm or less, and more preferably 200 μm or less. The lower limit is not particularly limited; however, the lower limit is usually 1 μm or more in many cases, and preferably 10 μm or more.

The thicknesses of the infrared-light-blocking layer and the copper-containing layer are average thicknesses, and regarding the method for measuring the average film thickness, the film thickness of the infrared-light-blocking layer or the copper-containing layer at any ten arbitrary sites, and an arithmetic mean of those values is determined.

The infrared-light-blocking layer formed from the composition of the invention can be applied to a variety of applications. For example, the infrared-light-blocking layer is used as an optical filter for lenses having a function of absorbing or blocking infrared light (optical lenses such as camera lenses for digital cameras, mobile telephones, and vehicle-mounted cameras, f-O lenses, and pick-up lenses) and for semiconductor light-receiving elements; an infrared-light-absorbing film or an infrared-light-absorbing sheet, which blocks heat rays for energy saving purposes; agricultural coating agents intended for selective utilization of sunlight; a recording medium which utilizes the heat of absorption of infrared light; an infrared filter for electronic equipment and photography; protective glasses; sunglasses; a heat ray-blocking film; optical character-reading and recording, prevention of duplication of classified documents, an electrophotographic photoreceptor; and laser welding. Furthermore, the infrared light-blocking layer is also useful as a noise cut-off filter for CCD cameras, and a filter for CMOS image sensors.

Furthermore, the present invention also relates to a method for producing an infrared cut-off filter, the method including a step of applying the composition of the invention on a substrate in a layered form on the light-receiving side of a solid-state imaging element, and a step of drying the composition. The film thickness, the laminate structure and the like can be appropriately selected according to the purpose.

The substrate may be any of a transparent substrate formed of glass or the like, a solid-state imaging element substrate, an additional substrate (for example, a glass substrate 30 which will be described later) provided on the light-receiving side of a solid-state imaging element substrate, and a layer such as a flattening layer provided on the light-receiving side of a solid-state imaging element substrate.

The drying conditions may vary depending on the kinds of the various components and solvents, the use proportions thereof, and the like; however, the drying time is usually about 30 seconds to 15 minutes at a temperature of 60° C. to 200° C.

The method for forming an infrared cut-off filter using the composition of the invention may further include other steps. There are no particular limitations on the other steps, and the steps can be appropriately selected according to the purpose. Examples include a substrate surface treatment step, a pre-heating step (prebake step), a curing treatment step, and a post-heating step (post-bake step).

Furthermore, the present invention also relates to a camera module having a solid-state imaging element and an infrared cut-off filter. In this camera module, the infrared cut-off filter is the infrared cut-off filter of the invention described above.

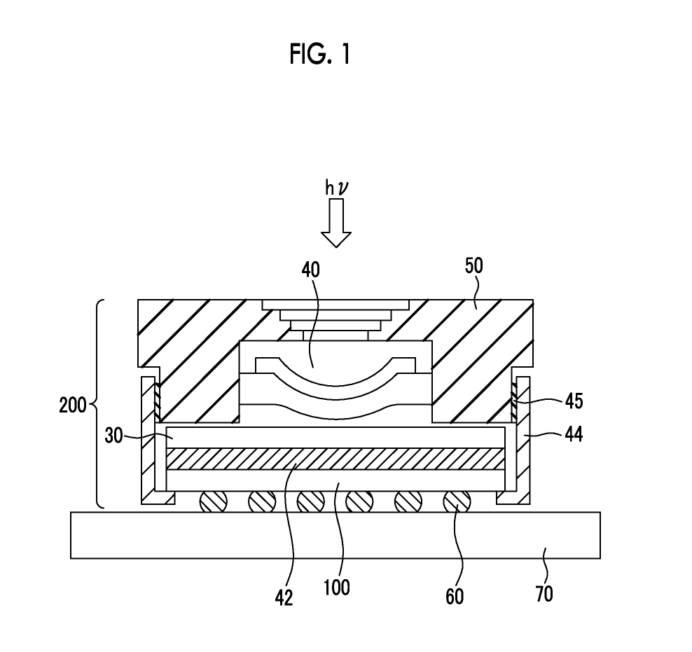

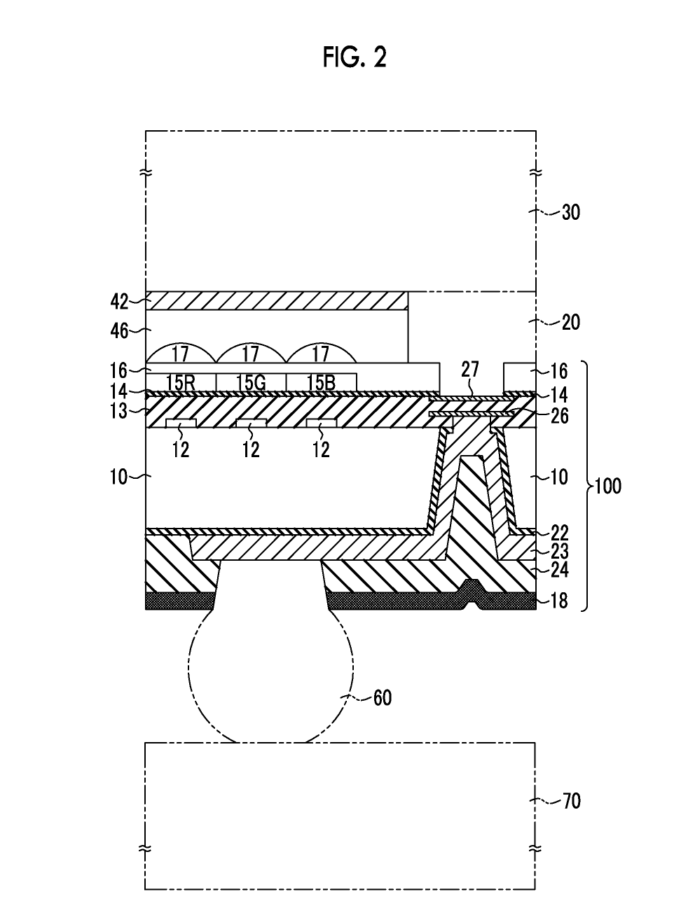

The camera module related to an exemplary embodiment of the invention will be described below with reference to FIG. 1 and FIG. 2; however, the present invention is not intended to be limited to the following specific example.

Meanwhile, in FIG. 1 and FIG. 2, a common symbol will be assigned to common parts.

FIG. 1 is a schematic cross-sectional diagram illustrating the configuration of a camera module including a solid-state imaging element.

The camera module 200 illustrated in FIG. 1 is connected to a circuit substrate 70, which is a mounting substrate, via solder balls 60 as connection members.

Specifically, the camera module 200 is configured to include a solid-state imaging element 100 having an imaging element unit on a first main surface of a silicon substrate; a flattening layer (not shown in FIG. 1) provided on the first main surface side (light-receiving side) of the solid-state imaging element 100; an infrared cut-off filter 42 provided on the flattening layer; a lens holder 50 disposed above the infrared cut-off filter 42 and holding an imaging lens 40 in the internal space; and a light-blocking/electromagnetic shield 44 disposed so as to surround the periphery of the solid-state imaging element 100 and the glass substrate 30. Meanwhile, a glass substrate 30 (light-transmitting substrate) may be provided on the flattening layer. The various members are adhered by means of an adhesive 45.

The present invention also relates to a method for producing a camera module having a solid-state imaging element 100, and an infrared cut-off filter 42 disposed on the light-receiving side of the solid-state imaging element, the method including a step of forming an infrared-light-blocking layer by applying the composition of the invention on the light-receiving side of the solid-state imaging element. In regard to the camera module related to the present embodiment, for example, an infrared cut-off filter 42 can be formed by applying the curable composition of the invention on a flattening layer and thereby forming a film. The method for applying the infrared cut-off filter is as described above.

The camera module 200 is configured such that incident light hv from an external source penetrates through the imaging lens 40, the infrared cut-off filter 42, the glass substrate 30, and the flattening layer, and then reaches the imaging element unit of the solid-state imaging element 100.

The camera module 200 has the infrared cut-off filter provided directly on the flattening layer; however, it is acceptable to provide the infrared cut-off filter directly on a microlens while the flattening layer is omitted, or it is also acceptable to provide the infrared cut-off filter on the glass substrate 30, or to bond a glass substrate 30 provided with an infrared cut-off filter onto the camera module.

FIG. 2 is a cross-sectional diagram showing a magnified view of the solid-state imaging element 100 of FIG. 1.

The solid-state imaging element 100 includes, on a first main surface of a silicon substrate 10 as a base, photodiodes (PD) 12, an interlayer insulating film 13, a base layer 14, color filters 15, an overcoat 16, and microlenses 17 in this order. Red color filters 15R, green color filters 15G and blue color filters 15B (hereinafter, these may be collectively referred to as “color filters 15”) and the microlenses 17 are respectively disposed so as to be corresponding to the photodiodes (PD) 12. On a second main surface on the side opposite to the first main surface of the silicon substrate 10, provided are a light-blocking film 18, an insulating film 22, a metal electrode 23, a solder resist layer 24, an internal electrode 26, and an element surface electrode 27. The various members are adhered by means of an adhesive 20.

A flattening layer 46 and the infrared cut-off filter 42 are provided above the microlenses 17. Instead of having the infrared cut-off filter 42 provided above the flattening layer 46, a form in which the infrared cut-off filter is provided above the microlenses 17, between the base layer 14 and the color filters 15, or between the color filters 15 and the overcoat 16, may also be adopted. Particularly, it is preferable that the infrared cut-off filter is provided at a position 2 mm or less (more preferably, 1 mm or less) away from the surface of the microlenses 17. When the infrared cut-off filter is provided at this position, the step of forming an infrared cut-off filter can be simplified, and infrared light that is unnecessary for the microlenses can be sufficiently blocked. Therefore, the infrared-light-blocking properties can be further enhanced.

In regard to the solid-state imaging element 100, reference can be made to the explanation on the solid-state imaging element 100 in paragraph “0245” of JP2012-068418A (paragraph “0407” of corresponding US2012/068292A) and thereafter, the disclosure of which is incorporated herein.

Thus, an exemplary embodiment of the camera module has been explained with reference to FIG. 1 and FIG. 2, but the exemplary embodiment is not intended to be limited to the form shown in FIG. 1 and FIG. 2.

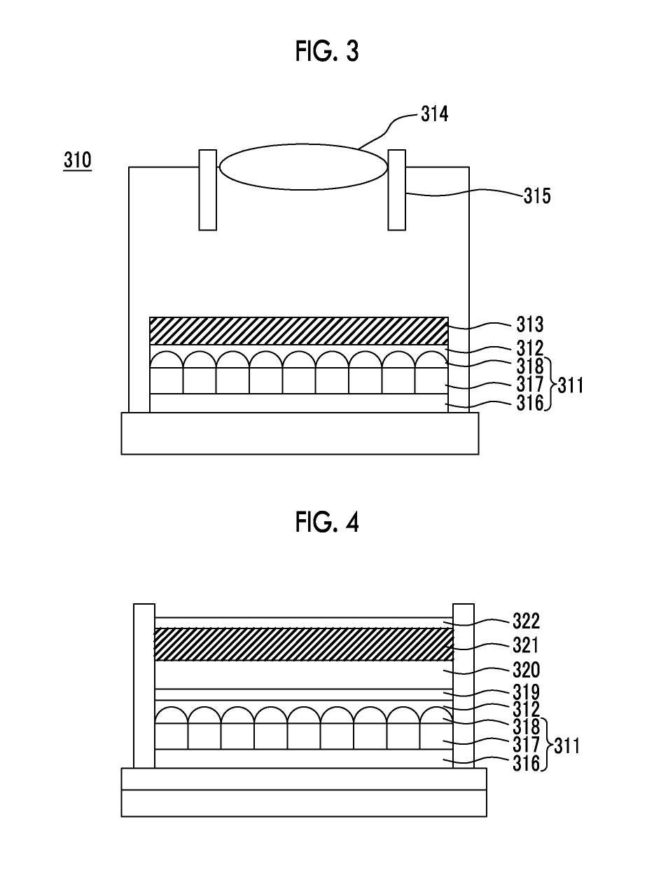

FIG. 3 is a schematic cross-sectional diagram illustrating the configuration of a camera module having an infrared cut-off filter according to another exemplary embodiment of the invention.

The camera module 310 includes, for example, a solid-state imaging element substrate 311; a flattening layer 312 provided on a main surface side (light-receiving side) of the solid-state imaging element substrate 311; an infrared cut-off filter 313; and a lens holder 315 disposed above the infrared cut-off filter 313 and holding an imaging lens 314 in the internal space.

In regard to the camera module 310, incident light hv from an external source penetrates through the imaging lens 314, the infrared cut-off filter 313, and the flattening layer 312 in sequence, and subsequently reaches the imaging element unit of the solid-state imaging element substrate 311.

The solid-state imaging element substrate 311 includes, for example, on a main surface of a silicon substrate as a base, an imaging element 316, an interlayer insulating film (not shown in the diagram), a base layer (not shown in the diagram), color filters 317, an overcoat (not shown in the diagram), and microlenses 318 in this order. The color filters 317 (red color filters, green color filters, and blue color filters) and the microlenses 318 are respectively disposed so as to be corresponding to the imaging elements 316.

Furthermore, instead of having the infrared cut-off filter 313 provided on the surface of the flattening layer 312, a form in which the infrared cut-off filter 313 is provided on the surface of the microlenses 318, between the base layer and the color filters 317, or between the color filters 317 and the overcoat, may also be adopted. For example, the infrared cut-off filter 313 may be provided at a position 2 mm or less (more preferably, 1 mm or less) away from the surface of the microlenses. When the infrared cut-off filter is provided at this position, the step of forming an infrared cut-off filter can be simplified, and infrared light that is unnecessary for the microlenses can be sufficiently blocked. Therefore, the infrared-light-blocking properties can be further enhanced.

The infrared cut-off filter of the invention can be supplied to a solder reflow process. When a camera module is produced by a solder reflow process, automatic packaging of an electronic component mounting board or the like that requires soldering is enabled, and productivity can be markedly enhanced as compared to the case in which a solder reflow process is not used. Furthermore, since the process can be carried out automatically, cost reduction can be promoted. In a case in which the infrared cut-off filter is supplied to a solder reflow process, since the filter should be exposed to a temperature of about 250° C. to 270° C., it is preferable that the infrared cut-off filter has heat resistance that can endure the solder reflow process (hereinafter, also referred to as “solder reflow resistance”).

In the present specification, “having solder reflow resistance” implies that the characteristics required for an infrared cut-off filter are maintained before and after a process of performing heating for 10 minutes at 200° C. More preferably, it implies that the characteristics are maintained before and after a process of performing heating for 10 minutes at 230° C. Even more preferably, it implies that the characteristics are maintained before and after a process of performing heating for 3 minutes at 250° C. If the infrared cut-off filter does not have solder reflow resistance, when the infrared cut-off filter is maintained under the conditions described above, the infrared absorption capacity of the infrared cut-off filter may deteriorate, or the infrared cut-off film may function unsatisfactorily as a film.

Furthermore, the present invention also relates to a method for producing a camera module, the method including a step of performing a reflow treatment. The near-infrared cut-off filter of the invention maintains the near-infrared absorption capacity even if a reflow process is carried out, and therefore, the characteristics of a miniaturized, weight-reduced camera module with improved performance will not be impaired.

FIGS. 4 to 6 are schematic cross-sectional diagrams illustrating examples of the peripheral parts of an infrared cut-off filter in a camera module.

As illustrated in FIG. 4, a camera module may include a solid-state imaging element substrate 311, a flattening layer 312, an ultraviolet/infrared reflective film 319, a transparent substrate 320, a near-infrared-light-absorbing layer 321, and an antireflective layer 322 in this order.

The ultraviolet/infrared reflective film 319 has an effect of imparting or enhancing the function as an infrared cut-off filter, and for example, reference can be made to paragraphs “0033” to “0039” of JP2013-68688 A, the disclosure of which is incorporated herein.

The transparent substrate 320 is to transmit light having a wavelength in the visible region, and for example, reference can be made to paragraphs “0026” to “0032” of JP2013-68688A, the disclosure of which is incorporated herein.

The infrared-light-absorbing layer 321 can be formed by applying the infrared-light-absorbing composition of the invention described above.

The antireflective layer 322 has a function of increasing the transmittance by preventing the reflection of light incident to the infrared cut-off filter, and efficiently utilizing the incident light, and for example, reference can be made to paragraph “0040” of JP2013-68688A, the disclosure of which is incorporated herein.

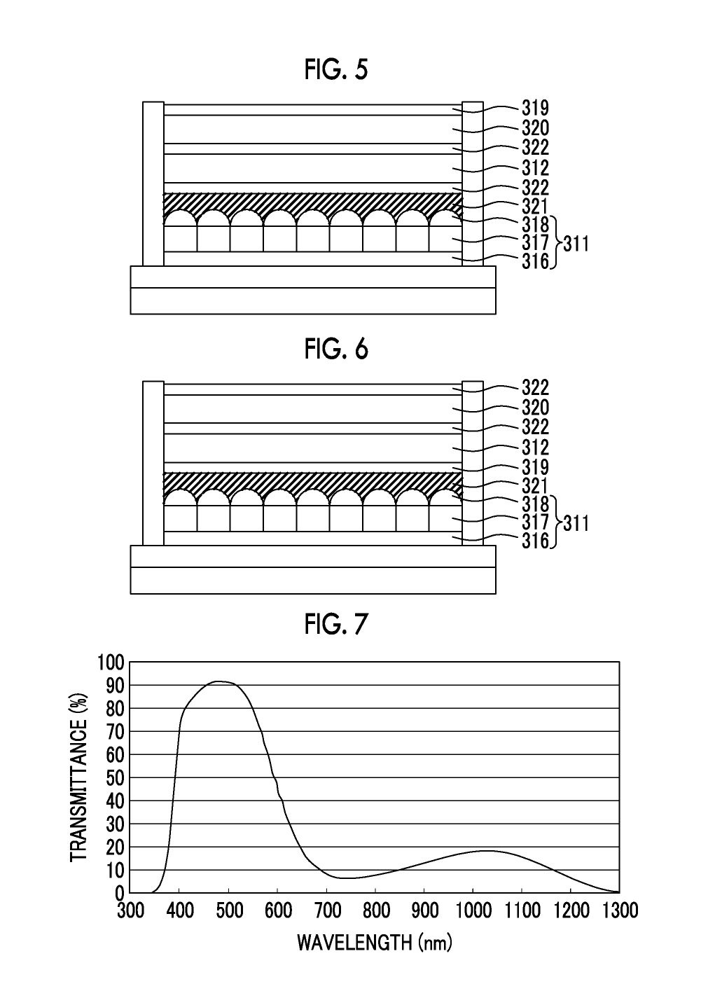

As illustrated in FIG. 5, the camera module may include a solid-state imaging element substrate 311, an infrared-light-absorbing layer 321, an antireflective layer 322, a flattening layer 312, an antireflective layer 322, a transparent substrate 320, and an ultraviolet/infrared reflective film 319 in this order.

As illustrated in FIG. 6, the camera module may include a solid-state imaging element substrate 311, a near-infrared-light-absorbing layer 321, an ultraviolet/infrared reflective film 319, a flattening layer 312, an antireflective layer 322, a transparent substrate 320, and an antireflective layer 322 in this order.

### EXAMPLES

Hereinafter, the invention will be described more specifically by way of Examples of the invention. The materials, use amounts, proportions, treatments, treatment procedure, and the like disclosed in the following Examples can be appropriately modified as long as the purport of the invention is maintained. Therefore, the scope of the invention should not be construed to be limited to the specific examples described below.

### Example 1

### Preparation of ITO Dispersion Liquid

28.1 parts by mass of a tin-doped indium oxide powder (indium tin oxide particles) (manufactured by Mitsubishi Materials Corporation, P4-ITO), 18.8 parts by mass of a dispersing agent a described below (solid content 30%, solvent: propylene glycol monomethyl ether), and 28.1 parts by mass of a solvent (cyclohexanone) were mixed in advance, and then the mixture was subjected to a dispersion treatment as follows using ULTRA APEX MILL manufactured by Kotobuki Industries Co., Ltd. as a circulation type dispersing apparatus (bead mill). Thus, an ITO dispersion liquid was obtained. The dispersing apparatus was operated under the following conditions.
Bead diameter: φ0.05 mm
Bead filling ratio: 75% by volume
Circumferential velocity: 10 m/sec
Pump supply amount: 10 kg/hour
Cooling water: tap water
Internal volume of the bead mill annular space: 0.15 L
Amount of mixed liquid to be dispersion treated: 0.7 kg

The 90% particle diameter (D90) and the 50% particle diameter (D50) of the ITO particles obtained by performing a dispersion treatment for 15 minutes were measured, and the particle diameters were 0.10 μm and 0.08 μm, respectively. Meanwhile, the 90% particle diameter (D90) and the 50% particle diameter (D50) were measured using a laser diffraction scattering particle size distribution analyzer (MICROTRAC UPA-EX150 manufactured by Nikkiso Co., Ltd.).

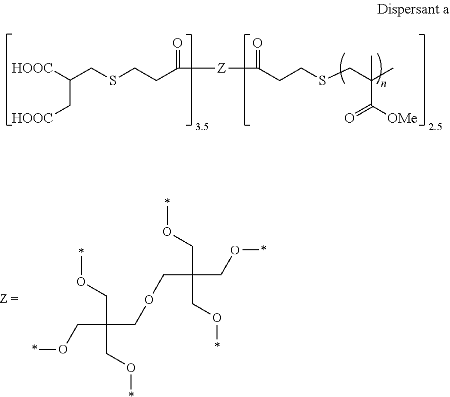

In the above formula, n was 14, the weight average molecular weight of the dispersing agent a calculated relative to polystyrene standards was 6,400, and the acid value was 80 mg KOH/g. The dispersing agent a was synthesized according to the synthesis method described in paragraphs “0114” to “0140” and paragraphs “0266” to “0348” of JP2007-277514A.

The following composition was mixed using the ITO dispersion liquid thus obtained, and an infrared-light-blocking composition was prepared.

| | |
|---|---|
| ITO dispersion liquid | 71.0 parts by mass |
| Binder polymer (ACA230AA, Daicel Cytec Co., | 16.8 parts by mass |
| Ltd., solid content 55%, solvent: propylene | |
| glycol monomethyl ether) | |
| Photopolymerization initiator: IRGACURE 907 | 2.8 parts by mass |
| (manufactured by BASF Japan Ltd.) | |
| Polymerizable compound: ARONIX M-510 | 9.4 parts by mass |
| (TO-756) (trade name; manufactured by | |
| Toagosei Co., Ltd.; tetrafunctional | |
| polymerizable compound) | |
| Silane coupling agent KBM-602 (manufactured | 0.11 parts by mass |
| by Shin-Etsu Silicone Co., Ltd.) | |
| Surfactant: MEGAFACE F-780 (manufactured by | 0.11 parts by mass |
| DIC Corporation) | |

<Production of Coating Film>

The infrared-light-blocking composition produced in Example 1 was applied on a blue glass substrate by a spin coating method, and subsequently the composition was heated for 2 minutes at 100° C. on a hot plate. Thus, a coating layer was obtained.

The coating layer thus obtained was exposed at an amount of exposure of 1000 mJ/cm² using an i-line stepper or an aligner, and the exposed coating layer was further subjected to a curing treatment for 10 minutes at 200° C. on a hot plate. Thus, an infrared-light-blocking layer having a film thickness of 5.0 μm was obtained.

### Example 2

An infrared-light-blocking layer having a film thickness of 5.0 μm was obtained according to the same procedure as that of Example 1, except that the time taken by the dispersion treatment in the (Preparation of ITO dispersion liquid) was changed from 15 minutes to 30 minutes.

Meanwhile, the 90% particle diameter (D90) and the 50% particle diameter (D50) of the ITO particles in the ITO dispersion liquid were 0.08 μm and 0.06 μm, respectively.

### Example 3

An infrared-light-blocking layer having a film thickness of 5.0 μm was obtained according to the same procedure as that of Example 1, except that the time taken by the dispersion treatment in the (Preparation of ITO dispersion liquid) was changed from 15 minutes to 60 minutes.

Meanwhile, the 90% particle diameter (D90) and the 50% particle diameter (D50) of the ITO particles in the ITO dispersion liquid were 0.08 μm and 0.05 μm, respectively.

### Example 4

An infrared-light-blocking layer having a film thickness of 5.0 μm was obtained according to the same procedure as that of Example 1, except that the time taken by the dispersion treatment in the (Preparation of ITO dispersion liquid) was changed from 15 minutes to 180 minutes.

Meanwhile, the 90% particle diameter (D90) and the 50% particle diameter (D50) of the ITO particles in the ITO dispersion liquid were 0.05 μm and 0.03 μm, respectively.

### Comparative Example 1

An infrared-light-blocking layer having a film thickness of 5.0 μm was obtained according to the same procedure as that of Example 1, except that the time taken by the dispersion treatment in the (Preparation of ITO dispersion liquid) was changed from 60 minutes to 300 minutes.

Meanwhile, the 90% particle diameter (D90) and the 50% particle diameter (D50) of the ITO particles in the ITO dispersion liquid were 0.04 μm and 0.02 μm, respectively.

### Comparative Example 2

An infrared-light-blocking layer having a film thickness of 5.0 μm was obtained according to the same procedure as that of Example 1, except that the dispersion treatment using a circulation type dispersing apparatus (bead mill) was not carried out.

Meanwhile, the 90% particle diameter (D90) and the 50% particle diameter (D50) of the ITO particles in the ITO dispersion liquid were 0.20 μm and 0.18 μm, respectively.

<Spectroscopic Evaluation>

The infrared-light-blocking layers produced as described above were evaluated according to the following criteria by evaluating the transmittance at an incident angle of 0° for the wavelength of 400 nm to 1200 nm using a spectroscope UV4100 manufactured by Hitachi High-Technologies Corporation. Meanwhile, the following visible range is intended to mean a wavelength range of 500 nm to 700 nm.

“A”: Transparency for the visible range is high (OD for the visible range is 0.1 or less), flare or the like does not occur, and the image quality is not deteriorated.

“B”: Transparency for the visible range is high (OD for the visible range is 0.1 or less), but flare or the like occurs, and the image quality is deteriorated.

“C”: Transparency for the visible range is low (OD for the visible range is more than 0.1), flare or the like occurs, and the image quality is deteriorated.

TABLE 1

| | Dispers- | | | Transmittance (%) | | | OD | | | |
|---|---|---|---|---|---|---|---|---|---|---|
| | ing | 90% particle | 50% particle | (film thickness 5 μm) | | | (film thickness 5 μm) | | | |
| | time | diameter | diameter | Wavelength | Wavelength | Wavelength | Wavelength | Wavelength | Wavelength | Determi- |
| | (min) | (μm) | (μm) | 500 nm | 1,000 nm | 1,100 nm | 500 nm | 1,000 nm | 1,100 nm | nation |
| Example 1 | 15 | 0.1 | 0.08 | 88 | 27 | 12 | 0.06 | 0.57 | 0.92 | A |
| Example 2 | 30 | 0.08 | 0.06 | 90 | 26 | 11 | 0.05 | 0.59 | 0.96 | A |
| Example 3 | 60 | 0.08 | 0.05 | 90 | 25 | 10 | 0.05 | 0.60 | 1.00 | A |
| Example 4 | 180 | 0.05 | 0.03 | 92 | 30 | 15 | 0.04 | 0.52 | 0.82 | A |
| Comparative | 300 | 0.04 | 0.02 | 91 | 70 | 60 | 0.04 | 0.15 | 0.22 | B |
| Example 1 | | | | | | | | | | |
| Comparative | 0 | 0.2 | 0.18 | 70 | 20 | 5 | 0.15 | 0.70 | 1.30 | C |
| Example 2 | | | | | | | | | | |

In the above Table 1, transmittance (%) and the optical density (OD) (film thickness 5 μm) represent the transmittance (%) at various wavelengths when the film thickness (average film thickness) of an infrared-light-blocking layer was 5 μm.

As shown in Table 1, it was confirmed that the infrared-light-blocking layers of Examples 1 to 4 that satisfied the predetermined requirements gave desired effects.

Furthermore, on the infrared-light-blocking layer of Example 1, a layer in which silica (SiO₂: film thickness 20 nm to 250 nm) layers and titania (TiO₂: film thickness 70 nm to 130 nm) layers were alternately laminated (number of laminations: 44) was formed as a dielectric multilayer that reflects near-infrared light, at a vapor deposition temperature of 200° C.

### Example 5

### Synthesis Example for Copper Compound 1

A 53.1% aqueous solution of sulfophthalic acid described below (13.49 g, 29.1 mmol) was dissolved in 50 mL of methanol, and the temperature of this solution was increased to 50° C. Subsequently, copper hydroxide (2.84 g, 29.1 mmol) was added thereto, and the mixture was reacted for 2 hours at 50° C. After completion of the reaction, the solvent and the water generated therefrom were distilled off in an evaporator, and thereby copper compound 1 (8.57 g) was obtained.

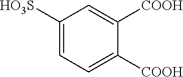 [SMILES: O=C(O)c1ccc(S(=O)(=O)O)cc1C(=O)O]

### Synthesis Example for Sulfonic Acid Polymer-Copper Compound 1

5.0 g of polyether sulfone (manufactured by BASF SE, ULTRASON E6020P) was dissolved in 46 g of sulfuric acid, and 16.83 g of chlorosulfonic acid was added dropwise thereto at room temperature under a nitrogen gas stream. After the mixture was allowed to react for 48 hours at room temperature, the reaction liquid was added dropwise to 1 L of a hexane/ethyl acetate (1/1) mixed liquid that had been cooled with ice water. A supernatant was removed, and the precipitate thus obtained was dissolved in methanol. The solution thus obtained was added dropwise to 0.5 L of ethyl acetate, and the precipitate thus obtained was collected by filtration. The solid thus obtained was dried under reduced pressure, and thereby 4.9 g of the following polymer A-1 was obtained. The sulfonic acid group content in the polymer calculated by neutralization and titration was 3.0 (meq/g), and the weight average molecular weight (Mw) was 53,000.

556 mg of copper hydroxide was added to 20 g of a 20% aqueous solution of the polymer A-1, and the mixture was stirred for 3 hours at room temperature to dissolve copper hydroxide. Thus, an aqueous solution of sulfonic acid polymer-copper compound 1 was obtained.

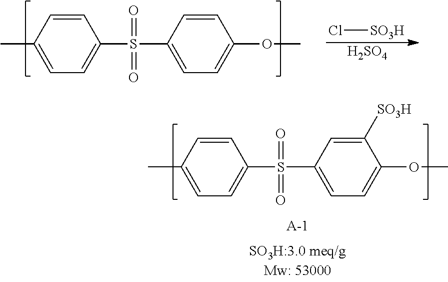

The copper compound 1 (72.6 parts by mass) and the aqueous solution of sulfonic acid polymer-copper compound 1 (24.2 parts by mass) were added to the infrared-light-blocking composition (3.2 parts by mass) obtained in Example 1. The infrared-light-blocking composition thus obtained was applied on a glass substrate by drop casting (dropping method), and the composition was heated stepwise on a hot plate for 10 minutes at 60° C., for 10 minutes at 80° C., for 10 minutes at 100° C., for 10 minutes at 120° C., and for 10 minutes at 140° C. Thus, an infrared-light-blocking layer having a film thickness of 155 μm was obtained, and the <spectroscopic evaluation> was carried out as described above. The results are shown in the following Table 2.

TABLE 2

| | Transmittance (%) | | | OD | | | |
|---|---|---|---|---|---|---|---|
| | (film thickness 155 μm) | | | (film thickness 155 μm) | | | |
| | Wavelength | Wavelength | Wavelength | Wavelength | Wavelength | Wavelength | Determi- |
| | 500 nm | 1,000 nm | 1,100 nm | 500 nm | 1,000 nm | 1,100 nm | nation |
| Example 5 | 87 | 18 | 15 | 0.06 | 0.75 | 0.82 | A |

The infrared-light-blocking layer obtained as described above had a transmittance at a wavelength in the range of 500 nm to 600 nm of 85% or more, a transmittance at a wavelength in the range of 700 nm to 1,100 nm of 20% or less, and a transmittance at a wavelength in the range of 800 nm to 900 nm of 10% or less.

Meanwhile, even in a case in which the copper compound 1 was changed to copper complexes (17 kinds) having the following sulfonic acid compounds as ligands, excellent effects were obtained similarly to Example 5.

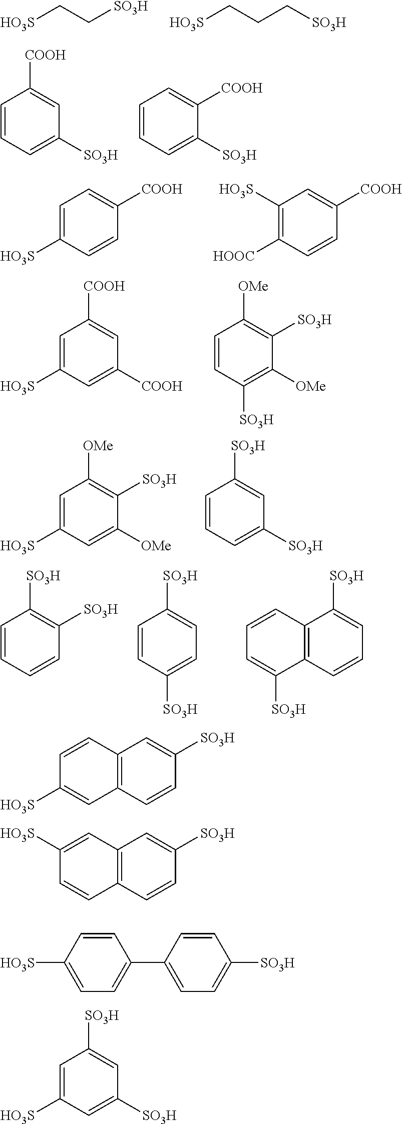

To the infrared-light-blocking composition prepared in Example 5, 5 parts by mass of a polymerizable compound was further added. As the polymerizable compound, the following compounds were used: KAYARAD D-330, D-320, D-310, DPHA, DPCA-20, DPCA-30, DPCA-60, DPCA=120 (all manufactured by Nippon Kayaku Co., Ltd.), M-305, M-510, M-520, M-460 (manufactured by Toagosei Co., Ltd.), A-TMMT (manufactured by Shin-Nakamura Chemical Co., Ltd.), SR-494 (manufactured by Arkema Inc.), DENACOL EX-212L (manufactured by Nagase ChemteX Corporation.), or JER-157S65 (manufactured by Mitsubishi Chemical Corporation). In these cases, excellent effects were also obtained similarly to the infrared-light-blocking layer of Example 5.

Excellent effects were obtained similarly to the infrared-light-blocking layer of Example 5, even in a case in which MEGAFACE F780 used in the infrared-light-blocking composition prepared in Example 5 was changed to MEGAFACE F171 (manufactured by DIC Corporation), SURFINOL 61 (manufactured by Nissin Chemical Industry Co., Ltd.,) or TORAY SILICONE SF8410 (manufactured by Dow Corning Toray Co., Ltd.).

### Example 6

The following compounds were mixed, and thereby a composition for forming a copper-containing layer was prepared.

| | |
|---|---|
| Copper compound 1 mentioned above | 25.2 parts by mass |
| Sulfonic acid polymer-copper | 6.8 parts by mass |
| compound 1 mentioned above | |
| Binder-A shown below | 62.4 parts by mass |
| Solvent (water) | in an amount that makes the total |
| | solid content concentration in |
| | the composition to 20% by mass |

Binder-A: following compound (Mw: 24,000)

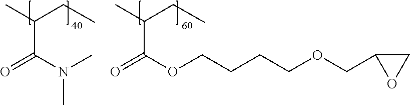

A coating layer was obtained by applying the infrared-light-blocking composition prepared in Example 1 on a blue glass substrate by a spin coating method, and then the composition was heated for 2 minutes at 100° C. on a hot plate.

The coating layer thus obtained was exposed in an amount of exposure of 1,000 mJ/cm² using an i-line stepper or an aligner, and the exposed coating layer was further subjected to a curing treatment for 10 minutes at 200° C. on a hot plate. Thus, an infrared-light-blocking layer having a film thickness of 5.0 μm was obtained.

Next, the composition for forming a copper-containing layer was applied on the infrared-light-blocking layer by drop casting (dropping method), and the composition was heated stepwise on a hot plate for 10 minutes at 60° C., for 10 minutes at 80° C., for 10 minutes at 100° C., for 10 minutes at 120° C., and for 10 minutes at 140° C. Thus, a copper-containing layer having a film thickness of 150 μm was obtained. The infrared cut-off filter thus obtained includes a multilayer infrared-light-blocking layer in which an infrared-light-blocking layer and a copper-containing layer are laminated. Meanwhile, the transmission spectrum diagram of the multilayer infrared-light-blocking layer thus obtained is shown in FIG. 7.

For the infrared cut-off filter thus obtained, the light-blocking performance for the range of 700 nm to 1,100 nm could be further enhanced.

When the thickness of the copper-containing layer was changed to 100 μm or 200 μm, the same effects as those of Example 6 were obtained.

Furthermore, when the thickness of the infrared-light-blocking layer was changed to 3 μm, 4 μm, 7 μm or 8 μm, the same effects as those of Example 6 were obtained.

### EXPLANATION OF REFERENCES

10: silicon substrate
12: photodiode (PD)
13: interlayer insulating film
14: base layer
15: filter layer
15R: red color filter
15G: green color filter
15B: blue color filter
16: overcoat
17: microlens
18: light-blocking film
20: adhesive
22: insulating film
23: metal electrode
24: solder resist layer
26: internal electrode
27: element surface electrode
30: glass substrate
40: imaging lens
41: adhesive
42: infrared cut-off filter
43: adhesive
44: light-blocking/electronic shield
45: adhesive
50: lens holder
60: solder ball
70: circuit substrate
100: solid-state imaging element
200: camera module
310: camera module
311: solid-state imaging element substrate
312: flattening layer
313: infrared cut-off filter
314: imaging lens
315: lens holder
316: imaging element
317: color filter
318: microlens
319: ultraviolet/infrared reflective film
320: transparent substrate
321: near-infrared-light-absorbing layer
322: antireflective layer

What is claimed is:

1. An infrared-light-blocking composition comprising:
inorganic microparticles; and
a dispersing agent,
wherein an infrared-light-blocking layer formed from the infrared-light-blocking composition has a transmittance at a wavelength of 1,000 nm of 60% or less, a transmittance at a wavelength of 1,100 nm of 50% or less, and a transmittance at a wavelength of 500 nm of 80% or more.

2. An absorption type infrared-light-blocking composition comprising:
inorganic microparticles; and
a dispersing agent,
wherein an infrared-light-blocking layer formed from the infrared-light-blocking composition has an optical density (OD) at a wavelength of 1,000 nm of 0.2 or more, an optical density (OD) at a wavelength of 1,100 nm of 0.3 or more, and an optical density (OD) at a wavelength of 500 nm of 0.1 or less.

3. The infrared-light-blocking composition according to claim 1, further comprising a copper compound.

4. The infrared-light-blocking composition according to claim 3, wherein the copper compound includes at least one selected from a sulfonic acid-copper complex, a carboxylic acid-copper complex, and a phosphorus-containing copper complex.

5. The infrared-light-blocking composition according to claim 1, wherein the 90% particle diameter (D90) of the inorganic microparticles dispersed in the infrared-light-blocking composition is 0.05 μm or more.

6. The infrared-light-blocking composition according to claim 1, wherein the 50% particle diameter (D50) of the inorganic microparticles dispersed in the infrared-light-blocking composition is 0.03 μm or more.

7. The infrared-light-blocking composition according to claim 1, wherein the inorganic microparticles include at least one selected from the group consisting of metal oxide particles and metal particles.

8. The infrared-light-blocking composition according to claim 1, wherein the content of the inorganic microparticles is 40% by mass or more relative to the total solid content.

9. The infrared-light-blocking composition according to claim 1, wherein the inorganic microparticles include at least one selected from the group consisting of indium tin oxide particles and antimony tin oxide particles.

10. The infrared-light-blocking composition according to claim 1, wherein the dispersing agent includes a polymer compound represented by the following Formula (1), which has a weight average molecular weight of 20,000 or less, or a resin which has a repeating unit having a group X that has a functional group with a pKa of 14 or less, and an oligomer chain or polymer chain Y having a number of atoms of 40 to 20,000 as a side chain, and contains a basic nitrogen atom 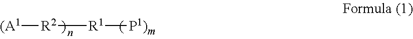
(wherein in Formula (1), R¹ represents a linking group having a valence of (m+n); R² represents a single bond or a divalent linking group; A¹ represents a monovalent substituent having at least one group selected from the group consisting of an acid group, a urea group, a urethane group, a group having a coordinating oxygen atom, a group having a basic nitrogen atom, a phenol group, an alkyl group, an aryl group, a group having an alkyleneoxy chain, an imide group, an alkyloxycarbonyl group, an alkylaminocarbonyl group, a carboxylic acid salt group, a sulfonamide group, a heterocyclic group, an alkoxysilyl group, an epoxy group, an isocyanate group, and a hydroxyl group; n units of A¹ and R² may be respectively identical or different;
m represents a positive number of 8 or less; n represents 1 to 9; m+n satisfies the value from 3 to 10;
P¹ represents a polymer chain; and m units of P¹ may be identical or different).

11. The infrared-light-blocking composition according to claim 1, further comprising at least one selected from the group consisting of a polymerization initiator, a polymerizable monomer, and a binder polymer.

12. The infrared-light-blocking composition according to claim 1, wherein the composition is an absorption type infrared-light-blocking composition.

13. The infrared-light-blocking composition according to claim 1, wherein the transmittance at a wavelength in the range of 700 nm to 1,100 nm of an infrared-light-blocking layer formed from the infrared-light-blocking composition is 20% or less.

14. The infrared-light-blocking composition according to claim 1, wherein the transmittance at a wavelength in the range of 800 nm to 900 nm of an infrared-light-blocking layer formed from the infrared-light-blocking composition is 10% or less.

15. An infrared-light-blocking layer formed from the infrared-light-blocking composition according to claim 1.

16. The infrared-light-blocking layer according to claim 15, having a film thickness of 200 μm or less.

17. An infrared cut-off filter comprising:
a blue glass substrate; and
an infrared-light-blocking layer disposed on the blue glass substrate,
wherein the infrared-light-blocking layer contains inorganic microparticles and a dispersing agent and has a transmittance at a wavelength of 1,000 nm of 60% or less, a transmittance at a wavelength of 1,100 nm of 50% or less, and a transmittance at a wavelength of 500 nm of 80% or more.

18. An infrared cut-off filter comprising:
a blue glass substrate; and
an infrared-light-blocking layer disposed on the blue glass substrate,
wherein the infrared-light-blocking layer contains inorganic microparticles and a dispersing agent and has an optical density (OD) at a wavelength of 1,000 nm of 0.2 or more, an optical density (OD) at a wavelength of 1,100 nm of 0.3 or more, and an optical density (OD) at a wavelength of 500 nm of 0.1 or less.

19. An infrared cut-off filter comprising:
a support; and
an infrared-light-blocking layer disposed on the support,
wherein the infrared-light-blocking layer contains inorganic microparticles and a dispersing agent and has an optical density (OD) at a wavelength of 1,000 nm of 0.2 or more, an optical density (OD) at a wavelength of 1,100 nm of 0.3 or more, and an optical density (OD) at a wavelength of 500 nm of 0.1 or less.

20. The infrared cut-off filter according to claim 17, wherein the film thickness of the infrared-light-blocking layer is 2 μm to 6 μm.

21. The infrared cut-off filter according to claim 17, further comprising a layer containing a copper compound separately from the infrared-light-blocking layer.

22. The infrared cut-off filter according to claim 21, wherein the copper compound includes at least one selected from a sulfonic acid-copper complex, a carboxylic acid-copper complex, and a phosphorus-containing copper complex.

23. A camera module comprising:
a solid-state imaging element; and
the infrared cut-off filter according to claim 17.
